(19) United States
(12) Patent Application Publication
(10) Pub. No.: US 2025/0149653 A1
(43) Pub. Date: May 8, 2025

(54) METHOD FOR MANUFACTURING A PROTECTED NEGATIVE ELECTRODE AND THE RESULTING NEGATIVE ELECTRODE

(71) Applicants: HYDRO-QUÉBEC, Montréal (CA); SCE FRANCE, Pau (FR)

(72) Inventors: Nicolas DELAPORTE, Montréal (CA); Vincent MORIZUR, Pau (FR); Gilles LAJOIE, Verchères (CA)

(21) Appl. No.: 18/832,402

(22) PCT Filed: Jan. 27, 2023
(86) PCT No.: PCT/CA2023/050111

§ 371 Date: Jul. 23, 2024

(30) Foreign Application Priority Data
Jan. 28, 2022 (CA) 3147039

(51) Int. Cl. H01M 10/42; H01M 4/02; H01M 4/134; H01M 4/36; H01M 4/38; H01M 4/62; H01M 10/052; H01M 10/0525; H01M 10/0565

(52) U.S. Cl. CPC H01M 10/4235; H01M 4/134; H01M 4/366; H01M 4/382; H01M 4/62; H01M 10/052; H01M 10/0525; H01M 10/0565; H01M 2004/027; H01M 2300/0082

(57) ABSTRACT

A negative electrode material comprising an electrochemically active material and a coating layer on its surface is described. The coating layer comprises a coating material based on a calcined lithiophilic organometallic structure comprising at least one lithiophilic metal and at least one at least partially calcined organic ligand. The methods of manufacturing the electrode material, electrodes comprising the material, and their use in electrochemical cells and batteries are also described.

### RELATED APPLICATION

This application claims priority, under applicable law, to Canadian provisional patent application No. 3,147,039 filed on Jan. 28, 2022, the content of which is incorporated herein by reference in its entirety and for all purposes.

### TECHNICAL FIELD

The present technology relates to the field of negative electrode materials comprising a coating layer on one of its surfaces, to electrodes comprising them, to processes for preparing these materials and to their uses in electrochemical cells.

### BACKGROUND

The liquid electrolytes used in lithium-ion batteries are flammable and slowly degrade to form a passivation layer on the surface of the lithium film known as the solid electrolyte interface (SEI), which irreversibly consumes lithium and reduces the coulombic efficiency of the battery. In addition, lithium anodes undergo significant morphological changes during battery cycling, and lithium dendrites are formed. As these usually migrate through the electrolyte, they can eventually cause short circuits.

Safety concerns and the requirement for higher energy density have spurred research into the development of an all-solid lithium rechargeable battery with a polymer or ceramic-type electrolyte, both of which are more stable towards lithium metal and reduce the growth of lithium dendrites. However, certain disadvantages arise from the use of such solid electrolytes, for example, loss of reactivity or ionic conductivity, poor contact between solid interfaces, etc.

Consequently, there is a need for the development of new processes for protecting the surface of metal electrodes.

### SUMMARY

According to one aspect, the present technology relates to a process for preparing a negative electrode material comprising an electrochemically active material and a coating layer comprising a coating material based on a calcined lithiophilic organometallic structure disposed on a surface of said electrochemically active material, the process comprising the following steps:
(i) contacting at least one organic ligand with at least one lithiophilic metal precursor to obtain a lithiophilic organometallic structure;
(ii) calcining the lithiophilic organometallic structure obtained in (i) to obtain the calcined lithiophilic organometallic structure of the coating material; and
(iii) depositing the coating material on the surface of the electrochemically active material.

In one embodiment, the lithiophilic metal is selected from Ag, Zn, Sn, Sb, Mg, Al, Ni, Cu, Co, and a combination of at least two thereof.

In another embodiment, the organic ligand is an organic ligand comprising a nitrogen function, an organic ligand comprising a carboxylate, or a mixed organic ligand comprising a nitrogen function and/or a carboxylate. According to one example, the organic ligand is 1,2,4,5-benzenetetracarboxylic acid or 1H-benzimidazole-6-carboxylic acid.

In another embodiment, the lithiophilic organometallic structure obtained in (i) is of Formula 1:

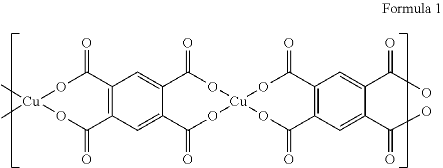

In another embodiment, the lithiophilic organometallic structure obtained in (i) is of Formula 2:

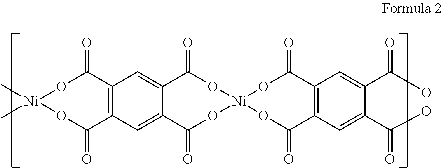

In another embodiment, the lithiophilic organometallic structure obtained in (i) is of Formula 3:

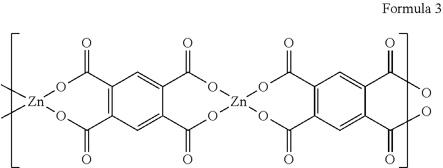

In another embodiment, the lithiophilic organometallic structure obtained in (i) is of Formula 4:

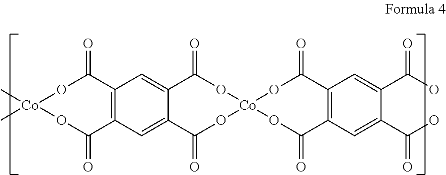

In another embodiment, the lithiophilic organometallic structure obtained in (i) is of Formula 5:

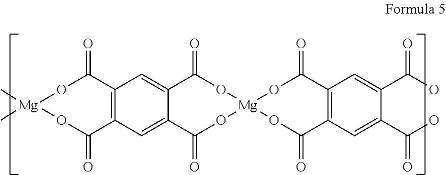

In another embodiment, the lithiophilic organometallic structure obtained in (i) is of Formula 6:

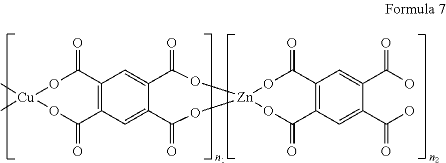

wherein,
n₁ and n₂ indicate the ratio of each unit and are independently selected numbers in the range from 0.1 to 0.9.

In another embodiment, the lithiophilic organometallic structure obtained in (i) is of Formula 7:

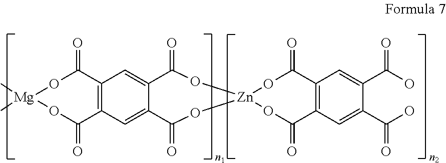

wherein,
n₁ and n₂ indicate the ratio of each unit and are independently selected numbers in the range from 0.1 to 0.9.

In another embodiment, the lithiophilic organometallic structure obtained in (i) is of Formula 8:

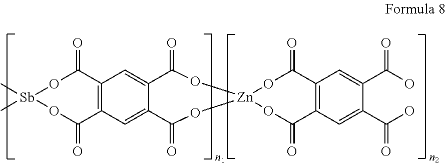

wherein,
n₁ and n₂ indicate the ratio of each unit and are independently selected numbers in the range from 0.1 to 0.9.

In another embodiment, the lithiophilic organometallic structure obtained in (i) is of Formula 9:

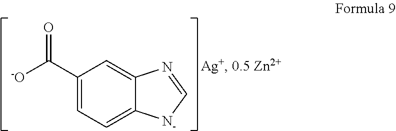

In another embodiment, the calcination step is carried out at a temperature of from about 500° C. to about 1050° C. According to one example, the calcination step is carried out at a temperature of from about 550° C. to about 1000° C.

In another embodiment, the calcination step is carried out under an inert atmosphere. According to one example, the inert atmosphere comprises a gas selected from argon, oxygen, nitrogen, helium, a fluorinated gas, and a mixture comprising at least two thereof. According to an example of interest, the inert atmosphere comprises argon.

In another embodiment, the deposition step is carried out by at least one of a doctor blade coating method, a comma coating method, a reverse-comma coating method, a printing method such as gravure coating, a slot-die coating method, or a spray deposition method. According to one example, the deposition step is carried out by a spray deposition method.

In another embodiment, said process further comprises a step of depositing a second coating layer.

According to one example, the step of depositing the second coating layer is carried out by at least one of a doctor blade coating method, a comma coating method, a reverse-comma coating method, a printing method such as gravure coating, a slot-die coating method, or a spray deposition method. According to an example of interest, the step of depositing the second coating layer is carried out by a spray deposition method.

According to another aspect, the present technology relates to a negative electrode material obtained according to the process as herein defined.

According to another aspect, the present technology relates to a negative electrode material comprising an electrochemically active material and a coating layer comprising a coating material based on a calcined lithiophilic organometallic structure comprising at least one lithiophilic metal and at least one at least partially calcined organic ligand, said coating layer disposed on a surface of said electrochemically active material.

In one embodiment, the electrochemically active material comprises an alkali metal, an alkaline earth metal, a non-alkali and non-alkaline earth metal, or an alloy comprising at least one thereof. According to one example, the electrochemically active material comprises an alkali metal, an alkaline-earth metal, or an alloy comprising at least one alkali or alkaline-earth metal. For example, the electrochemically active material comprises metallic lithium or an alloy including or based on metallic lithium. According to another example, the electrochemically active material comprises nickel.

In another embodiment, the electrochemically active material is in the form of a film having a thickness in the range from about 5 μm to about 75 μm, or from about 15 μm to about 70 μm, or from about 25 μm to about 65 μm, or from about 30 μm to about 60 μm, or from about 45 μm to about 55 μm, upper and lower limits included.

In another embodiment, the lithiophilic metal is selected from Ag, Zn, Sn, Sb, Mg, Al, Ni, Cu, Co, and a combination of at least two thereof.

In another embodiment, the organic ligand is an organic ligand comprising a nitrogen function, an organic ligand comprising a carboxylate, or a mixed organic ligand comprising a nitrogen function and/or a carboxylate. According to one example, the organic ligand is 1,2,4,5-benzenetetracarboxylic acid or 1H-benzimidazole-6-carboxylic acid.

In another embodiment, the lithiophilic organometallic structure before calcination is of Formula 1:

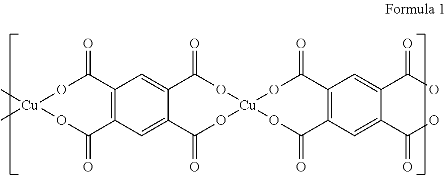

In another embodiment, the lithiophilic organometallic structure before calcination is of Formula 2:

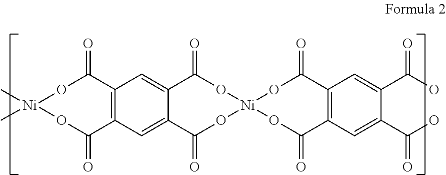

In another embodiment, the lithiophilic organometallic structure before calcination is of Formula 3:

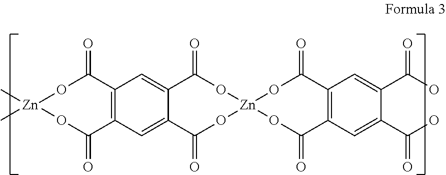

In another embodiment, the lithiophilic organometallic structure before calcination is of Formula 4:

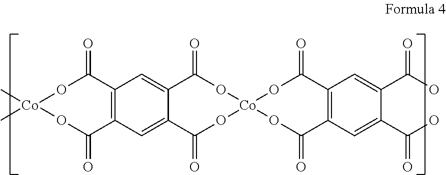

In another embodiment, the lithiophilic organometallic structure before calcination is of Formula 5:

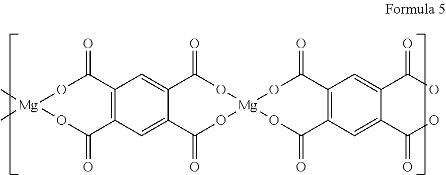

In another embodiment, the lithiophilic organometallic structure before calcination is of Formula 6:

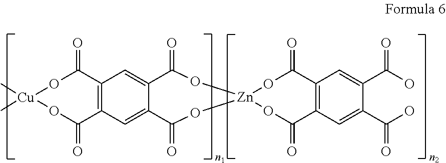

wherein,
n₁ and n₂ indicate the ratio of each unit and are independently selected numbers in the range from 0.1 to 0.9.

In another embodiment, the lithiophilic organometallic structure before calcination is of Formula 7:

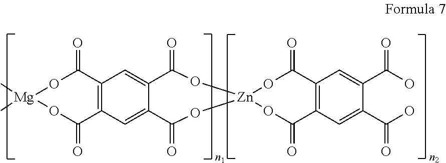

wherein,
n₁ and n₂ indicate the ratio of each unit and are independently selected numbers in the range from 0.1 to 0.9.

In another embodiment, the lithiophilic organometallic structure before calcination is of Formula 8:

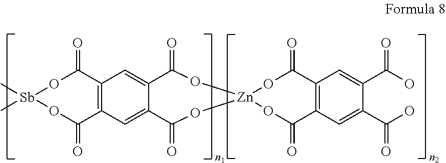

wherein,
n₁ and n₂ indicate the ratio of each unit and are independently selected numbers in the range from 0.1 to 0.9.

In another embodiment, the lithiophilic organometallic structure before calcination is of Formula 9:

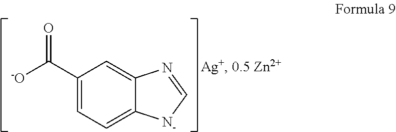

In another embodiment, the calcined lithophilic organometallic structure further comprises a silver source. According to a variant of interest, the silver source is a silver salt. According to one example, the silver salt is AgCl or AgNO₃. According to another example, the salt is present in a lithiophilic metal:silver ratio in the range from about 4:3 to about 4:1, upper and lower limits included.

In another embodiment, the coating material further comprises a solid polymer electrolyte comprising a salt in a solvating polymer.

According to one example, the solid polymer electrolyte is a copolymer of ethylene oxide and at least one substituted oxirane comprising a crosslinkable functional group. According to one example, the copolymer comprises ethylene oxide-based units and —O—CH₂—CHR units, wherein R is a substituent comprising a radically crosslinkable functional group and is independently selected from one unit to the other. For example, R′ is a substituent being free of radically crosslinkable functional groups and is independently selected from one unit to the other.

According to another example, the copolymer has a polymolecularity index (I=M_{w}/Mₙ) of less than or equal to 2.2, wherein Mₙ is the number average molecular weight of the copolymer and is greater than or equal to 20,000 and M_{w} is the weight average molecular weight.

According to another example, the copolymer is crosslinked.

According to another example, the salt is a lithium salt. For example, the lithium salt is selected from the group consisting of lithium hexafluorophosphate (LiPF₆), lithium bis(trifluoromethanesulfonyl)imide (LiTFSI), lithium bis(fluorosulfonyl)imide (LiFSI), lithium 2-trifluoromethyl-4,5-dicyanoimidazolate (LiTDI), lithium 4,5-dicyano-1,2,3-triazolate (LiDCTA), lithium bis(pentafluoroethylsulfonyl)imide (LiBETI), lithium tetrafluoroborate (LiBF₄), lithium bis(oxalato)borate (LiBOB), lithium nitrate (LiNO₃), lithium chloride (LiCl), lithium bromide (LiBr), lithium fluoride (LiF), lithium perchlorate (LiClO₄), lithium hexafluoroarsenate (LiAsF₆), lithium trifluoromethanesulfonate (LiSO₃CF₃) (LiOTf), lithium fluoroalkylphosphate Li[PF₃(CF₂CF₃)₃] (LiFAP), lithium tetrakis(trifluoroacetoxy)borate Li[B(OCOCF₃)₄] (LiTFAB), lithium bis(1,2-benzenediolato(2-)-O,O′)borate Li[B(C₆O₂)₂] (LiBBB), and a combination of at least two thereof. According to a variant of interest, the lithium salt is LiTFSI.

In another embodiment, the coating layer has a thickness in the range from about 1 μm to about 20 μm, or from about 1 μm to about 19 μm, or from about 1 μm to about 18 μm, or from about 1 μm to about 17 μm, or from about 1 μm to about 16 μm, or from about 1 μm to about 15 μm, or from about 1 μm to about 14 μm, or from about 1 μm to about 13 μm, or from about 2 μm to about 12 μm, upper and lower limits included. According to one example, the thickness of the coating layer is in the range from about 2 μm to about 12 μm, upper and lower limits included.

In another embodiment, the electrochemically active material is lubricated.

In another embodiment, the coating layer is a first coating layer and the electrode material comprises a second coating material layer.

According to one example, the second coating layer has a thickness in the range from about 1 μm to about 20 μm, or from about 1 μm to about 19 μm, or from about 1 μm to about 18 μm, or from about 1 μm to about 17 μm, or from about 1 μm to about 16 μm, or from about 1 μm to about 15 μm, or from about 1 μm to about 14 μm, or from about 2 μm to about 14 μm, upper and lower limits included. According to a variant of interest, the thickness of the second coating layer is in the range from about 2 μm to about 14 μm, upper and lower limits included.

According to another example, the second coating layer comprises a non-crosslinked polymer.

According to another aspect, the present technology relates to a process for preparing an electrode material as herein defined, the process comprising a step of depositing the coating layer based on the calcined lithiophilic organometallic structure on the surface of the electrochemically active material.

In one embodiment, the process further comprises a step of depositing the second coating layer.

In another embodiment, the deposition step is carried out by at least one of a doctor blade coating method, a comma coating method, a reverse-comma coating method, a printing method such as gravure coating, a slot-die coating method, or a spray deposition method. According to one example, the deposition step is carried out by a spray deposition method.

In one embodiment, the process further comprises the preparation of the coating layer based on the calcined lithiophilic organometallic structure.

According to one example, the preparation of the coating layer based on a calcined lithiophilic organometallic structure further comprises a step of preparing the calcined lithiophilic organometallic structure. For example, the step of preparing the calcined lithiophilic organometallic structure comprises (i) a step of contacting at least one organic ligand with at least one lithiophilic metal precursor to obtain a lithiophilic organometallic structure, and (ii) a step of calcining the lithiophilic organometallic structure obtained in (i) to obtain the calcined lithiophilic organometallic structure.

According to another aspect, the present technology relates to a negative electrode comprising the electrode material as herein defined or an electrode material obtained according to the process as herein defined on a current collector.

According to another aspect, the present technology relates to a self-supporting negative electrode comprising the electrode material as herein defined or an electrode material obtained according to the process as herein defined.

According to another aspect, the present technology relates to an electrochemical cell comprising a negative electrode, a positive electrode, and an electrolyte, wherein the negative electrode is as herein defined or comprises an electrode material as herein defined.

In one embodiment, the positive electrode comprises an electrochemically active material selected from a metal oxide, a metal sulfide, a metal oxysulfide, a metal phosphate, a metal fluorophosphate, a metal oxyfluorophosphate, a metal sulfate, a metal halide, a metal fluoride, sulfur, selenium, and a combination of at least two thereof.

According to one example, the metal of the electrochemically active material is selected from titanium (Ti), iron (Fe), manganese (Mn), vanadium (V), nickel (Ni), cobalt (Co), aluminum (Al), chromium (Cr), copper (Cu), zirconium (Zr), niobium (Nb), and a combination of at least two thereof.

According to another example, the metal of the electrochemically active material further comprises an alkali or alkaline earth metal selected from lithium (Li), sodium (Na), potassium (K), and magnesium (Mg).

According to another example, the electrochemically active material is a lithium metal phosphate. For example, the lithium metal phosphate is LiFePO₄.

In another embodiment, the electrolyte is a solid polymer electrolyte comprising a salt in a solvating polymer. According to an alternative, the electrolyte is a liquid electrolyte comprising a salt in a solvent. According to another alternative, the electrolyte is a gel electrolyte comprising a salt in a solvent and optionally a solvating polymer. According to one example, the salt is a lithium salt. For example, the lithium salt is selected from the group consisting of lithium hexafluorophosphate (LiPF₆), lithium bis(trifluoromethanesulfonyl)imide (LiTFSI), lithium bis(fluorosulfonyl)imide (LiFSI), lithium 2-trifluoromethyl-4,5-dicyanoimidazolate (LiTDI), lithium 4,5-dicyano-1,2,3-triazolate (LIDCTA), lithium bis(pentafluoroethylsulfonyl)imide (LiBETI), lithium tetrafluoroborate (LiBF₄), lithium bis(oxalato)borate (LiBOB), lithium nitrate (LiNO₃), lithium chloride (LiCl), lithium bromide (LiBr), lithium fluoride (LiF), lithium perchlorate (LiClO₄), lithium hexafluoroarsenate (LiAsF₆), lithium trifluoromethanesulfonate (LiSO₃CF₃) (LiOTf), lithium fluoroalkylphosphate Li[PF₃(CF₂CF₃)₃] (LiFAP), lithium tetrakis(trifluoroacetoxy)borate Li[B(OCOCF₃)₄] (LiTFAB), lithium bis(1,2-benzenediolato(2-)-O,O′)borate Li[B(C₆O₂)₂] (LiBBB), and a combination of at least two thereof. According to a variant of interest, the lithium salt is LiTFSI.

According to another aspect, the present technology relates to a battery comprising at least one electrochemical cell as herein defined.

In one embodiment, said battery is selected from the group consisting of a lithium battery, a lithium-ion battery, a sodium battery, a sodium-ion battery, a potassium battery, a potassium-ion battery, a magnesium battery, and a magnesium-ion battery. According to a variant of interest, said battery is a lithium battery. According to another variant of interest, said battery is a lithium-ion battery.

### BRIEF DESCRIPTION OF THE FIGURES

FIG. 1 presents thermogravimetric analysis results in (A) for MOF 1, in (B) for MOF 2, in (C) for MOF 3 (solid line) and for MOF 4 (dashed line), and in (D) for MOF 5, as described in Example 1(b).

FIG. 2 shows images of MOF 1 particles obtained by scanning electron microscopy (SEM) at different magnifications, as described in Example 1(c).

FIG. 3 shows images of MOF 2 particles obtained by SEM at different magnifications, as described in Example 1(c).

FIG. 4 shows images of MOF 3 particles obtained by SEM at different magnifications, as described in Example 1(c).

FIG. 5 shows images of MOF 4 particles obtained by SEM at different magnifications, as described in Example 1(c).

FIG. 6 shows images of MOF 5 particles obtained by SEM at different magnifications, as described in Example 1(c).

FIG. 7 shows in (A) an image obtained by SEM of MOF 1 particles and in (B) to (D) energy dispersive X-ray spectroscopy (EDS) mapping images of the elements C, O and Cu respectively, as described in Example 1(d).

FIG. 8 shows in (A) an image obtained by SEM of MOF 2 particles and in (B) to (D) EDS mapping images of the elements Ni, C and O respectively, as described in Example 1(d).

FIG. 9 shows in (A) an image obtained by SEM of MOF 3 and in (B) to (D) EDS mapping images of the elements O, C and Zn respectively, as described in Example 1(d).

FIG. 10 shows in (A) an image obtained by SEM of MOF 4 and in (B) to (D) EDS mapping images of the elements C, O and Zn respectively, as described in Example 1(d).

FIG. 11 presents thermogravimetric analysis results in (A) for MOF 6, in (B) for MOF 7, and in (C) for MOFs 8 to 10, as described in Example 2(b).

FIG. 12 shows Raman spectra obtained for MOFs 6, 7 and 10, as described in Example 2(c).

FIG. 13 shows Raman spectra obtained for MOFs 8 and 9, as described in Example 2(c).

FIG. 14 shows in (A) a graph of the volume of nitrogen adsorbed per gram of sample as a function of the relative pressure of nitrogen (P/P₀), in (B) a graph of the distribution of pore volumes as a function of the pore width, in (C) a graph of the specific surface area as a function of the pore width, and in (D) a graph of the total pore volume as a function of the pore width obtained for MOF 6, as described in Example 2(d).

FIG. 15 shows in (A) a graph of the volume of nitrogen adsorbed per gram of sample as a function of the relative pressure of nitrogen (P/P₀), in (B) a graph of the distribution of pore volumes as a function of the pore width, in (C) a graph of the specific surface area as a function of the pore width, and in (D) a graph of the total pore volume as a function of the pore width obtained for MOF 7, as described in Example 2(d).

FIG. 16 shows in (A) a graph of the volume of nitrogen adsorbed per gram of sample as a function of the relative pressure of nitrogen (P/P₀), in (B) a graph of the distribution of pore volumes as a function of the pore width, in (C) a graph of the specific surface area as a function of the pore width, and in (D) a graph of the total pore volume as a function of the pore width obtained for MOF 8 (♦), MOF 9 (★), and MOF 10 (▪), as described in Example 2(d).

FIG. 17 shows transmission electron microscopy (TEM) images of MOF 6, as described in Example 2(e).

FIG. 18 shows in (A) to (C) images obtained by TEM of MOF 6, in (D) an EDS mapping image of Cu, and in (E) a graph presenting the results of the EDS analysis obtained for the area delimited in (D), as described in Example 2(e).

FIG. 19 shows images obtained by TEM of MOF 6, as described in Example 2(e).

FIG. 20 shows in (A) to (C) images obtained by TEM of MOF 6, in (D) an EDS mapping image of Cu, in (E) an EDS mapping image of C (red) and Cu (green), and in (F) a graph presenting the results of the EDS analysis obtained for the area delimited in (D) and (E), as described in Example 2(e).

FIG. 21 shows images obtained by TEM of MOF 6, as described in Example 2(e).

FIG. 22 shows images obtained by TEM of MOF 6, as described in Example 2(e).

FIG. 23 shows in (A) to (C) images obtained by TEM of MOF 7, in (D) an EDS mapping image of Ni, and in (E) and (F) graphs presenting the results of the EDS analysis obtained for the area delimited in (D), as described in Example 2(e).

FIG. 24 shows images obtained by TEM of MOF 7, as described in Example 2(e).

FIG. 25 shows images obtained by TEM of MOF 7, as described in Example 2(e).

FIG. 26 shows in (A) and (B) images obtained by TEM of MOF 10, and in (C) the results of the corresponding EDS analysis, as described in Example 2(e).

FIG. 27 shows in (A) and (B) images obtained by TEM of MOF 10, and in (C) an EDS mapping image of Zn, as described in Example 2(e).

FIG. 28 shows in (A) an image obtained by TEM of MOF 10, in (B) an EDS mapping image of Zn, and in (C) a graph presenting the results of the EDS analysis obtained for the area delimited in (B), as described in Example 2(e).

FIG. 29 shows in (A) an image obtained by TEM of MOF 9, in (B) to (E) EDS mapping images of Zn, C, O and Si respectively, and in (F) the results of the corresponding EDS analysis obtained for the two zones delimited in (A) to (E), as described in Example 2(e).

FIG. 30 shows in (A) to (C) images obtained by TEM of MOF 9, in (D) to (G) EDS mapping images of Zn, O, C and Si respectively, and in (H) the results of the corresponding EDS analysis obtained for the two zones delimited in (C) to (G), as described in Example 2(e).

FIG. 31 shows in (A) and (B) images obtained by TEM of MOF 9, in (C) to (F) the results of the corresponding EDS analysis obtained for the two zones indicated by arrows in (B), as described in Example 2(e).

FIG. 32 shows images obtained by TEM of MOF 9, as described in Example 2(e).

FIG. 33 shows images obtained by TEM of MOF 8, as described in Example 2(e).

FIG. 34 shows in (A) an image obtained by TEM of MOF 8, in (B) to (D) EDS mapping images of Zn, C and O respectively, and in (E) the results of the corresponding EDS analysis obtained for the area delimited in (A) to (D), as described in Example 2(e).

FIG. 35 shows in (A) and (C) images obtained by TEM of MOF 8, in (D) to (F) EDS mapping images of Zn, C and O respectively, and in (G) the results of the corresponding EDS analysis obtained for the area delimited in (C) to (F), as described in Example 2(e).

FIG. 36 shows in (A) and (C) images obtained by TEM of MOF 8, and in (D) the results of EDS analysis obtained for the two zones indicated by arrows on the corresponding TEM image also shown in (D), as described in Example 2(e).

FIG. 37 shows in (A) an image obtained by TEM of MOF 8, in (B) to (D) EDS mapping images of Zn, C and O respectively, and in (E) and (F) the results of the corresponding EDS analysis obtained respectively for zones 1 and 2 delimited in (A) to (D), as described in Example 2(e).

FIG. 38 shows images obtained by TEM of MOF 8, as described in Example 2(e).

FIG. 39 shows images obtained by SEM of MOF 8 in (A) before grinding, in (B) after about 5 minutes of grinding, and in (C) after grinding twice for about 5 minutes, as described in Example 2(f).

FIG. 40 shows in (A) an image obtained by TEM of MOF 8 after grinding twice for about 5 minutes, and in (B) and (C) EDS mapping images of C and Zn respectively, as described in Example 2(f).

FIG. 41 presents thermogravimetric analysis results in (A) for MOF 11, in (B) for MOF 12, in (C) for MOF 13, in (D) for MOF 14, and in (E) for MOF 15, as described in Example 3(b).

FIG. 42 shows images obtained by SEM of MOF 11, as described in Example 3(c).

FIG. 43 shows images obtained by SEM of MOF 12, as described in Example 3(c).

FIG. 44 shows images obtained by SEM of MOF 13, as described in Example 3(c).

FIG. 45 shows images obtained by SEM of MOF 14, as described in Example 3(c).

FIG. 46 shows images obtained by SEM of MOF 15, as described in Example 3(c).

FIG. 47 shows in (A) an image obtained by SEM of MOF 11, and in (B) to (E) EDS mapping images of C, Zn, Cu and O respectively, as described in Example 3(d).

FIG. 48 shows in (A) an image obtained by SEM of MOF 11, and in (B) to (E) EDS mapping images of Zn, C, O and Cu respectively, as described in Example 3(d).

FIG. 49 shows in (A) an image obtained by SEM of MOF 13, and in (B) to (E) EDS mapping images of Zn, C, O and Cu respectively, as described in Example 3(d).

FIG. 50 shows in (A) an image obtained by SEM of MOF 14, and in (B) to (E) EDS mapping images of C, O, Cu and Zn respectively, as described in Example 3(d).

FIG. 51 shows in (A) an image obtained by SEM of MOF 15, and in (B) to (E) EDS mapping images of Zn, C, O and Cu respectively, as described in Example 3(d).

FIG. 52 presents thermogravimetric analysis results in (A) for MOF 11, in (B) for MOF 12, and in (C) for MOF 13, as described in Example 3(e).

FIG. 53 shows in (A) and (B) images obtained by SEM of a MOF having been calcined at a temperature of about 1000° C. and having been ground, and in (C) the results of the corresponding EDS analysis, as described in Example 3(f).

FIG. 54 presents thermogravimetric analysis results in (A) for MOF 16, in (B) for MOF 17, in (C) for MOF 18, and in (D) for MOF 19, as described in Example 4(b).

FIG. 55 shows in (A) a nitrogen adsorption/desorption isotherm, in (B) a graph of the distribution of pore volumes as a function of pore width, in (C) a graph of the specific surface area in function of the pore width, and in (D) a graph of the total pore volume as a function of the pore width obtained for MOFs 16 (▪), 17 (▴), 18 (●), and 19 (★), as described in Example 4(c).

FIG. 56 shows images obtained by SEM of MOF 16, as described in Example 4(d).

FIG. 57 shows images obtained by SEM of MOF 17, as described in Example 4(d).

FIG. 58 shows images obtained by SEM of MOF 18, as described in Example 4(d).

FIG. 59 shows images obtained by SEM of MOF 19, as described in Example 4(d).

FIG. 60 shows in (A) a SEM image obtained for MOF 16, and in (B) graphs presenting the results of EDS analysis obtained for the zones delimited in (A), as described in Example 4(e).

FIG. 61 shows in (A) an image obtained by SEM of MOF 17, and in (B) to (E) EDS mapping images of C, Ag, O and Zn respectively, as described in Example 4(e).

FIG. 62 shows in (A) an image obtained by SEM of MOF 18, and in (B) to (E) EDS mapping images of C, O, Ag and Zn respectively, as described in Example 4(e).

FIG. 63 presents thermogravimetric analysis results in (A) for MOF 20, and in (B) for MOF 21, as described in Example 5(b).

FIG. 64 shows images obtained by SEM of MOF 20, as described in Example 5(c).

FIG. 65 shows images obtained by SEM of MOF 21 before and after calcination at a temperature of about 750° C., as described in Example 5(c).

FIG. 66 shows images obtained by SEM of MOF 22 before and after calcination at a temperature of about 1000° C., as described in Example 5(c).

FIG. 67 shows in (A) an image obtained by SEM of MOF 21 before calcination, and in (B) to (E) EDS mapping images of O, Mg, C and Zn respectively, as described in Example 5(d).

FIG. 68 shows in (A) an image obtained by SEM of MOF 21 after calcination at a temperature of about 750° C., in (B) to (E) EDS mapping images of Zn, Mg, C and O respectively, and in (F) the results of the corresponding EDS analysis, as described in Example 5(d).

FIG. 69 shows in (A) an image obtained by SEM of MOF 22 before calcination, and in (B) to (F) EDS mapping images of C, O, Ir, Zn and Mg respectively, as described in Example 5(d).

FIG. 70 shows in (A) an image obtained by SEM of MOF 22 after calcination at a temperature of about 1000° C., in (B) to (E) EDS mapping images of C, O, Mg and Zn respectively, and in (F) the results of the corresponding EDS analysis, as described in Example 5(d).

FIG. 71 shows images obtained by SEM of MOF 23, as described in Example 6(b).

FIG. 72 shows images obtained by SEM of MOF 24, as described in Example 6(b).

FIG. 73 shows in (A) an image obtained by TEM of MOF 23, in (B) to (D) EDS mapping images of C, O and Mg respectively, and in (E) the results of the corresponding EDS analysis, as described in Example 6(c).

FIG. 74 shows in (A) an image obtained by TEM of MOF 24, in (B) to (D) EDS mapping images of C, O and Mg respectively, and in (E) the results of the corresponding EDS analysis, as described in Example 6(c).

FIG. 75 shows images obtained by SEM of MOF 25, as described in Example 7(b).

FIG. 76 shows images obtained by SEM of MOF 26, as described in Example 7(b).

FIG. 77 shows images obtained by SEM of MOF 27, as described in Example 7(b).

FIG. 78 shows images obtained by SEM of MOF 28, as described in Example 7(b).

FIG. 79 shows images obtained by SEM of MOF 29, as described in Example 7(b).

FIG. 80 shows images obtained by SEM of MOF 30, as described in Example 7(b).

FIG. 81 shows in (A) an image obtained by SEM of MOF 25, and in (B) to (D) EDS mapping images of C, O and Sb respectively, as described in Example 7(c).

FIG. 82 shows in (A) an image obtained by SEM of MOF 26, and in (B) to (E) EDS mapping images of C, O, Zn and Sb respectively, as described in Example 7(c).

FIG. 83 shows in (A) an image obtained by SEM of MOF 27, and in (B) to (E) EDS mapping images of C, O, Zn and Sb respectively, as described in Example 7(c).

FIG. 84 shows in (A) an image obtained by SEM of MOF 28, and in (B) to (E) EDS mapping images of C, O, Zn and Sb respectively, as described in Example 7(c).

FIG. 85 shows in (A) an image obtained by SEM of MOF 29, and in (B) to (E) EDS mapping images of C, O, Sb and Zn respectively, as described in Example 7(c).

FIG. 86 shows in (A) an image obtained by SEM of MOF 30, and in (B) to (E) EDS mapping images of C, O, Sb and Zn respectively, as described in Example 7(c).

FIG. 87 shows images obtained by SEM of MOF 31, as described in Example 8(b).

FIG. 88 shows images obtained by SEM of MOF 32 before calcination, as described in Example 8(b).

FIG. 89 shows an image obtained by SEM of MOF 32 after calcination at a temperature of about 1000° C., as described in Example 8(b).

FIG. 90 shows in (A) an image obtained by SEM of MOF 31, and in (B) to (E) EDS mapping images of Ag, Zn, N and O respectively, as described in Example 8(c).

FIG. 91 shows in (A) an image obtained by SEM of MOF 32 before calcination, and in (B) to (E) EDS mapping images of Zn, Ag, N and O respectively, as described in Example 8(c).

FIG. 92 shows in (A) an image obtained by SEM of MOF 32 after calcination at a temperature of about 1000° C. as well as an EDS mapping of C (red) and Ag (green), and in (B) and (C) EDS mapping images respectively of Ag and C obtained for the zones delimited in (A), as described in Example 8(c).

FIG. 93 shows the results of the EDS analysis for MOF 32 after calcination at a temperature of about 1000° C. obtained in (A) for the sum of the spectra, in (B) for Spectrum 14, and in (C) for Spectrum 15, as described in Example 8(c).

FIG. 94 shows a graph of capacity versus number of cycles obtained at charge and discharge currents of C/6, C/4, C/3, C/2 and 1 C for Cells 8 (▴) and 9 (▾) and References 3 (▪) and 4 (●), as described in Example 9 (c).

FIG. 95 shows images obtained by SEM of Layer 1, as described in Example 10(b).

FIG. 96 shows images obtained by SEM of Layer 2, as described in Example 10(b).

FIG. 97 shows in (A) an SEM image obtained of Layer 1 as well as EDS mapping of Zn (blue), Cu (green) and Al (red), and in (B) and (C) EDS mapping images respectively of Cu and Zn obtained for the area delimited in (A), as described in Example 10(c).

FIG. 98 shows in (A) an SEM image obtained for Layer 2, in (B) an SEM image as well as EDS mapping of Cu (pink), Al (blue), O (green) and C (red) obtained for Layer 2, and in (C) and (D) respectively EDS mapping images of Cu and C obtained for the area delimited in (A) and (B), as described in Example 10(c).

FIG. 99 shows in (A) a SEM image obtained for Layer 2 as well as EDS mapping of O (green) and C (red), and in (B) and (C) EDS mapping images respectively of C and O obtained for the area delimited in (A), as described in Example 10(c).

FIG. 100 shows a graph of capacity versus number of cycles obtained at charge and discharge currents of C/6, C/4, C/3, C/2 and 1 C for Cells 10 (▪), 11 (●), 12 (▴) and 13 (▴) and References 5 (★) and 6 ( [symbol] ) as described in Example 10(d).

FIG. 101 shows a graph of coulombic efficiency versus number of cycles obtained for Cells 10 (▪), 11 (●), 12 (▴) and 13 (▾) and References 5 (★) and 6 ( [symbol] ), as described in Example 10(d).

### DETAILED DESCRIPTION

All technical and scientific terms and expressions used herein have the same definitions as those generally understood by the person skilled in the art of the present technology. The definition of some terms and expressions used is nevertheless provided below.

When the term “about” is used herein, it means approximately, in the region of, or around. For example, when the term “about” is used in relation to a numerical value, it modifies it by a variation of 10% above and below its nominal value. This term can also take into account, for example, the experimental error of a measuring device or rounding.

When a range of values is mentioned in the present application, the lower and upper limits of the range are, unless otherwise indicated, always included in the definition. When a range of values is mentioned in the present application, then all intermediate ranges and subranges, as well as the individual values included in the ranges of values, are included in the definition.

When the article “a” is used to introduce an element in the present application, it does not have the meaning of “only one”, but rather of “one or more”. Of course, where the description states that a particular step, component, element, or feature “may” or “could” be included, that particular step, component, element, or feature is not required to be included in each embodiment.

The term “self-supporting electrode” as used herein refers to an electrode without a metal current collector.

The chemical structures described herein are drawn according to the conventions of the field. Also, when an atom, such as a carbon atom, as drawn seems to include an incomplete valence, then it is assumed that the valence is satisfied by one or more hydrogen atoms even if they are not explicitly drawn.

The term “aromatic” refers to an aromatic group having 4n+2 conjugated π(pi) electrons in which n is a number from 1 to 3, in a monocyclic group, or a fused bicyclic or tricyclic system having a total of from 6 to 15 ring members, in which at least one of the rings of a system is aromatic.

The present technology relates to the formation of a layer of coating material on an electrode material comprising an electrochemically active material. This coating material comprises an organometallic structure (“Metal Organic Framework, MOF”) forming a network of at least one lithophilic metal and at least one organic ligand. The organometallic structure of the coating is calcined, preferably before its application to the electrode film. The electrode is preferably a negative electrode.

The present technology therefore relates to an electrode material comprising an electrochemically active material and a coating layer comprising a coating material based on a calcined lithiophilic organometallic structure comprising at least one lithiophilic metal and at least one at least partially calcined organic ligand, said coating layer disposed on a surface of said electrochemically active material.

The electrochemically active material may comprise an alkali metal, an alkaline-earth metal, a non-alkali and non-alkaline-earth metal or an alloy comprising at least one thereof, for example, in the form of a metal film. Preferably, the electrochemically active material comprises an alkali metal, an alkaline-earth metal, or an alloy comprising at least one alkali or alkaline-earth metal. For example, the electrochemically active material comprises metallic lithium or an alloy including or based on metallic lithium. The electrochemically active material may also comprise nickel. According to one example, the electrochemically active material is a lubricated metal film.

When the electrochemically active material is in the form of a film, it can have a thickness in the range from about 5 μm to about 75 μm, or from about 15 μm to about 70 μm, or from about 25 μm to about 65 μm, or from about 30 μm to about 60 μm, or from about 45 μm to about 55 μm, upper and lower limits included.

The organometallic structure comprises a lithiophilic metal. Any known compatible lithiophilic metal is contemplated. Non-limiting examples of lithiophilic metals include Ag, Zn, Sn, Sb, Mg, Al, Ni, Cu, Co, and a combination of at least two thereof. After calcination, the lithiophilic metal may be present in the calcined lithiophilic organometallic structure, for example, in elemental, metal oxide, metal nitride, and/or metal fluroride form. For example, the form in which the lithiophilic metal is present in the calcined lithiophilic organometallic structure may vary depending on the gas or mixture of gases present in the atmosphere used during calcination of the lithiophilic organometallic structure.

The organic ligand before calcination is generally an organic compound comprising at least two functions capable of forming a bond (for example, ionic, covalent, etc.) with the lithiophilic metal. Each of these functions generally comprises at least one heteroatom (for example, N, O, S, P, etc.). For example, the organic ligand is an organic ligand comprising a nitrogen function, an organic ligand comprising a carboxylate, or a mixed organic ligand comprising a nitrogen and/or carboxylate function. For example, the ligand comprises at least two, or at least three, or at least four carboxylate groups, preferably linked by an aromatic or polyaromatic group (such as 1,2,4,5-benzenetetracarboxylic acid). Alternatively, the ligand comprises at least one carboxylate group and a nitrogen function linked by or forming part of an aromatic group (such as 1H-benzimidazole-6-carboxylic acid). Any type of compatible organic ligand forming a repeating structure with a lithiophilic metal is contemplated.

Non-limiting examples of lithiophilic organometallic structures (before calcination) include Formulae 1 to 9 or one of their positional isomers:

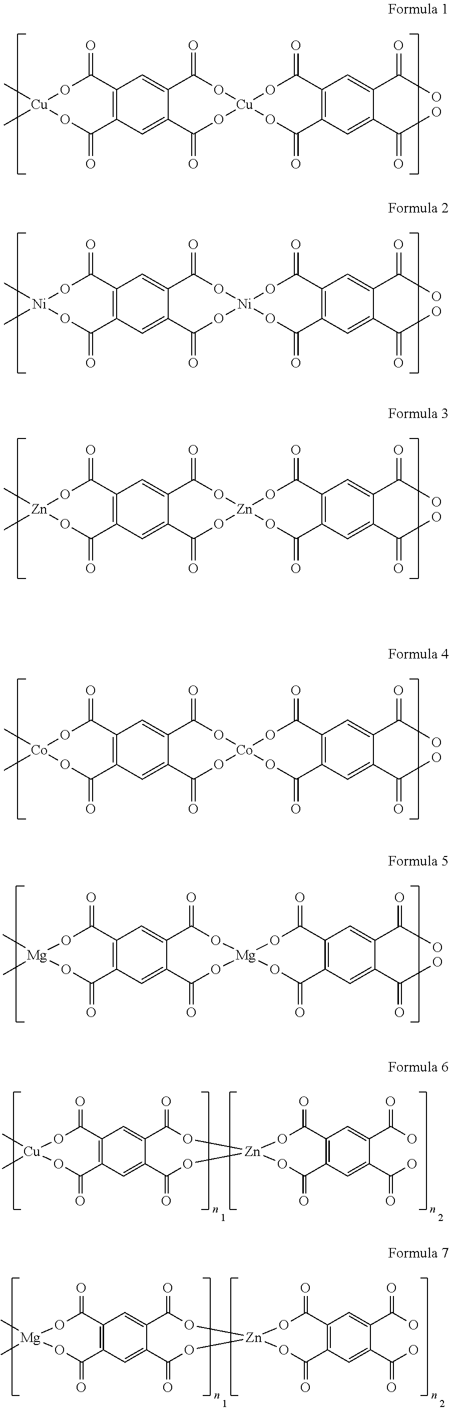

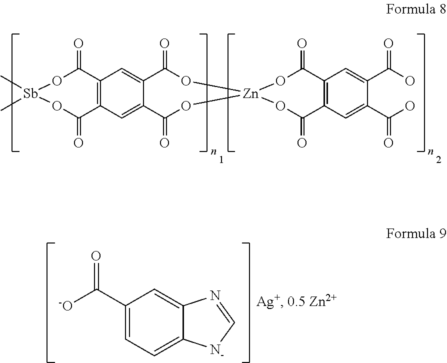

wherein n₁ and n₂, when present, indicate the ratio of each unit and are independently selected numbers in the range from 0.1 to 0.9.

Some of the calcined lithiophilic organometallic structures may also further comprise a metal source, for example, a silver source. According to one example, the silver source is a silver salt such as silver chloride (AgCl) or silver nitrate (AgNO₃). When a silver salt is included, it may be present in a lithiophilic metal:silver ratio in the range from about 1:1 to about 5:1, or from about 4:3 to about 4:1, upper and lower limits included.

The coating material may also comprise other elements, such as a solid electrolyte polymer, preferably crosslinked. The latter may be composed of a salt in a solvating polymer. The solid electrolyte polymer included in the coating material may then be a copolymer of ethylene oxide and at least one substituted oxirane comprising a crosslinkable function.

According to one example, the copolymer comprises units based on ethylene oxide and —O—CH₂—CHR— units, wherein R is a substituent comprising a crosslinkable functional group, for example by radical route, and is independently selected from one unit to another. The copolymer may also further comprise —O—CH₂—CHR′— units, wherein R′ is a substituent being free of radically crosslinkable functional groups and is independently selected from one unit to the other.

According to some examples, the copolymer has a polymolecularity index (I=M_{w}/Mₙ) of less than or equal to 2.2, wherein Mₙ is the number average molecular weight of the copolymer and is greater than or equal to 20,000 and M_{w} is the weight average molecular weight. For example, the polymolecularity index can be determined by size exclusion chromatography (SEC).

The salt included in the solid polymer electrolyte of the coating material is preferably a lithium salt. Non-limiting examples of lithium salts include lithium hexafluorophosphate (LiPF₆), lithium bis(trifluoromethanesulfonyl)imide (LiTFSI), lithium bis(fluorosulfonyl)imide (LiFSI), lithium 2-trifluoromethyl-4,5-dicyanoimidazolate (LiTDI), lithium 4,5-dicyano-1,2,3-triazolate (LIDCTA), lithium bis(pentafluoroethylsulfonyl)imide (LiBETI), lithium tetrafluoroborate (LiBF₄), lithium bis(oxalato)borate (LiBOB), lithium nitrate (LiNO₃), lithium chloride (LiCl), lithium bromide (LiBr), lithium fluoride (LiF), lithium perchlorate (LiClO₄), lithium hexafluoroarsenate (LiAsF₆), lithium trifluoromethanesulfonate (LiSO₃CF₃) (LiOTf), lithium fluoroalkylphosphate Li[PF₃(CF₂CF₃)₃] (LiFAP), lithium tetrakis(trifluoroacetoxy)borate Li[B(OCOCF₃)₄] (LiTFAB), lithium bis(1,2-benzenediolato(2-)-O,O′)borate Li[B(C₆O₂)₂] (LiBBB), or a combination of at least two thereof. Preferably, the lithium salt comprises LiTFSI.

The coating layer may have a thickness in the range from about 1 μm to about 20 μm, or from about 1 μm to about 19 μm, or from about 1 μm to about 18 μm, or from about 1 μm to about 17 μm, or from about 1 μm to about 16 μm, or from about 1 μm to about 15 μm, or from about 1 μm to about 14 μm, or from about 1 μm to about 13 μm, or from about 2 μm to about 12 μm, upper and lower limits included, preferably in the range from about 2 μm to about 12 μm, upper and lower limits included.

According to another example, the coating layer is a first coating layer and the electrode material comprises a second layer of coating material. For example, the second coating layer may have a thickness in the range from about 1 μm to about 20 μm, or from about 1 μm to about 19 μm, or from about 1 μm to about 18 μm, or from about 1 μm to about 17 μm, or from about 1 μm to about 16 μm, or from about 1 μm to about 15 μm, or from about 1 μm to about 14 μm, or from about 2 μm to about 14 μm, upper and lower limits included, preferably in the range from about 2 μm to about 14 μm, upper and lower limits included. Preferably, the second coating layer comprises a polymer such as a non-crosslinked solid electrolyte polymer.

The electrode material as herein defined is generally prepared by a process comprising a step of depositing the coating layer based on calcined lithiophilic organometallic structures on the surface of the electrochemically active material. According to some examples, the process further comprises a step of depositing the second coating layer. The deposition step (or steps) can be carried out by at least one of a doctor blade coating method, a comma coating method, a reverse-comma coating method, a printing method such as gravure coating, a slot-die coating method, or a spray deposition method. Preferably, the deposition step (or steps) is (are) carried out by a spray deposition method.

The process may also further comprise the preparation of the coating material based on calcined lithiophilic organometallic structures, for example, comprising the preparation of the calcined lithiophilic organometallic structures. For example, the preparation of the calcined lithiophilic organometallic structures comprises a step of contacting at least one organic ligand with at least one lithiophilic metal precursor to obtain a lithiophilic organometallic structure, and a step of calcining the lithiophilic organometallic structure to obtain the calcined lithiophilic organometallic structure. For example, the calcination step is carried out at a temperature in the range from about 500° C. to about 1050° C., upper and lower limits included, preferably in the range from about 550° C. to about 1000° C., upper and lower limits included. The calcination step can be carried out in an inert atmosphere comprising, for example, a gas selected from argon, nitrogen, helium, a fluorinated gas, and a mixture comprising at least one therefor. Preferably, the inert atmosphere gas comprises argon.

The present electrode material is used in the manufacture of electrodes, for example, negative electrodes. For example, a negative electrode as herein contemplated comprises the electrode material as herein defined or the electrode material obtained according to the process defined above, with or without a current collector (self-supported).

An electrochemical cell comprising the present electrode material or the above negative electrode is also contemplated. This electrochemical cell comprises, for example, a negative electrode, a positive electrode, and an electrolyte, wherein the negative electrode is as defined above or comprises an electrode material as defined herein.

The positive electrode comprises an electrochemically active material. Examples of electrochemically active materials of the positive electrode include a metal oxide, a metal sulfide, a metal oxysulfide, a metal phosphate, a metal fluorophosphate, a metal oxyfluorophosphate, a metal sulfate, a metal halide, a metal fluoride, sulfur, selenium, and a combination of at least two of thereof when compatible. For example, the metal of the electrochemically active material is selected from titanium (Ti), iron (Fe), manganese (Mn), vanadium (V), nickel (Ni), cobalt (Co), aluminum (Al), chromium (Cr), copper (Cu), zirconium (Zr), niobium (Nb), and a combination of at least two thereof. The metal may further comprise an alkali or alkaline earth metal selected from lithium (Li), sodium (Na), potassium (K), and magnesium (Mg). According to one example, the electrochemically active material of the positive electrode is a lithium metal phosphate, such as LiFePO₄.

The electrolyte of the electrochemical cell is preferably a solid electrolyte, for example, a solid polymer electrolyte comprising a salt in a solvating polymer which may be as defined for the coating material.

The present document also relates to electrochemical accumulators or batteries comprising at least one electrochemical cell as herein defined. For example, the battery is selected from the group consisting of a lithium battery, a lithium-ion battery, a sodium battery, a sodium-ion battery, a potassium battery, a potassium-ion battery, a magnesium battery, and a magnesium-ion battery, preferably a lithium or lithium-ion battery.

The present technology also includes the use of the present electrochemical accumulators or batteries, among others, in portable devices (such as cell phones, cameras, tablets or laptops), in electric or hybrid vehicles, or in renewable energy storage.

### EXAMPLES

The following examples are for illustrative purposes only and should not be construed as further limiting the scope of the invention as contemplated. These examples will be better understood by referring to the accompanying figures.

### Example 1—Preparation and Characterization of Lithiophilic MOFs Based on Metal Cations Linked to Aromatic Polycarboxylate Ligands

### a) Preparation of Lithiophilic MOFs

Lithiophilic MOFs based on metal cations (M=Cu²⁺, Ni²⁺, Zn²⁺, or Co²⁺) were prepared from 1,2,4,5-benzenetetracarboxylic acid (H₄btec) and at least one metal salt or metal compound (for example, copper(II) acetate (Cu(OAc)₂), nickel(II) carbonate (NiCO₃), zinc oxide (ZnO), or cobalt (II) carbonate (CoCO₃)). The MOFs prepared in the present example are presented in Table 1.

TABLE 1
Formulas of the MOFs prepared in the present example

| | Lithiophilic | Lithiophilic |
|---|---|---|
| | organometallic | organometallic |
| MOF | structure | structure |
| MOF 1 | [Cu₂(btec)], nH₂O | 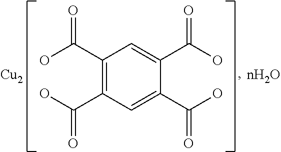 |
| MOF 2 | [Ni₂(btec)], nH₂O | 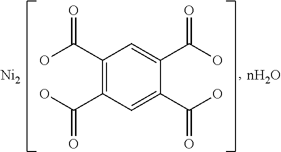 |
| MOF 3 | [Zn₂(btec)], nH₂O | 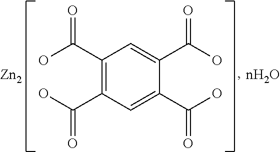 |
| MOF 4 | [Zn₂(btec)], nH₂O | 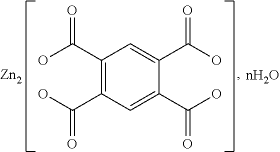 |
| MOF 5 | [Co₂(btec)], nH₂O | 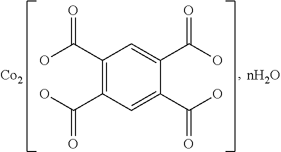 |

### b) Characterization of the Lithophilic MOFs by Thermogravimetric Analysis (TGA)

The MOFs prepared in Example 1(a) were characterized by thermogravimetric analysis to evaluate their thermal stability and their conversion process. Thermogravimetric analyses were carried out under a constant air flow rate of 100 mL/min over a temperature range from about 30° C. to about 1000° C. and at a temperature increase rate of 5° C./min. The results of the thermogravimetric analyses obtained for MOFs 1 to 5 are presented in FIG. 1 and summarized in Table 2.

TABLE 2
Summary of the thermogravimetric analyses (MOFs 1 to 5)

| MOF | Figure |
|---|---|
| MOF 1 | FIG. 1(A) |
| MOF 2 | FIG. 1(B) |
| MOF 3 | FIG. 1(C) (solid line) |
| MOF 4 | FIG. 1(C) (dashed line) |
| MOF 5 | FIG. 1(D) |

FIG. 1(A) shows a first mass loss at a temperature below 100° C. which can be attributed to the removal of water, a second mass loss from a temperature of about 150° C. which can be attributed to the decomposition of coordinated water molecules, and a third mass loss that can be attributed to the decomposition of the organic ligand starting at a temperature of about 250° C.

FIG. 1(B) shows a first mass loss at a temperature below 150° C. which can be attributed to the removal of water and a second mass loss which can be attributed to the decomposition of the organic ligand starting at a temperature of about 360° C.

FIG. 1(C) shows a first mass loss at a temperature below 100° C. which can be attributed to the removal of water and a second mass loss which can be attributed to the decomposition of the organic ligand starting at a temperature of about 450° C.

FIG. 1(D) shows a first mass loss at a temperature below 250° C. which can be attributed to the removal of water and a second mass loss which can be attributed to the decomposition of the organic ligand starting at a temperature of about 350° C.

### c) SEM Characterization of the Lithiophilic MOFs

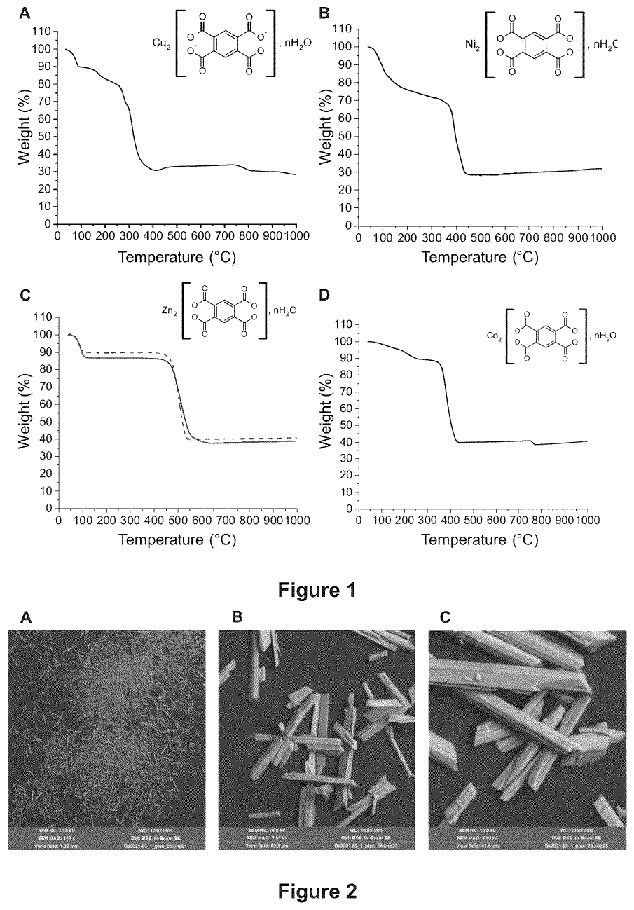

The MOFs prepared in Example 1(a) were imaged using a scanning electron microscope (SEM) equipped with a secondary electron (SE) detector to highlight topography and morphology, and a backscattered electron (BSE) detector to study chemical contrast, or only a BSE detector when indicated. All SEM images were obtained at an accelerating voltage of 10.0 kV. The images obtained for MOFs 1 to 5 are shown in FIGS. 2 to 6 and summarized in Table 3.

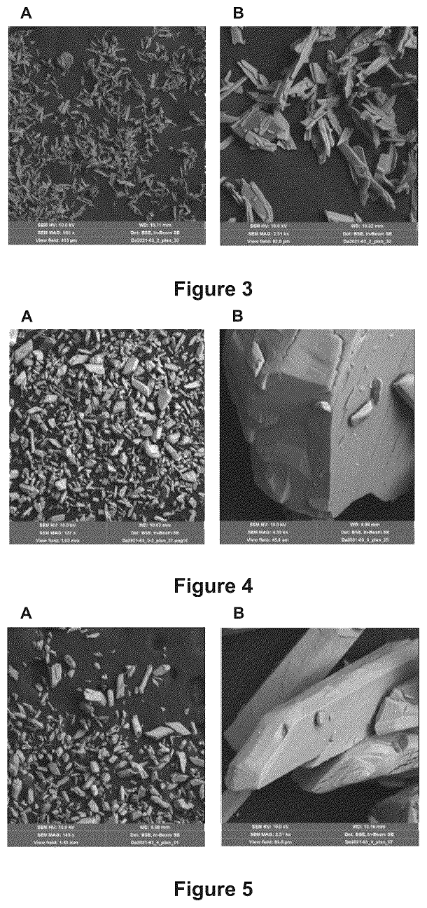

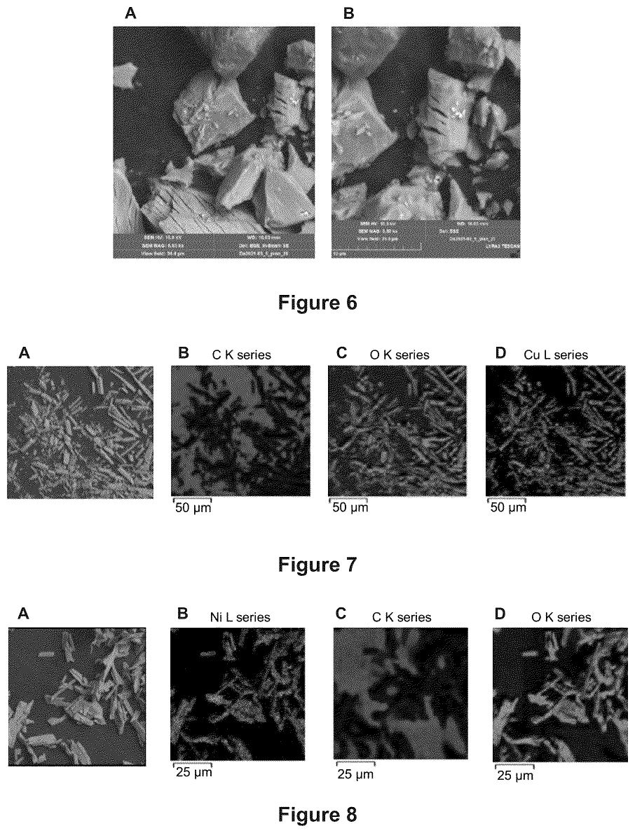

TABLE 3
Summary of the SEM images obtained for MOFs 1 to 5

| | | Working | | | | |
|---|---|---|---|---|---|---|
| | | distances | | | Horizontal field | |
| MOF | Figure | (mm) | Magnifications | | of view | |
| MOF 1 | FIG. 2(A) | 10.02 | 149 | x | 1.39 | mm |
| | FIG. 2(B) | 10.05 | 2.51K | x | 82.6 | μm |
| | FIG. 2(C) | 10.05 | 5.01K | x | 41.5 | μm |
| MOF 2 | FIG. 3(A) | 10.11 | 502 | x | 413 | μm |
| | FIG. 3(B) | 10.22 | 2.51K | x | 82.8 | μm |
| MOF 3 | FIG. 4(A) | 10.02 | 127 | x | 1.63 | mm |
| | FIG. 4(B) | 9.98 | 4.55K | x | 45.6 | μm |
| MOF 4 | FIG. 5(A) | 9.98 | 145 | x | 1.43 | mm |
| | FIG. 5(B) | 10.16 | 2.51K | x | 82.8 | μm |
| MOF 5 | FIG. 6(A) | 10.03 | 6.03K | x | 34.4 | μm |
| | FIG. 6(B) | 10.03 | 9.88K | x | 21.0 | μm |

It is possible to observe in FIGS. 2 and 3 that the particles of MOFs 1 and 2 have a substantially elongated rod-shaped morphology with a diameter ranging from about 2 μm to about 30 μm.

FIGS. 4 and 5 show that the particles of MOFs 3 and 4 have a variable morphology, with diameters ranging from about 20 μm to about 200 μm, upper and lower limits included.

FIG. 6 shows SEM images obtained in (A) with a SE detector and a BSE detector, and in (B) with a BSE detector. It is possible to observe that the MOF 5 particles have a variable morphology with diameters ranging from about 20 μm to about 100 μm.

### d) EDS Characterization of the Lithophilic MOFs

The elemental analysis or chemical characterization of the MOFs prepared in Example 1(a) was carried out using a SEM equipped with an X-ray detector for EDS analysis. FIGS. 7 to 10 show in (A) SEM images of the elements for MOFs 1 to 4 respectively, and in (B) to (D) the corresponding EDS mapping images. The images obtained from EDS mapping are summarized in Table 4.

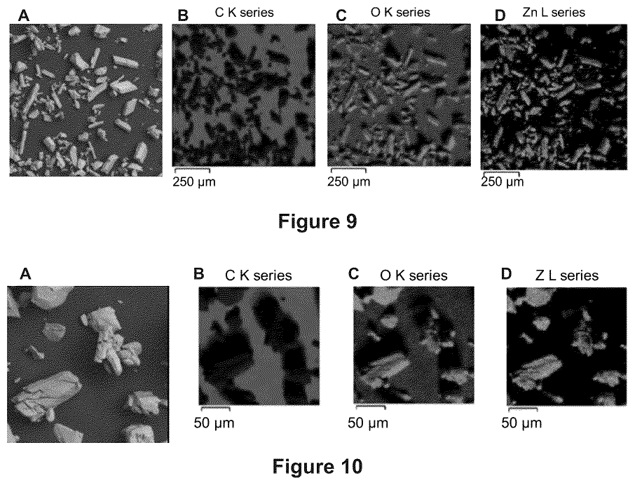

TABLE 4
Summary of the EDS images obtained for MOFs 1 to 4

| | | | Scale bar |
|---|---|---|---|
| MOF | Figure | Element | (μm) |
| MOF 1 | FIG. 7(B) | C K series | 50 |
| | FIG. 7(C) | O K series | |
| | FIG. 7(D) | Cu L series | |
| MOF 2 | FIG. 8(B) | Ni L series | 25 |
| | FIG. 8(C) | C K series | |
| | FIG. 8(D) | O K series | |
| MOF 3 | FIG. 9(B) | C K series | 250 |
| | FIG. 9(C) | O K series | |
| | FIG. 9(D) | Zn L series | |
| MOF 4 | FIG. 10(B) | C K series | 50 |
| | FIG. 10(C) | O K series | |
| | FIG. 10(D) | Zn L series | |

The EDS mapping images in FIGS. 7 to 10 show that the particle composition of MOFs 1 to 4 is substantially homogeneous at the elemental level.

### Example 2—Preparation and Characterization of Calcined Lithiophilic MOFs Based on Metal Cations Linked to Aromatic Polycarboxylate Ligands

### a) Preparation of the Calcined Lithiophilic MOFs

Calcined MOFs based on metal cations linked to aromatic polycarboxylate ligands were prepared from metal cations (M=Cu²⁺, Ni²⁺, Zn²⁺, or Co²⁺) and 1,2,4,5-benzenetetracarboxylic acid (H₄btec). The MOFs were calcined under an inert argon atmosphere according to the following protocol:
1. temperature increase from room temperature to 200° C. at a temperature increase rate of 1° C./min;
2. plateau for 1 hour at 200° C.;
3. temperature increase from 200° C. to the calcination temperature at a temperature increase rate of 3° C./min; and
4. plateau for 2 hours at the calcination temperature.

The calcined MOFs prepared in the present example, the calcination temperatures, the theoretical yields after calcination determined by TGA, and the yields after calcination are presented in Table 5.

TABLE 5
Calcination temperatures, theoretical yields after calcination determined
by TGA, and yields after calcination for MOFs 6 to 10

| | | Calcination | Theoretical yield | |
|---|---|---|---|---|
| | | temperature | after calcination (%) | Yield after |
| MOF | MOF before calcination | (°C.) | determined by TGA | calcination (%) |
| MOF 6 | [Cu₂(btec)], n H₂O | 750 | 30-35 | 39 |
| MOF 7 | [Ni₂(btec)], n H₂O | 750 | 30 | 35 |
| MOF 8 | [Zn₂(btec)], n H₂O | 550 | 40 | 53 |
| MOF 9 | [Zn₂(btec)], n H₂O | 650 | 40 | 50 |
| MOF 10 | [Zn₂(btec)], n H₂O | 750 | 40 | 43 |

### b) Characterization of the Calcined Lithiophilic MOFs by TGA

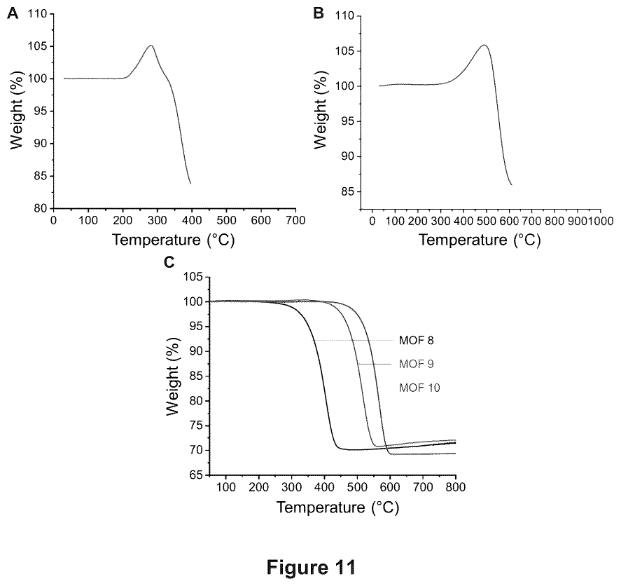

The calcined MOFs prepared in Example 2(a) were characterized by TGA to evaluate their respective metal content. Thermogravimetric analyses were carried out under a constant air flow rate of 100 mL/min and a temperature increase rate of 5° C./min. The results of the thermogravimetric analyses obtained for MOFs 6 to 10 are presented in FIG. 11 and summarized in Table 6.

TABLE 6
Summary of the thermogravimetric analyses
obtained for MOFs 6 to 10

| MOF | FIG. |
|---|---|
| MOF 6 | FIG. 11(A) |
| MOF 7 | FIG. 11(B) |
| MOF 8 | FIG. 11(C) |
| MOF 9 | FIG. 11(C) |
| MOF 10 | FIG. 11(C) |

FIG. 11(A) shows the thermogravimetric curve obtained for MOF 6. The thermogravimetric analysis was carried out over a temperature range from about 30° C. to about 700° C. It is possible to observe that the mechanism of oxidation of the metal in air does not allow for its adequate quantification.

FIG. 11(B) shows the thermogravimetric curve obtained for MOF 7. The thermogravimetric analysis was carried out over a temperature range from about 30° C. to about 900° C. It is possible to observe that the mechanism of oxidation of the metal in air does not allow for its adequate quantification.

FIG. 11(C) shows the thermogravimetric curves obtained for MOFs 8 to 10. The thermogravimetric analyses were carried out over a temperature range from about 50° C. to about 800° C. The mass of metal present in MOFs 8 to 10 was estimated at about 70 wt. %. It is possible to observe in FIG. 11(C) that the carbon in MOFs calcined at a higher temperature appears graphitic and requires a higher temperature to degrade in air. It is also possible to observe in FIG. 11(C) the absence of mass gain which can be attributed either, for example, to the presence of ZnO particles or to the presence of a ZnO layer on the surface of Zn particles.

### c) Characterization of the Calcined Lithiophilic MOFs by Raman Microspectroscopy

The analysis of the molecular composition of the calcined MOFs prepared in Example 2(a) was carried out by Raman microspectroscopy.

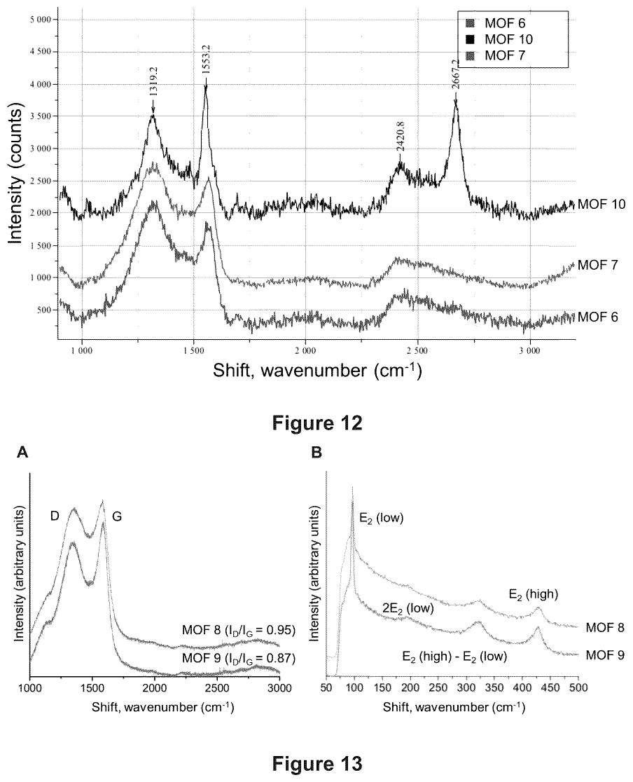

FIG. 12 shows Raman spectra obtained for MOFs that were calcined at a temperature of 750° C. (MOFs 6, 7 and 10). It is possible to observe a substantially graphitic carbon for the calcined MOF based on Ni²⁺ (MOF 7). Calcined MOFs based on Cu²⁺ and Zn²⁺ (MOFs 6 and 10) appear to produce carbon of a similar and substantially disordered nature. FIG. 13 shows Raman spectra obtained for MOFs based on Zn²⁺ calcined at a temperature of 550° C. and 650° C. (MOFs 8 and 9). FIG. 13 shows in (A) an intensity ratio of the D band to the G band (I_{D}/I_{G}) for MOF 8 of 0.95 and for MOF 9 of 0.87. The carbon produced by the calcination of these two MOFS would therefore be substantially amorphous. A comparison of the Raman spectrum shown in FIG. 13 (B) with those of other Raman spectroscopy work carried out on ZnO (Song, Yin, et al. “Raman spectra and microstructure of zinc oxide irradiated with swift heavy ion.” Crystals 9.8 (2019): 395) highlights the presence of ZnO in the analyzed samples.

### d) Characterization of the Surface of the Calcined Lithiophilic MOFs by the Brunauer, Emmett and Teller (BET) Method

The pore size, specific surface area, and pore volume of the calcined MOFs prepared in Example 2(a) were characterized.

Nitrogen adsorption/desorption isotherms (graph of the volume of adsorbed nitrogen (cm³/g) as a function of the relative nitrogen pressure P/P₀) were obtained for each of the MOFs prepared in Example 2(a). The pore size (nm), pore volume distribution (dV/dw) (cm³/g·nm), specific surface area (m²/g), and total pore volume (cm³/g) were extracted from these isotherms. The pore size determination was carried out using the Broekhoff and de Boer (BdB) method. The pore volume distribution was determined by the Barett, Joyner, and Halenda (BJH) method. The specific surface area and pore volume were calculated using the BET method.

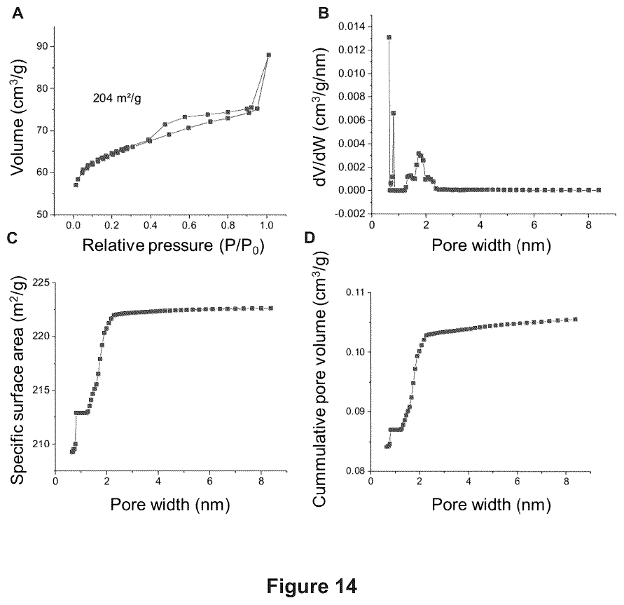

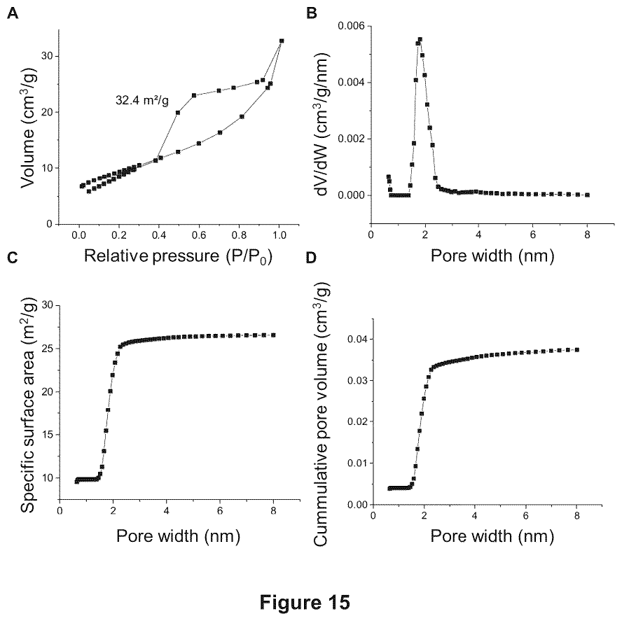

FIGS. 14 and 15 show in (A) a nitrogen adsorption/desorption isotherm, in (B) a graph of the distribution of pore volumes as a function of the pore width, in (C) a graph of the specific surface area as a function of pore width, and in (D) a graph of the total pore volume as a function of the pore width obtained for MOFs 6 and 7 respectively.

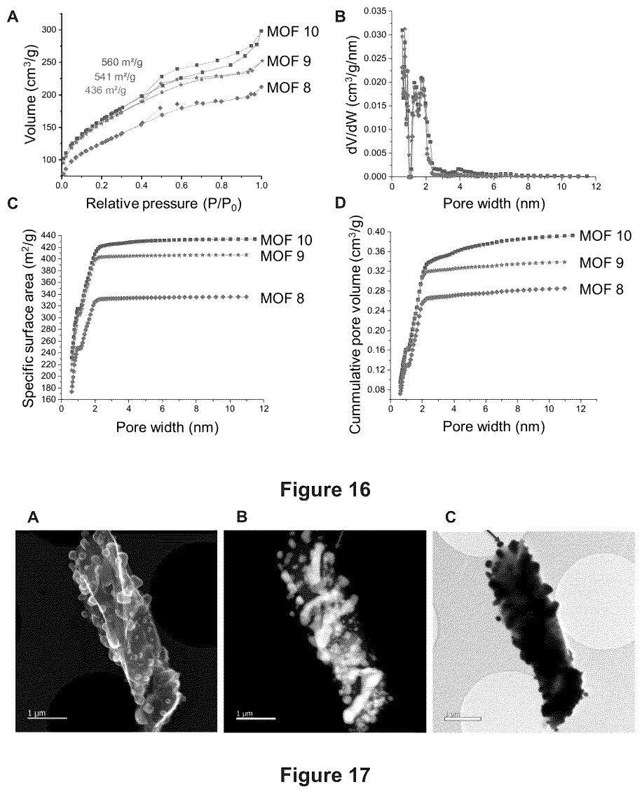

FIG. 16 shows in (A) a nitrogen adsorption/desorption isotherm, in (B) a graph of the distribution of pore volumes as a function of the pore width, in (C) a graph of the specific surface area as a function of the pore width, and in (D) a graph of the total pore volume as a function of the pore width obtained for MOF 8 (♦), le MOF 9 (★), and MOF 10 (▪).

It is possible to observe the presence of a hysteresis loop characteristic of mesoporous materials on the nitrogen adsorption/desorption isotherm of each of the calcined MOFs (MOFs 6 to 10).

Furthermore, it is also possible to conclude that a substantial part of the specific surface area and porosity of each of the calcined MOFs (MOFs 6 to 10) originate from mesopores and not micropores.

### e) Characterization of the Surface of the Calcined Lithiophilic MOFs by TEM and EDS

The calcined MOFs prepared in Example 2(a) were characterized by TEM and EDS.

FIGS. 17 to 38 present TEM images, EDS mapping images, and the results of the EDS analysis obtained for MOFs 6 to 10. The experimental conditions used for the TEM and TEM-EDS analyses carried out for MOFs 6 to 10 are presented in Table 7.

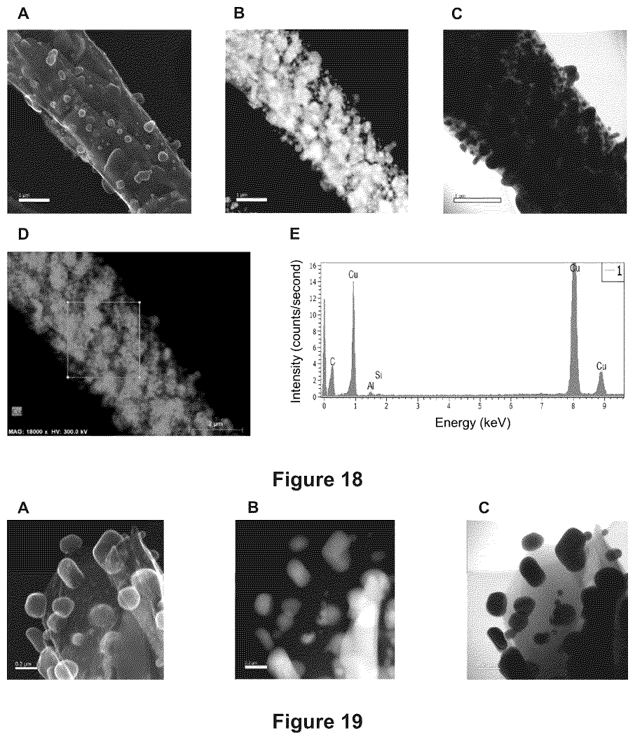

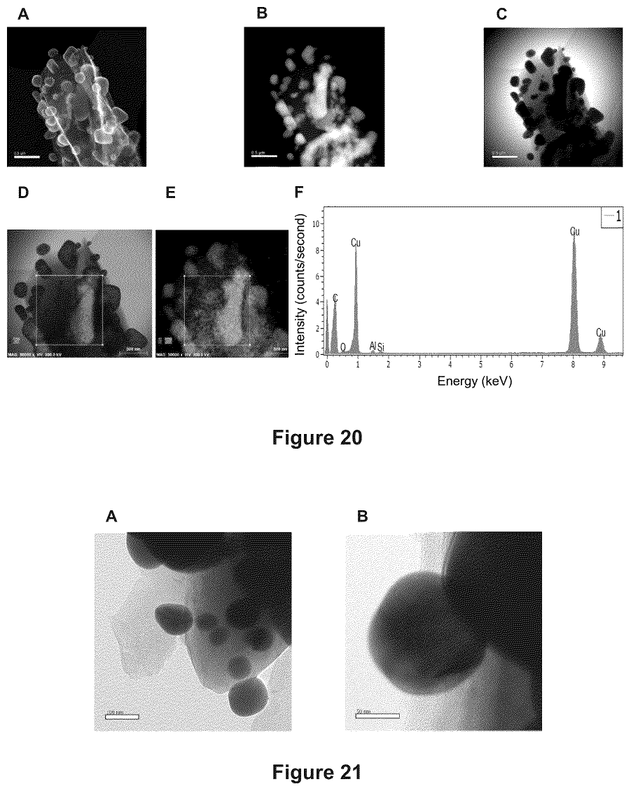

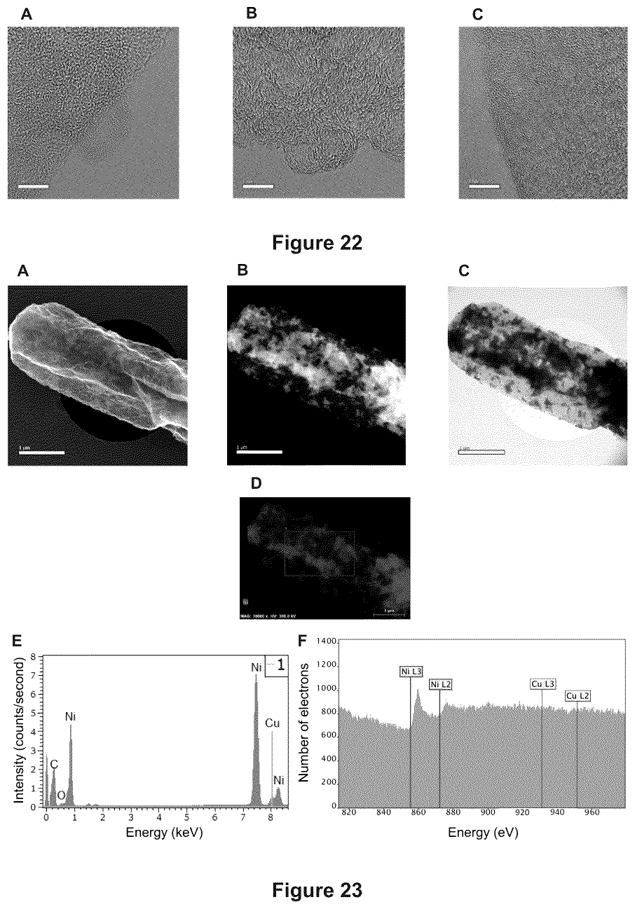

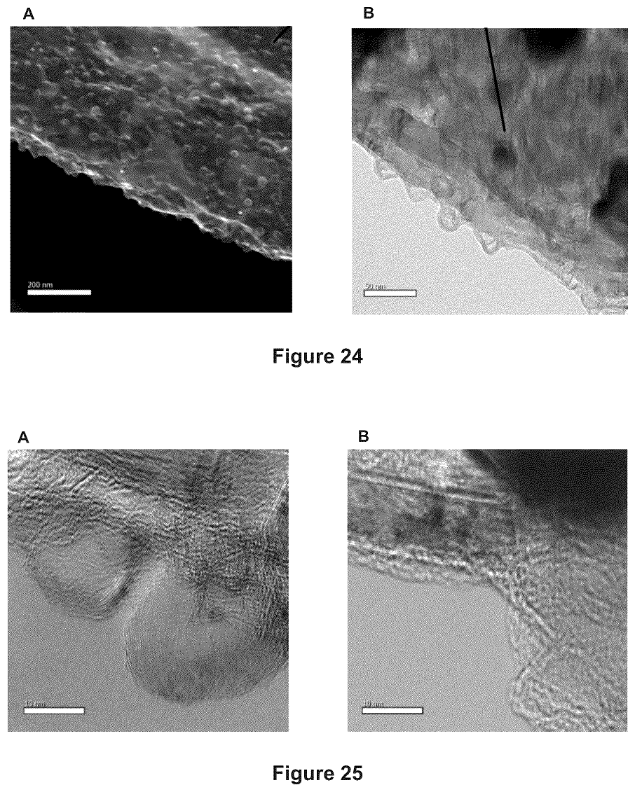

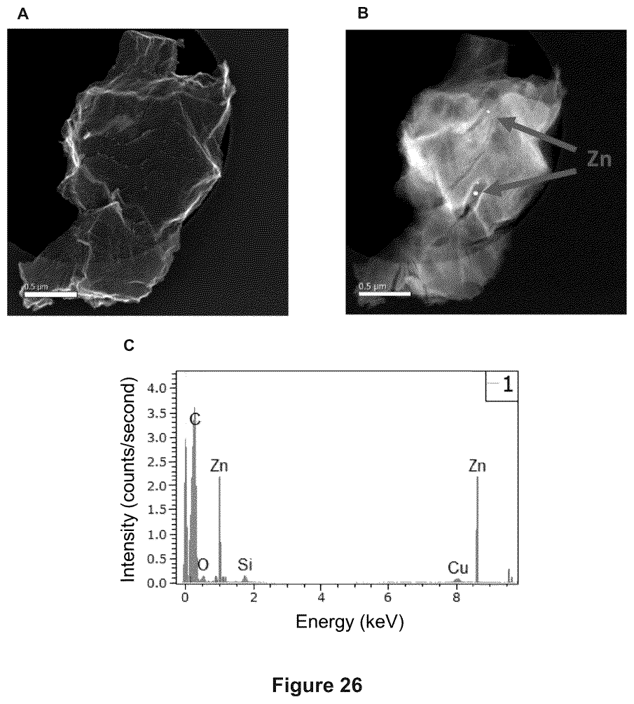

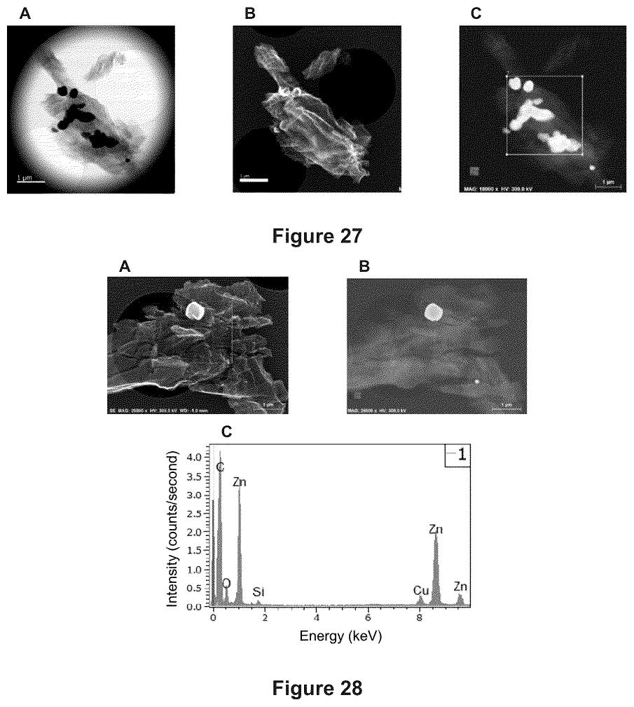

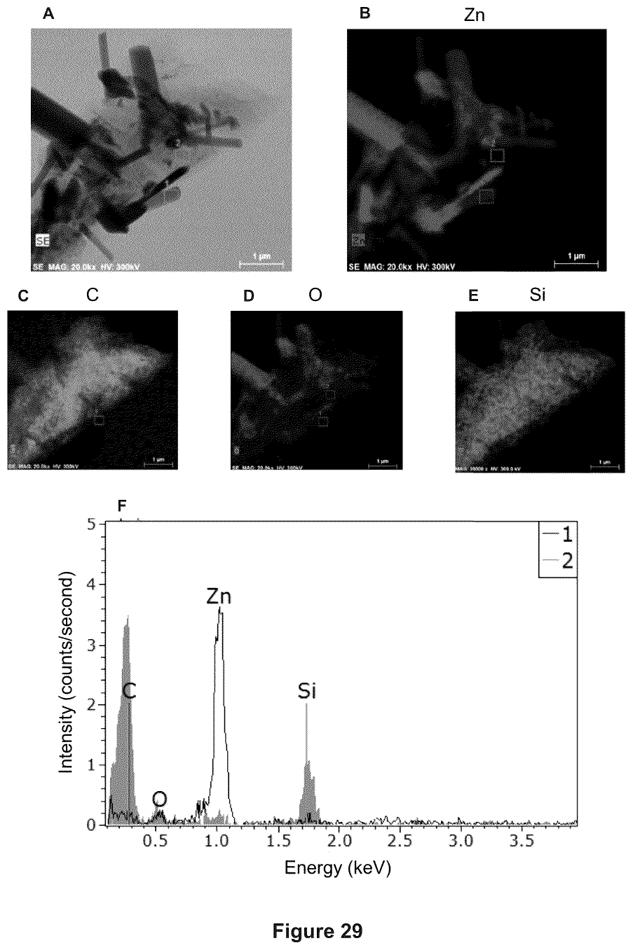

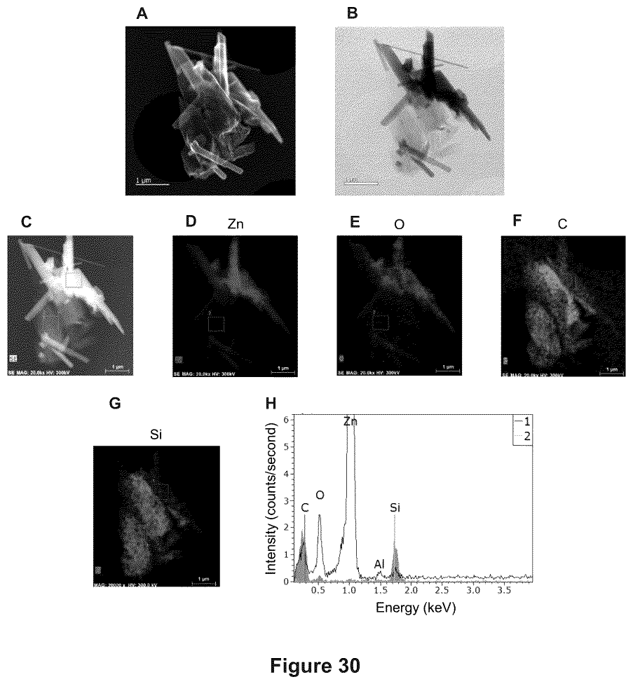

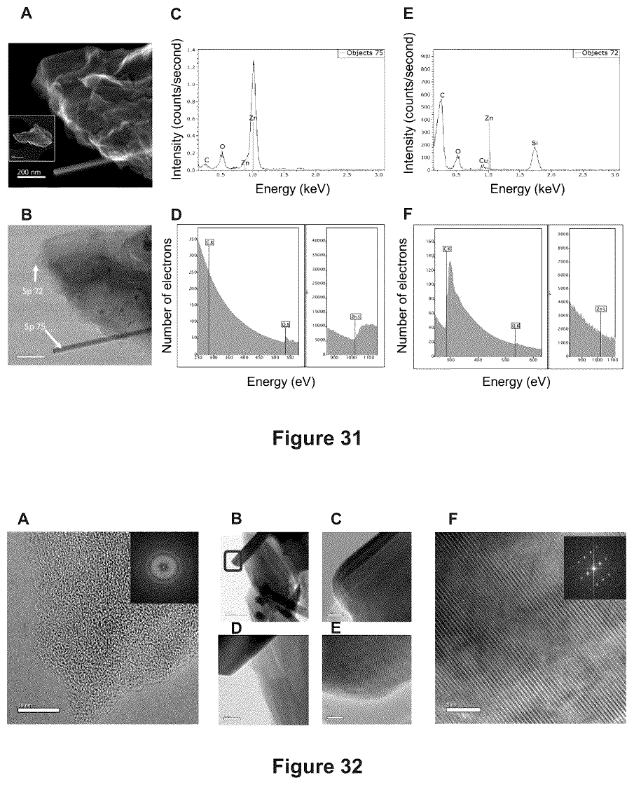

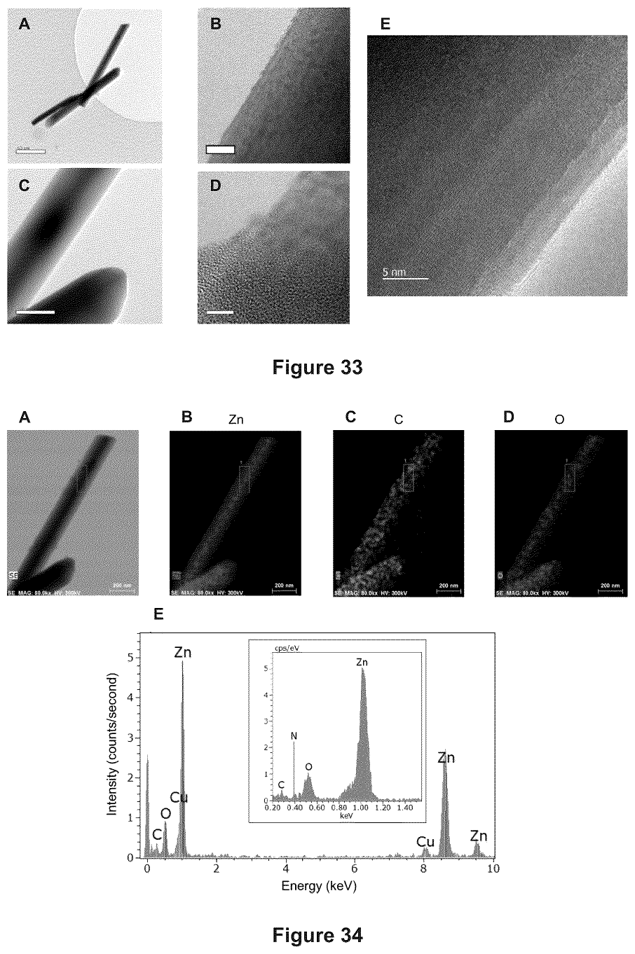

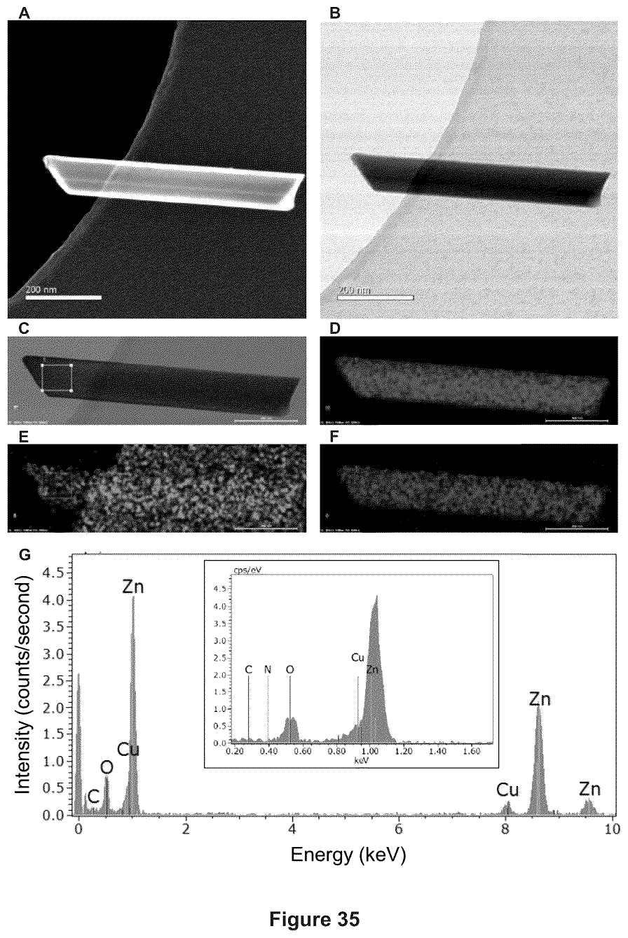

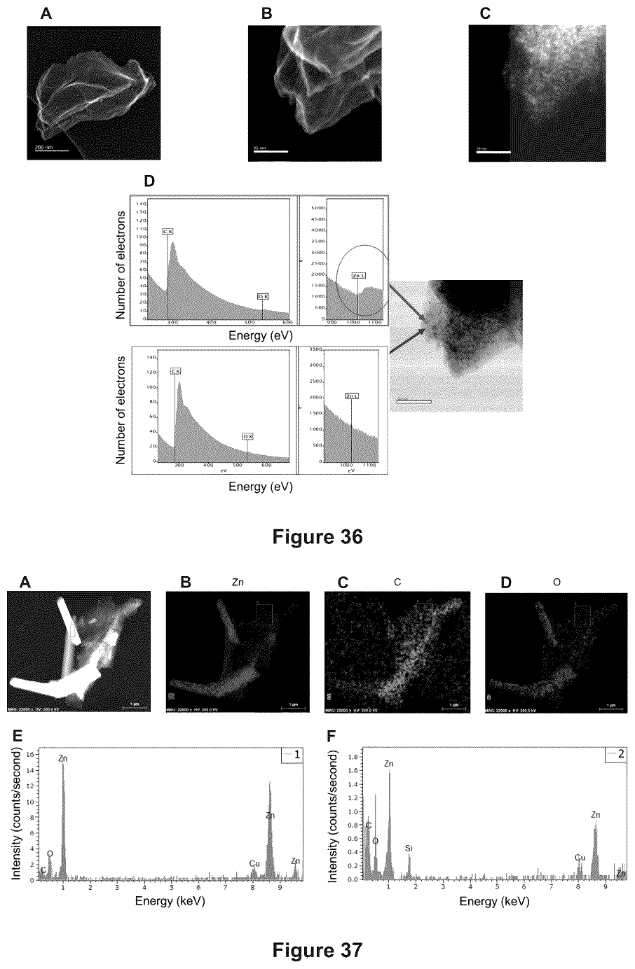

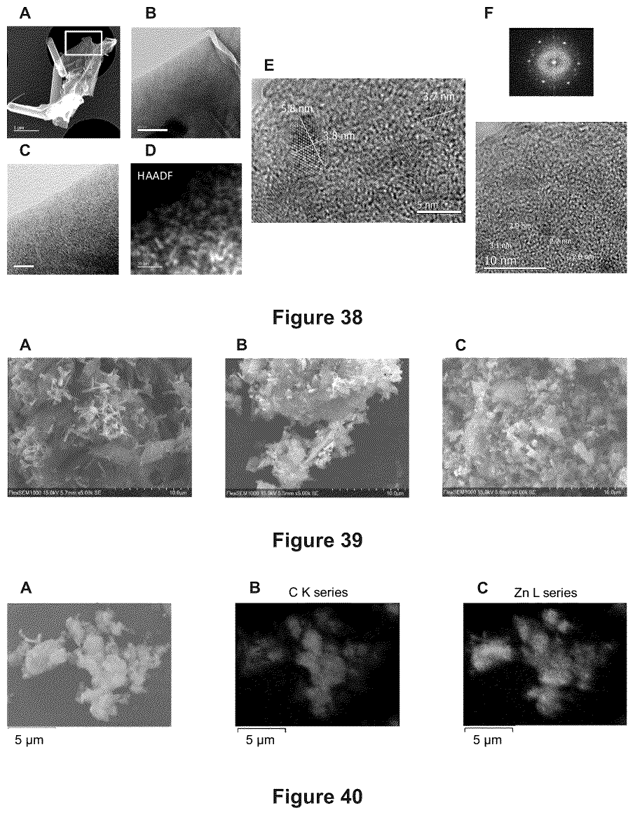

TABLE 7
Experimental conditions used for the TEM and
TEM-EDS analyses carried out for MOFs 6 to 10

| | | | | Scale |
|---|---|---|---|---|
| MOF | FIG. | Detector | Element(s) | bar (μm) |
| MOF 6 | FIG. 17(A) | SE | — | 1 |
| | FIG. 17(B) | HAADF | — | 1 |
| | FIG. 17(C) | TE | — | 1 |
| | FIG. 18(A) | SE | — | 1 |
| | FIG. 18(B) | HAADF | — | 1 |
| | FIG. 18(C) | TE | — | 1 |
| | FIG. 18(D) | EDS | Cu | 2 |
| | FIG. 19(A) | SE | — | 0.2 |
| | FIG. 19(B) | HAADF | — | 0.2 |
| | FIG. 19(C) | TE | — | 0.2 |
| | FIG. 20(A) | SE | — | 0.5 |
| | FIG. 20(B) | HAADF | — | 0.5 |
| | FIG. 20(C) | TE | — | 0.5 |
| | FIG. 20(D) | EDS | Cu | 0.5 |
| | FIG. 20(E) | EDS | C et Cu | 0.5 |
| | FIG. 21(A) | SE | — | 0.1 |
| | FIG. 21(B) | SE | — | 0.05 |
| | FIG. 22(A) | SE | — | 0.005 |
| | FIG. 22(B) | SE | — | 0.005 |
| | FIG. 22(C) | SE | — | 0.005 |
| MOF 7 | FIG. 23(A) | SE | — | 1 |
| | FIG. 23(B) | HAADF | — | 1 |
| | FIG. 23(C) | TE | — | 1 |
| | FIG. 23(D) | EDS | Ni | 1 |
| | FIG. 24(A) | SE | — | 0.2 |
| | FIG. 24(B) | TE | — | 0.05 |
| | FIG. 25(A) | SE | — | 0.01 |
| | FIG. 25(B) | SE | — | 0.01 |
| MOF 10 | FIG. 26(A) | SE | — | 0.5 |
| | FIG. 26(B) | HAADF | — | 0.5 |
| | FIG. 27(A) | TE | — | 1 |
| | FIG. 27(B) | SE | — | 1 |
| | FIG. 27(C) | EDS | Zn | 1 |
| | FIG. 28(A) | SE | — | 1 |
| | FIG. 28(B) | EDS | Zn | 1 |
| MOF 9 | FIG. 29(A) | SE | — | 1 |
| | FIG. 29(B) | EDS | Zn | 1 |
| | FIG. 29(C) | EDS | C | 1 |
| | FIG. 29(D) | EDS | O | 1 |
| | FIG. 29(E) | EDS | Si | 1 |
| | FIG. 30(A) | SE | — | 1 |
| | FIG. 30(B) | TE | — | 1 |
| | FIG. 30(C) | SE | — | 1 |
| | FIG. 30(D) | EDS | Zn | 1 |
| | FIG. 30(E) | EDS | O | 1 |
| | FIG. 30(F) | EDS | C | 1 |
| | FIG. 30(G) | EDS | Si | 1 |
| | FIG. 31(A) | SE | — | 0.2 |
| | FIG. 31(B) | TE | — | 0.2 |
| | FIG. 32(A) | SE | — | 0.01 |
| | FIG. 32(B) | SE | — | 0.5 |
| | FIG. 32(C) | SE | — | 0.005 |
| | FIG. 32(D) | SE | — | 0.05 |
| | FIG. 32(E) | SE | — | 0.005 |
| | FIG. 32(F) | SE | — | 0.005 |
| MOF 8 | FIG. 33(A) | SE | — | 0.5 |
| | FIG. 33(B) | SE | — | 0.01 |
| | FIG. 33(C) | SE | — | 0.1 |
| | FIG. 33(D) | SE | — | 0.005 |
| | FIG. 33(E) | SE | — | 0.005 |
| | FIG. 34(A) | SE | — | 0.2 |
| | FIG. 34(B) | EDS | Zn | 0.2 |
| | FIG. 34(C) | EDS | C | 0.2 |
| | FIG. 34(D) | EDS | O | 0.2 |
| | FIG. 35(A) | SE | — | 0.2 |
| | FIG. 35(B) | SE | — | 0.2 |
| | FIG. 35(C) | SE | — | 0.2 |
| | FIG. 35(D) | EDS | Zn | 0.2 |
| | FIG. 35(E) | EDS | C | 0.2 |
| | FIG. 35(F) | EDS | O | 0.2 |
| | FIG. 36(A) | SE | — | 0.2 |
| | FIG. 36(B) | SE | — | 0.05 |
| | FIG. 36(C) | HAADF | — | 0.05 |
| | FIG. 36(D) | TE | — | 0.05 |
| | FIG. 37(A) | SE | — | 1 |
| | FIG. 37(B) | EDS | Zn | 1 |
| | FIG. 37(C) | EDS | C | 1 |
| | FIG. 37(D) | EDS | O | 1 |
| | FIG. 38(A) | SE | — | 1 |
| | FIG. 38(B) | SE | — | 0.2 |
| | FIG. 38(C) | SE | — | 0.05 |
| | FIG. 38(D) | HAADF | — | 0.02 |
| | FIG. 38(E) | SE | — | 0.005 |
| | FIG. 38(F) | SE | — | 0.01 |

### Analysis of the TEM and TEM-EDS Images Obtained for MOF 6

FIG. 17 shows nanometric metal particles substantially dispersed within and on the surface of the carbon. The arrows in FIGS. 17(B) and 17(C) each point to a copper particle.

FIG. 18(E) shows the results of the EDS analysis obtained for the area delimited on the EDS mapping image shown in FIG. 18(D). FIG. 18(E) shows the presence of copper and its approximate relative abundance in MOF 6.

FIG. (F) shows the results of the EDS analysis obtained for the area delimited on the EDS mapping images shown in FIGS. 18(D) and (E).

FIGS. 21 and 22 show that the carbon is substantially amorphous and substantially disordered. This is consistent with the Raman microspectroscopy analysis shown in Example 2(c).

### Analysis of the TEM and TEM-EDS Images Obtained for MOF 7

FIGS. 23(E) and (F) respectively show a graph of the intensity (counts/seconds) as a function of the energy in (keV) and a graph of the number of electrons as a function of the energy in (eV) obtained for the area delimited on the EDS mapping image shown in FIG. 23(D). FIGS. 23(E) and (F) show the presence of copper and nickel and their approximate relative abundance.

FIG. 24 shows TEM images of MOF 7 on which it is possible to observe nanometric metal particles substantially dispersed in the carbon matrix. The lines in FIG. 24 each indicate a nickel particle.

FIG. 25 shows two TEM images of MOF 7 on which it is possible to observe a substantially more graphitic carbon. This is consistent with the Raman microspectroscopy analysis presented in Example 2(c). It is also possible to observe carbon planes on this figure.

### Analysis of the TEM and TEM-EDS Images Obtained for MOF 10

FIG. 26 shows in (A) and (B) TEM images of MOF 10, and in (C) the results of the corresponding EDS analysis. The two arrows in FIG. 26(B) each point to a zinc particle. FIG. 26 shows that MOF 10 is substantially heterogeneous, comprising, in places, only a few nanometric metal particles.

FIG. 28(C) is a graph showing the results of the EDS analysis obtained for the area delimited on the EDS mapping image shown in FIG. 28(B).

FIGS. 27 and 28 show the presence of agglomerates comprising zinc on the surface and in the carbon matrix. These agglomerates form at a substantially high temperature. Part of the porosity could therefore be attributed to a loss of zinc. Indeed, a specific surface area of 560 m²/g for MOF 10 was obtained by BET.

### Analysis of the TEM and TEM-EDS Images Obtained for MOF 9

FIG. 29(F) shows the results of the EDS analysis obtained for the two zones delimited in the images presented in FIGS. 29(A) to (E). The images in FIG. 29 show the presence of elongated particles of irregular shape. It is also possible to observe the presence of silicon in zones rich in carbon.

FIG. 30 shows in (H) the results of the EDS analysis obtained for the two zones delimited on the images presented in FIGS. 30(C) to (G).

FIG. 31 shows in (A) and (B) images obtained by TEM of MOF 9, and in (C) to (F) the results of the corresponding EDS analysis obtained for the two zones indicated by arrows in (B). FIGS. 31(C) and (D) respectively show a graph of the intensity as a function of the energy and a graph of the number of electrons as a function of the energy obtained for the Sp75 zone indicated in (B). FIGS. 31(E) and (F) respectively show a graph of the intensity as a function of the energy and a graph of the number of electrons as a function of the energy obtained for the Sp72 zone shown in (B). It can be observed that the elongated rod-shaped particle is rich in Zn while the irregularly shaped particles are free of Zn.

FIG. 32 shows (A) to (F) images obtained by TEM of MOF 9. More particularly, FIG. 32(A) shows an image of an irregularly shaped particle and FIGS. 32(B) to (F) show images of the elongated rod-shaped particle outlined in (B). It can be observed that the irregularly shaped particle has amorphous carbon while the elongated rod-shaped Zn-rich particles have crystalline planes.

### Analysis of the TEM and TEM-EDS Images Obtained for MOF 8

FIG. 33 shows elongated rod-shaped particles having a width in the range from about 100 nm to about 200 nm and a length of about 1 μm.

FIG. 34 shows in (E) the results of the EDS analysis obtained for the area delimited on the images presented in FIGS. 34(A) to (D).

FIG. 35 shows in (G) the results of the EDS analysis obtained for the area delimited on the images presented in FIGS. 35(C) to (F). FIG. 35 shows the substantial presence of Zn in the composition of the elongated rod-shaped particles.

FIG. 36 shows irregularly shaped particles comprising a substantial number of nanometric Zn particles. FIG. 36 shows in (D) the results of the EDS analysis obtained for the two zones indicated by arrows on the corresponding TEM image.

FIG. 37 shows in (E) and (F) the results of the EDS analysis respectively obtained for zones 1 (elongated rod-shaped particle) and 2 (irregularly shaped particle) delimited on the images shown in FIGS. 37(A) to (D). FIG. 37(E) confirms that elongated rod-shaped particles are substantially rich in Zn and FIG. 37(F) confirms that irregularly shaped particles are substantially amorphous and less rich in Zn.

FIG. 38 shows the presence of Zn nanoparticles having a length ranging from about 2 nm to about 5 nm in the carbon matrix.

### f) Effect of Grinding on the Calcined Lithiophilic MOFs

The effect of grinding was also characterized using a SEM equipped with an SE detector, as well as by EDS.

FIG. 39 shows SEM images obtained for MOF 8 in (A) before grinding, in (B) after about 5 minutes of grinding (SPEX™ ball mill), and in (C) after grinding twice for about 5 minutes. Scale bars represent 10 μm.

FIG. 40 shows in (A) an SEM image of MOF 8 particles after grinding twice for about 5 minutes, and the mapping images of elements C and Zn are shown in (B) and (C), respectively. Scale bars represent 5 μm.

### Example 3—Preparation and Characterization of Calcined Bimetallic Lithiophilic MOFs Based on Zn and Cu

### a) Preparation of the Calcined Bimetallic Lithiophilic MOFs Based on Zn and Cu

Calcined bimetallic lithiophilic MOFs were prepared with different proportions of copper and zinc (Cu:Zn ratio) according to Equation 1:

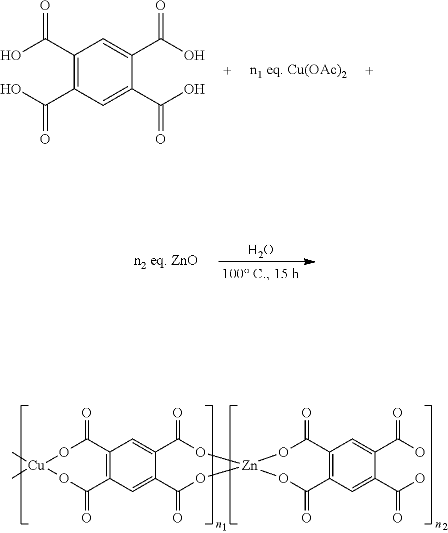

### Equation 1

The MOFs thus prepared were then purified by filtration and dried under vacuum for about 18 hours at room temperature.

The MOFs were calcined under an inert argon atmosphere using the following protocol:
1. temperature increase from room temperature to 200° C. at a temperature increase rate of 1° C./min;
2. plateau for 1 hour at 200° C.;
3. temperature increase from 200° C. to 750° C. at a temperature increase rate of 3° C./min; and
4. plateau for 2 hours at 750° C.

The structure, Cu:Zn ratio, and theoretical yield after calcination determined by TGA of the calcined MOFs prepared in the present example are shown in Table 8.

TABLE 8
Structure, Cu:Zn ratio, and theoretical yield after calcination determined by TGA of MOFs 11 to 15

| | | Cu:Zn | |
|---|---|---|---|
| | Lithiophilic organometallic structure | Ratio | Yield after |
| MOF | (before calcination) | (%) | calcination |
| MOF 11 | 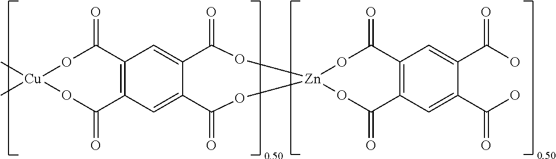 | 50:50 | 47.9 |
| MOF 12 | 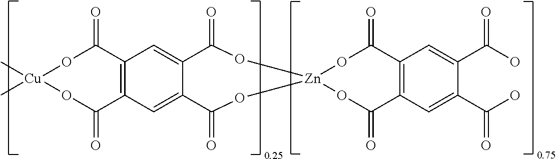 | 25:75 | 46.7 |
| MOF 13 | 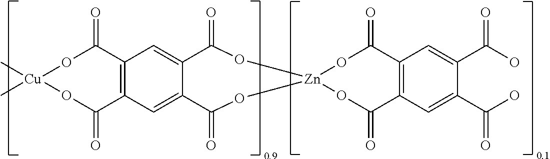 | 90:10 | 49.7 |
| MOF 14 | 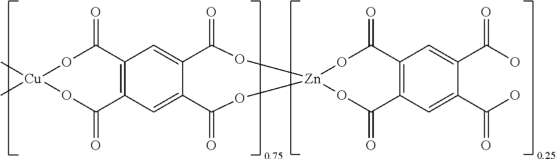 | 75:25 | 47.80 |
| MOF 15 | 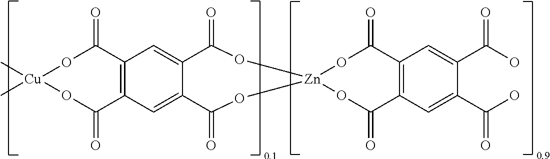 | 10:90 | 48.60 |

### b) Characterization of the Calcined Bimetallic Lithiophilic MOFs by TGA

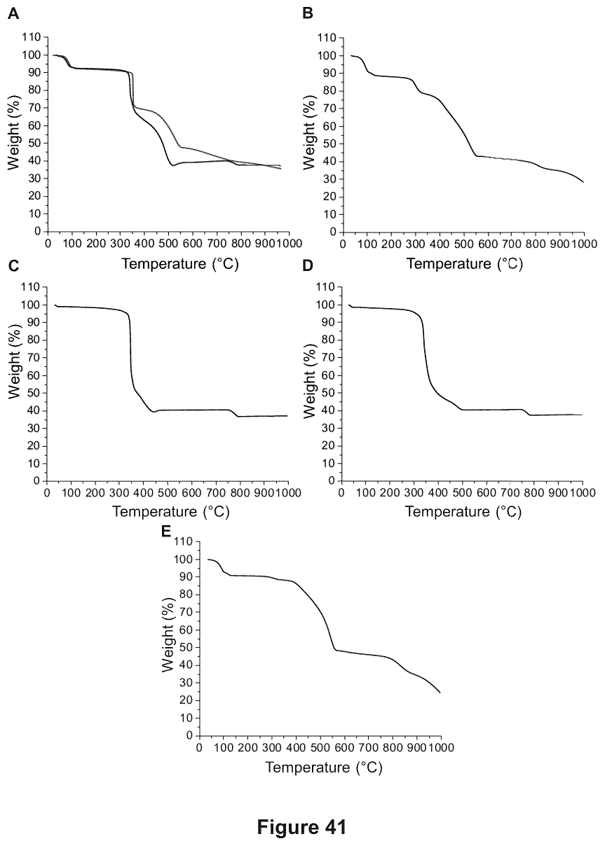

The MOFs prepared in Example 3(a) were characterized by TGA in order to evaluate their thermal stability and their conversion process. Thermogravimetric analyses were carried out under a constant air flow rate of 100 mL/min over a temperature range from about 30° C. to about 1000° C. and at a temperature increase rate of 5° C./min. The results of the thermogravimetric analyses obtained for MOFs 11 to 15 are presented in FIG. 41 and summarized in Table 9.

TABLE 9
Summary of the thermogravimetric analyses
obtained for MOFs 11 to 15

| MOF | FIG. |
|---|---|
| MOF 11 | FIG. 41(A) |
| MOF 12 | FIG. 41(B) |
| MOF 13 | FIG. 41(C) |
| MOF 14 | FIG. 41(D) |
| MOF 15 | FIG. 41(E) |

FIG. 41 shows two mass losses that can be attributed to the copper-ligand half and the zinc-ligand half respectively. It is possible to observe that the percentage of mass loss seems substantially consistent with the Cu:Zn ratios.

### c) SEM Characterization of the Calcined Bimetallic Lithiophilic MOFs

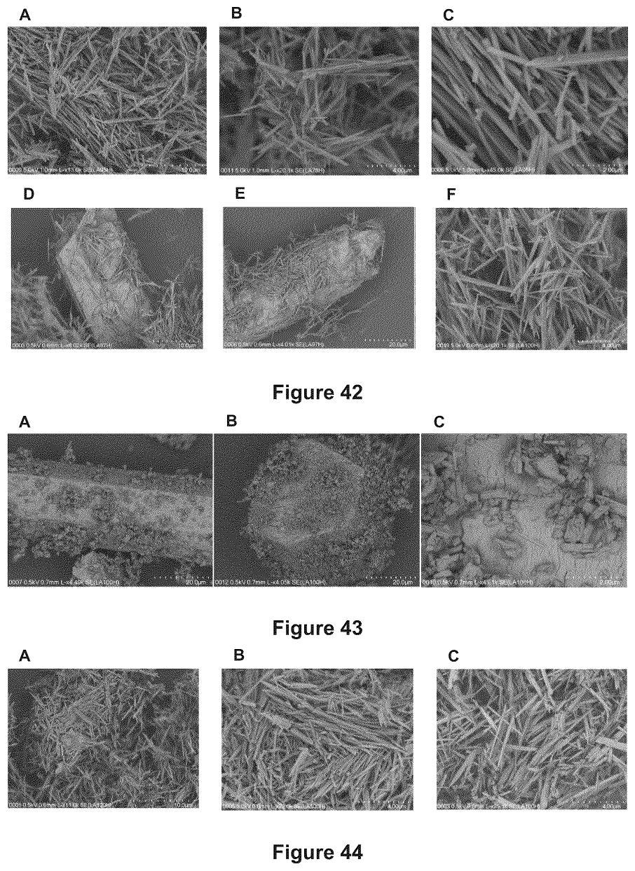

The MOFs prepared in Example 3(a) were imaged using a SEM equipped with an SE detector. The images obtained for MOFs 11 to 15 are presented in FIGS. 42 to 46 and summarized in Table 10.

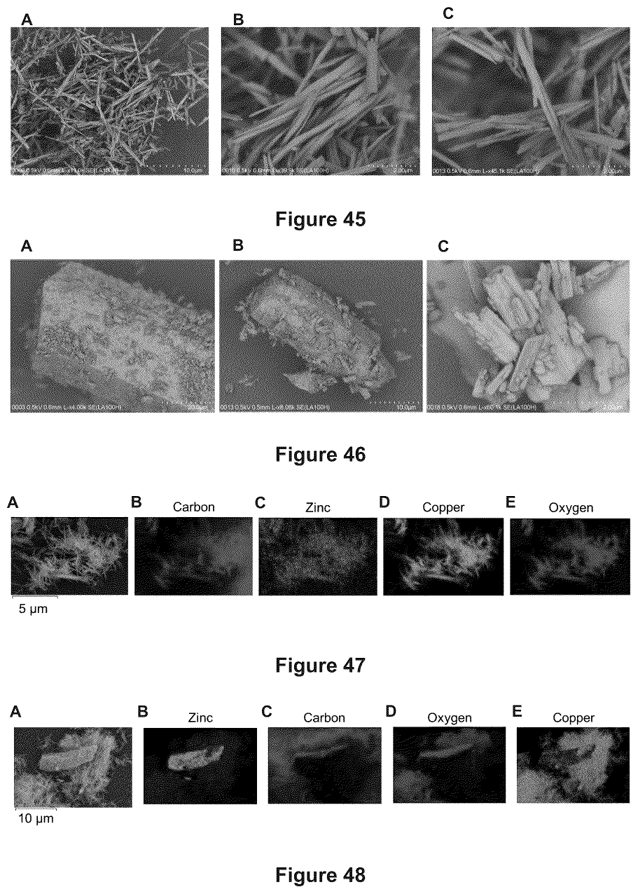

TABLE 10
Summary of the SEM images obtained for MOFs 11 to 15

| | | Scale |
|---|---|---|
| MOF | FIG. | bar (μm) |
| MOF 11 | FIG. 42(A) | 10.0 |
| | FIG. 42(B) | 4.00 |
| | FIG. 42(C) | 2.00 |
| | FIG. 42(D) | 10.0 |
| | FIG. 42(E) | 20.0 |
| | FIG. 42(F) | 4.00 |
| MOF 12 | FIG. 43(A) | 20.0 |
| | FIG. 43(B) | 20.0 |
| | FIG. 43(C) | 2.00 |
| MOF 13 | FIG. 44(A) | 10.0 |
| | FIG. 44(B) | 4.00 |
| | FIG. 44(C) | 4.00 |
| MOF 14 | FIG. 45(A) | 10.0 |
| | FIG. 45(B) | 2.00 |
| | FIG. 45(C) | 2.00 |
| MOF 15 | FIG. 46(A) | 20.0 |
| | FIG. 46(B) | 10.0 |
| | FIG. 46(C) | 2.00 |

### d) Characterization of the Calcined Bimetallic Lithiophilic MOFs by EDS

The elemental analysis or chemical characterization of the MOFs prepared in Example 3(a) was carried out using a SEM equipped with an X-ray detector for EDS analysis. FIGS. 47 to 51 show in (A) SEM images obtained for MOFs 11 and 13 to 15, and in (B) to (E) the corresponding EDS mapping images. The experimental conditions used for the EDS analyses carried out for MOFs 11 and 13 to 15 are presented in Table 11.

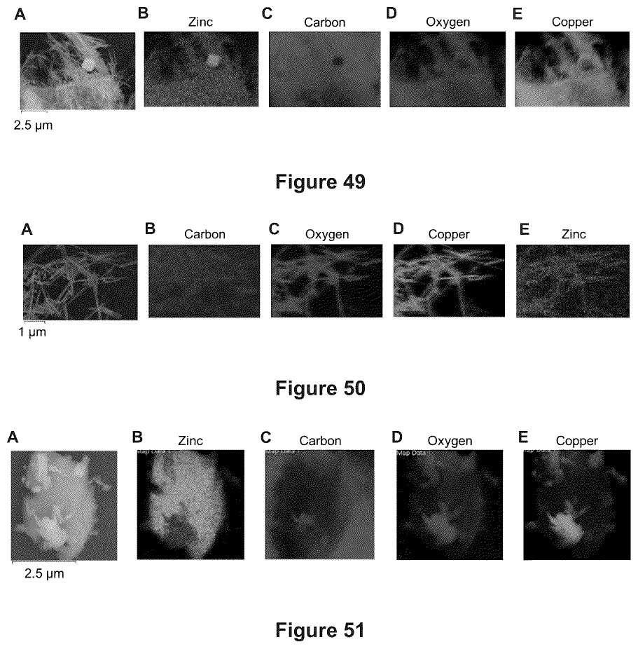

TABLE 11
Experimental conditions used for the EDS analyses
carried out for MOFs 11 and 13 to 15

| | | | Scale |
|---|---|---|---|
| MOF | FIG. | Element | bar (μm) |
| MOF 11 | FIG. 47(B) | C | 5 |
| | FIG. 47(C) | Zn | |
| | FIG. 47(D) | Cu | |
| | FIG. 47(E) | O | |
| | FIG. 48(B) | Zn | 10 |
| | FIG. 48(C) | C | |
| | FIG. 48(D) | O | |
| | FIG. 48(E) | Cu | |
| MOF 13 | FIG. 49(B) | Zn | 2.5 |
| | FIG. 49(C) | C | |
| | FIG. 49(D) | O | |
| | FIG. 49(E) | Cu | |
| MOF 14 | FIG. 50(B) | C | 1 |
| | FIG. 50(C) | O | |
| | FIG. 50(D) | Cu | |
| | FIG. 50(E) | Zn | |
| MOF 15 | FIG. 51(B) | Zn | 2.5 |
| | FIG. 51(C) | C | |
| | FIG. 51(D) | O | |
| | FIG. 51(E) | Cu | |

FIGS. 46 and 51 show that the MOF 15 sample comprises substantially larger particles rich in Zn and substantially smaller elongated needle-shaped particles rich in Cu.

### e) Characterization of the Calcined Bimetallic Lithiophilic MOFs by TGA (in Air)

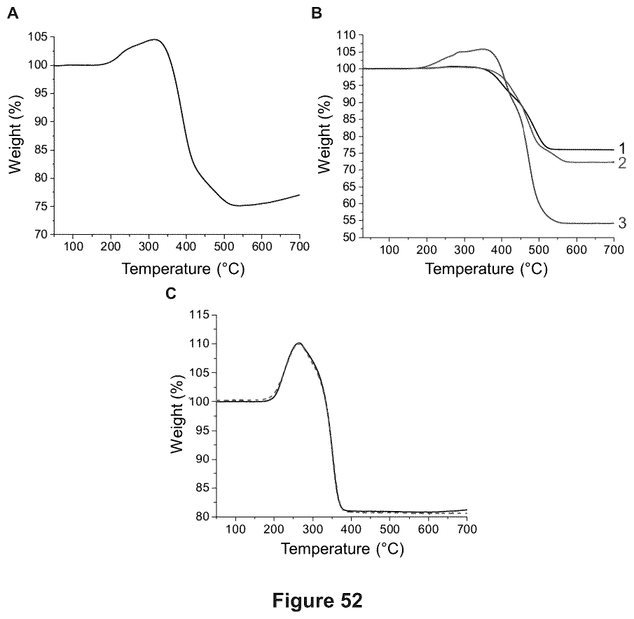

The calcined MOFs prepared in Example 3(a) were characterized by TGA in order to evaluate their respective quantity of metals. Thermogravimetric analyses were carried out under a constant air flow rate of 100 mL/min and a temperature increase rate of 5° C./min. The results of the thermogravimetric analyses obtained for MOFs 11 to 13 are presented in FIG. 52 and summarized in Table 12.

TABLE 12
Summary of the thermogravimetric analyses
obtained for MOFs 11 to 13

| | | Calcination |
|---|---|---|
| | | temperature |
| FIG. | MOF | (° C.) |
| FIG. 52(A) | MOF 11 | 750 |
| FIG. 52(B) (1) | MOF 12 | 750 |
| FIG. 52(B) (2) | | 910 |
| FIG. 52(B) (3) | | 1000 |
| FIG. 52(C) (solid line) | MOF 13 | 750 |
| FIG. 52(C) (dashed line) | | 750 |

FIG. 52(B) shows that the mass loss for MOF 12 calcined at a temperature of about 910° C. is slightly greater than for MOF 12 calcined at a temperature of about 750° C. This could be explained by the presence of more carbon, and therefore, a small amount of Zn could probably have been lost. FIG. 52(B) also shows a substantially greater mass loss for MOF 12 calcined at a temperature of about 1000° C. as well as a copper oxidation phenomenon at a temperature of about 200° C. to about 400° C., which indicates that little to no zinc is present.

### f) Characterization of the Calcined and Ground Bimetallic Lithiophilic MOFs by SEM and EDS

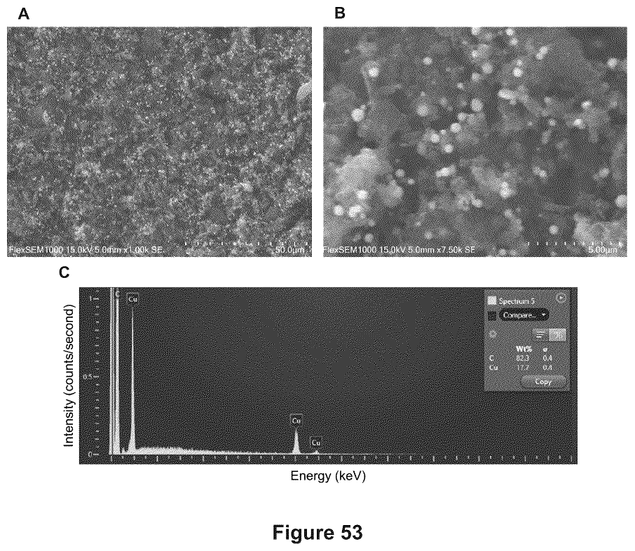

FIG. 53 shows in (A) and (B) SEM images of a MOF similar to MOF 12, but having been calcined at a temperature of about 1000° C. instead of about 750° C. and having been ground three times for about 5 minutes with a SPEX™ ball mill. The scale bars in (A) and (B) represent 50.0 μm and 5.00 μm respectively. FIG. 53 shows spherical nanometric particles substantially well dispersed in the carbon matrix.

FIG. 53 (C) shows the results of the EDS analysis confirming the absence of Zn in the matrix and the presence of carbon and copper.

### Example 4—Preparation and Characterization of Calcined Bimetallic Lithiophilic MOFs Based on Zn and Ag

### a) Preparation of the Calcined Bimetallic Lithiophilic MOFs Based on Zn and Ag

Calcined bimetallic lithiophilic MOFs were prepared with different proportions of zinc and silver (Zn:Ag ratio). To do so, MOFs based on Zn were prepared according to Equation 2:

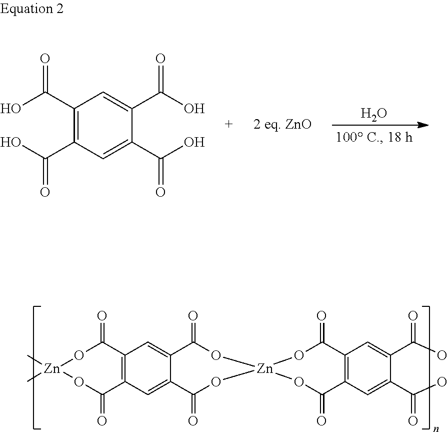

The MOFs thus prepared were then purified by filtration and dried in vacuum for about 20 hours at a temperature of about 160° C.

AgNO₃ was incorporated into MOFs based on Zn by an impregnation method according to Equation 3:

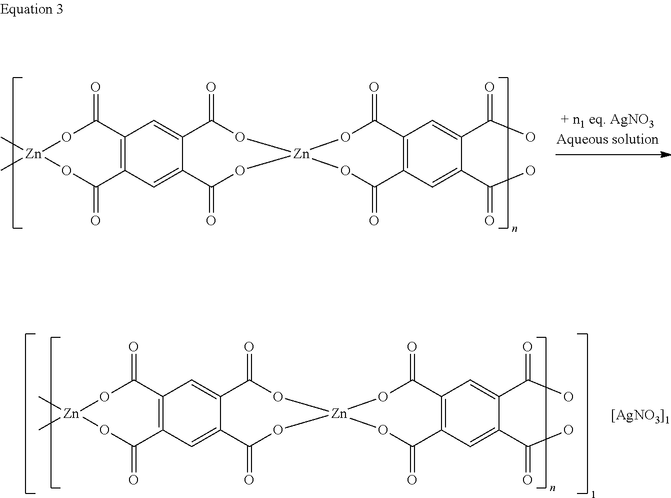

An aqueous solution of AgNO₃ was added to the Zn-based MOF powders. The resulting solutions were stirred for about 2 hours at room temperature. The water was then evaporated and the Zn- and MOFs based on Ag were dried under vacuum for about 18 hours at room temperature.

The MOFs were calcined under an inert argon atmosphere using the following protocol:
1. temperature increase from room temperature to 200° C. at a temperature increase rate of 1° C./min;
2. plateau for 1 hour at 200° C.;
3. temperature increase from 200° C. to 750° C. at a temperature increase rate of 3° C./min; and
4. plateau for 2 hours at 750° C.

The structure and Zn:Ag ratio of the calcined bimetallic MOFs prepared in the present example are presented in Table 13.

TABLE 13
Structure and Zn:Ag ratio of MOFs 16 to 19

| | Lithiophilic organometallic structure | Zn:Ag |
|---|---|---|
| MOF | (before calcination) | ratio |
| MOF 16 | 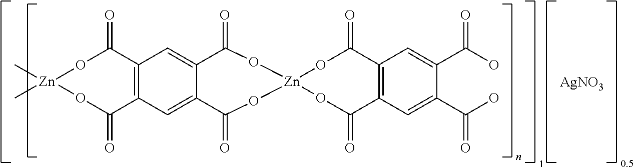 | 4:1 |
| MOF 17 | 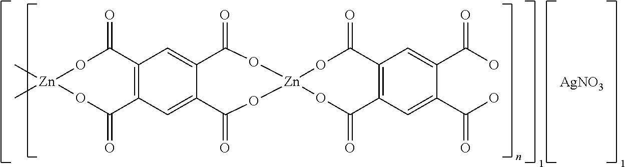 | 2:1 |
| MOF 18 | 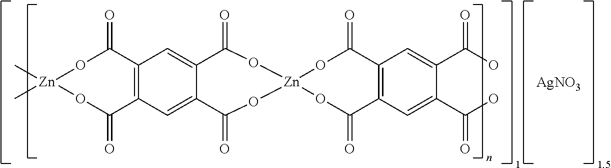 | 4:3 |
| MOF 19 | 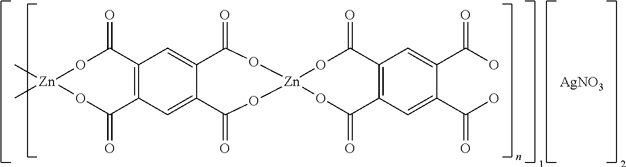 | 1:1 |

### b) Characterization of the Calcined Bimetallic Lithiophilic MOFs by TGA

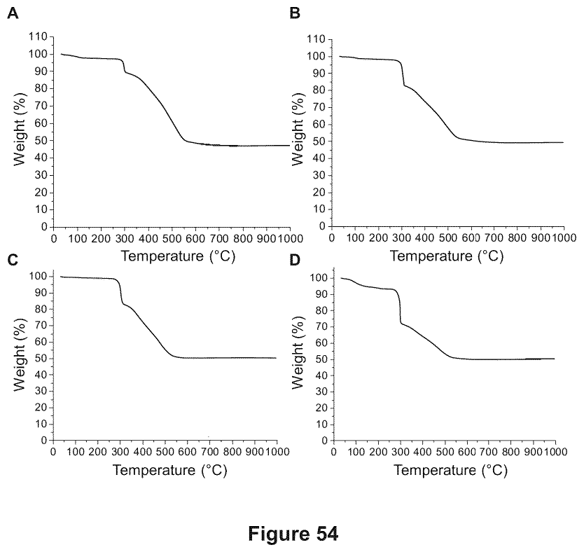

The MOFs prepared in Example 4(a) were characterized by TGA in order to evaluate their thermal stability and their conversion process. Thermogravimetric analyses were carried out under a constant air flow rate of 100 mL/min over a temperature range from about 30° C. to about 1000° C. and at a temperature increase rate of 5° C./min. The results of the thermogravimetric analyses obtained for MOFs 16 to 19 are presented in FIG. 54 and summarized in Table 14.

TABLE 14
Summary of the thermogravimetric analyses (MOFs 16 to 19)

| MOF | FIG. |
|---|---|
| MOF 16 | FIG. 54(A) |
| MOF 17 | FIG. 54(B) |
| MOF 18 | FIG. 54(C) |
| MOF 19 | FIG. 54(D) |

FIG. 54 shows a loss of mass at a temperature below 300° C. that can be attributed to silver.

### c) Characterization of the Surface of the Calcined Bimetallic Lithiophilic MOFs by the BET Method

The pore size, specific surface area, and pore volume of the calcined MOFs prepared in Example 4(a) were characterized.

Nitrogen adsorption/desorption isotherms (graph of the volume of nitrogen adsorbed as a function of the relative nitrogen pressure P/P₀) were obtained for each of the MOFs prepared in Example 4(a). The pore size, pore volume distribution, specific surface area, and total pore volume were extracted from these isotherms. The pore size was determined using the BdB method. The distribution of pore volumes was determined by the BJH method. The specific surface area and pore volume were calculated using the BET method.

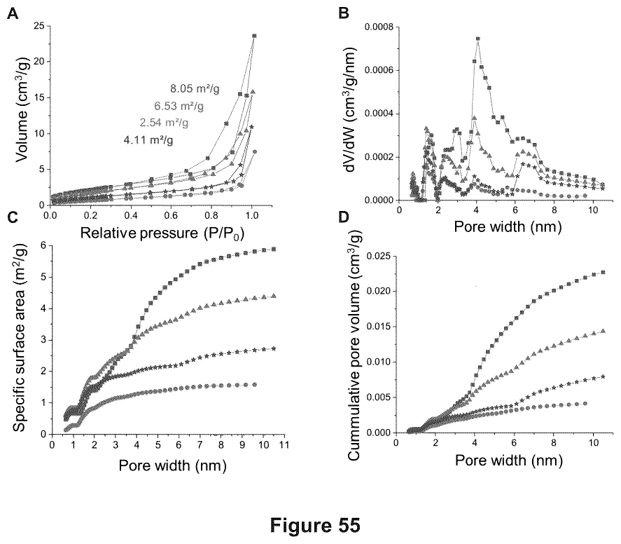

FIG. 55 shows in (A) a nitrogen adsorption/desorption isotherm, in (B) a graph of the distribution of pore volumes as a function of pore width, in (C) a graph of the specific surface area as a function of the pore width, and in (D) a graph of the total pore volume as a function of the pore width obtained for MOFs 16 (▪), 17 (▴), 18 (▾), and 19 (★). It is possible to observe that the more silver salt is incorporated, the more the BET surface area decreases and the pores having a width between about 3.5 nm and about 6 nm are filled. A substantial proportion of the specific surface area comes from mesopores having a width between about 2 nm and about 8 nm. The method of incorporating the silver salt into the mesoporosity therefore appears to be effective.

### d) SEM Characterization of the Calcined Bimetallic Lithiophilic MOFs

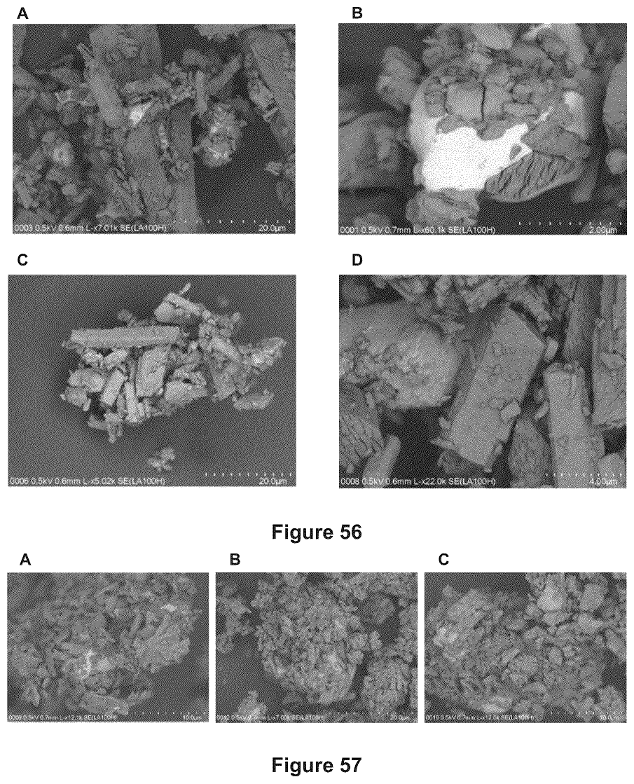

The MOFs prepared in Example 4(a) were imaged using a SEM equipped with an SE detector. The images obtained for MOFs 16 to 19 are presented in FIGS. 56 to 59 and summarized in Table 15.

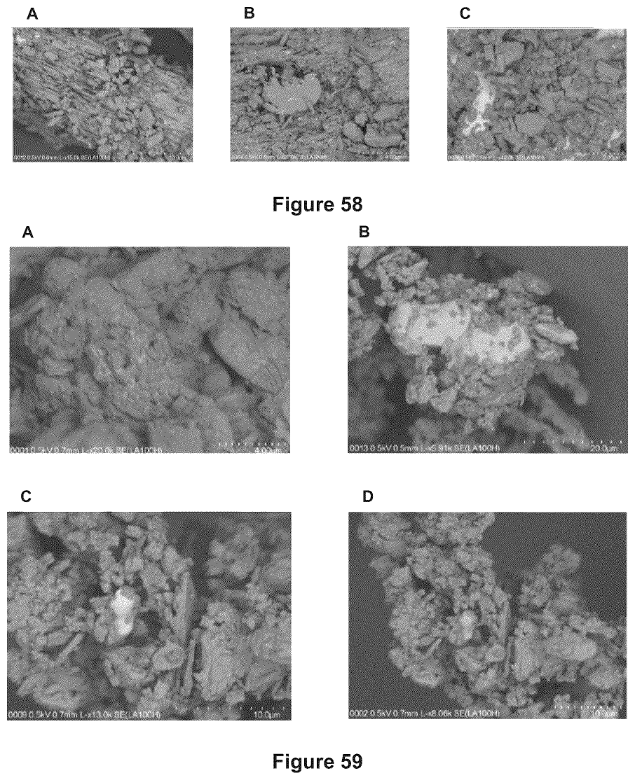

TABLE 15
Summary of the SEM images obtained for MOFs 16 to 19

| | | Scale |
|---|---|---|
| MOF | FIG. | bar (μm) |
| MOF 16 | FIG. 56(A) | 20.0 |
| | FIG. 56(B) | 2.00 |
| | FIG. 56(C) | 20.0 |
| | FIG. 56(D) | 4.00 |
| MOF 17 | FIG. 57(A) | 10.0 |
| | FIG. 57(B) | 20.0 |
| | FIG. 57(C) | 10.0 |
| MOF 18 | FIG. 58(A) | 10.0 |
| | FIG. 58(B) | 4.00 |
| | FIG. 58(C) | 2.00 |
| MOF 19 | FIG. 59(A) | 4.00 |
| | FIG. 59(B) | 20.0 |
| | FIG. 59(C) | 10.0 |
| | FIG. 59(D) | 10.0 |

FIGS. 56 to 59 show heterogeneous mixtures comprising particles of varying size and shape.

### e) Characterization of the Calcined Bimetallic Lithiophilic MOFs by EDS

The elemental analysis or chemical characterization of the MOFs prepared in Example 4(a) was carried out using a SEM equipped with an X-ray detector for EDS analysis.

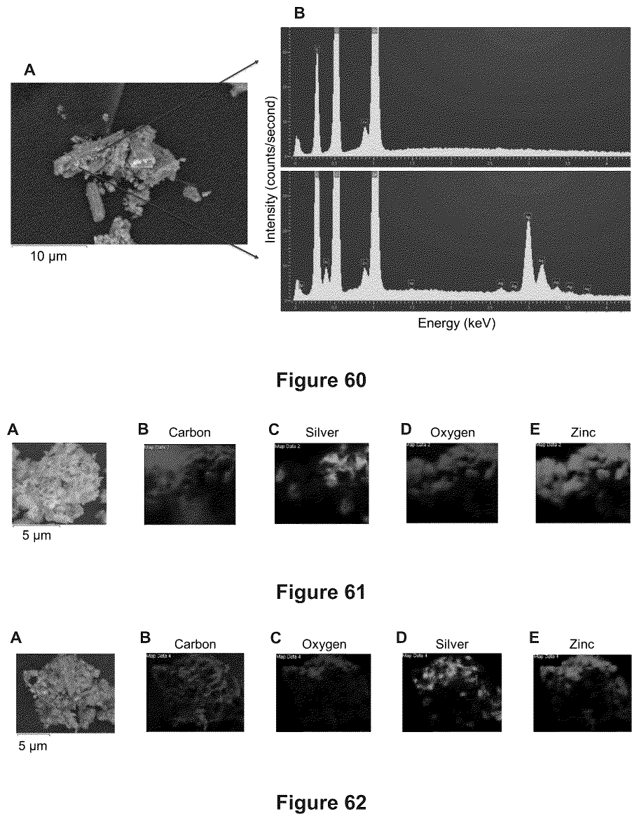

FIG. 60 shows in (A) a SEM image obtained for MOF 16, and in (B) graphs presenting the results of EDS analysis obtained for the zones delimited in (A). The scale bar represents 10 μm.

FIGS. 61 and 62 show in (A) SEM images obtained for MOFs 16 to 18, and (B) to (E) the corresponding EDS mapping images. The experimental conditions used for the EDS analyses carried out for MOFs 17 and 18 are presented in Table 16.

TABLE 16
Experimental conditions used for the EDS
analyses carried out for MOFs 17 and 18

| | | | Scale |
|---|---|---|---|
| MOF | FIG. | Element | bar (μm) |
| MOF 17 | FIG. 61(B) | C | 5 |
| | FIG. 61(C) | Ag | |
| | FIG. 61(D) | O | |
| | FIG. 61(E) | Zn | |
| MOF 18 | FIG. 62(B) | C | 5 |
| | FIG. 62(C) | O | |
| | FIG. 62(D) | Ag | |
| | FIG. 62(E) | Zn | |

### Example 5—Preparation and Characterization of Lithiophilic MOFs Based on Mg and Bimetallic Lithiophilic MOFs Based on Mg and Zn

### a) Preparation of the Lithiophilic MOFs Based on Mg and the Bimetallic Lithiophilic MOFs Based on Mg and Zn

Lithiophilic MOFs based on Mg were prepared from magnesium carbonate hydroxide pentahydrate ((MgCO₃)₄ Mg(OH)₂ 5H₂O) and H₄btec. Two bimetallic MOFs based on Mg and Zn were prepared from (MgCO₃)₄ Mg(OH)₂ 5H₂O, ZnO, and H₄btec. The MOFs thus prepared were then purified by filtration and dried under vacuum for about 18 hours at room temperature.

The MOFs prepared in the present example are presented in Table 17.

TABLE 17
Structure and Mg:Zn ratio of MOFs 20 to 22

| MOF | Lithiophilic organometallic structure | Mg:Zn ratio |
|---|---|---|
| MOF 20 | 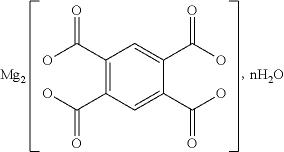 | — |
| MOF 21 | 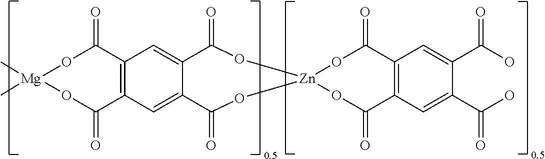 | 50:50 |
| MOF 22 | 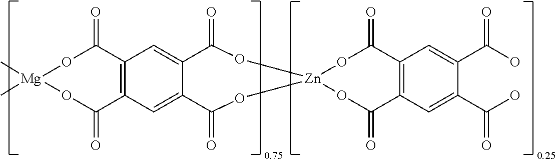 | 75:25 |

### b) Characterization of the Lithiophilic MOFs Based on Mg by TGA

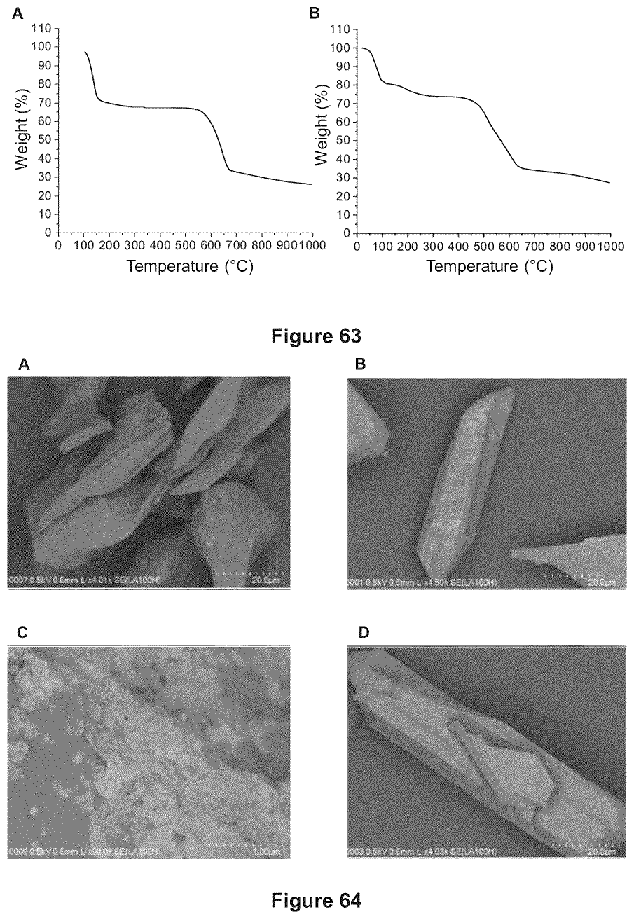

The MOFs prepared in Example 5(a) were characterized by TGA in order to evaluate their thermal stability and their conversion process. Thermogravimetric analyses were carried out under a constant air flow rate of 100 ml/min over a temperature range from about 30° C. to about 1000° C. and at a temperature increase rate of 5° C./min. The results of the thermogravimetric analyses obtained for MOFs 20 and 21 are shown in FIG. 63 and summarized in Table 18.

TABLE 18
Summary of the thermogravimetric analyses
obtained (MOFs 20 and 21)

| MOF | FIG. |
|---|---|
| MOF 20 | FIG. 63(A) |
| MOF 21 | FIG. 63(B) |

### c) SEM Characterization of the Lithiophilic MOFs Based on Mg

The MOFs prepared in Example 5(a) were imaged using a SEM equipped with an SE detector. The images obtained for MOFs 20 to 22 are presented in FIGS. 64 to 66 and summarized in Table 19.

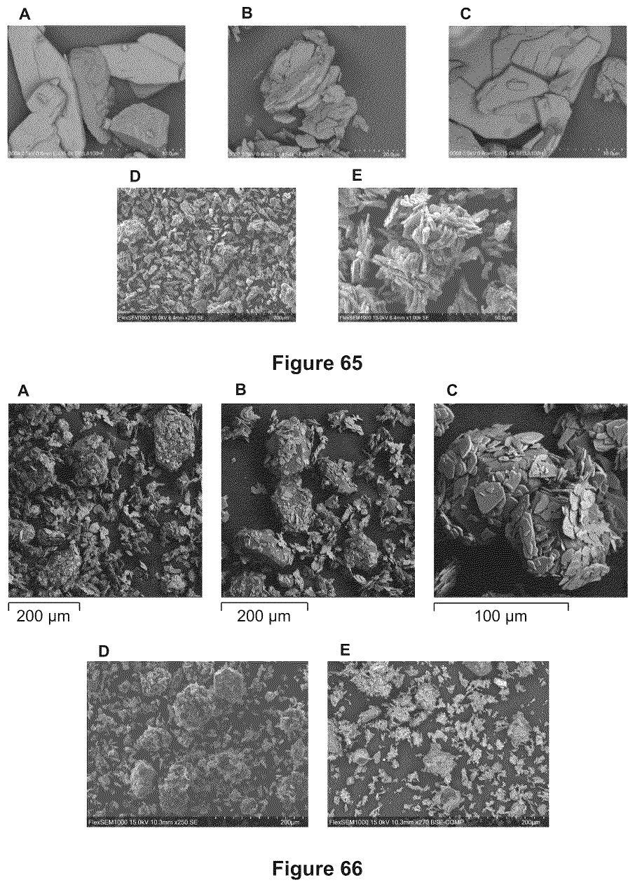

TABLE 19
Summary of the SEM images obtained for MOFs 20 to 22

| | | Scale |
|---|---|---|
| MOF | FIG. | bar (μm) |
| MOF 20 | FIG. 64(A) | 20.0 |
| | FIG. 64(B) | 20.0 |
| | FIG. 64(C) | 1.00 |
| | FIG. 64(D) | 20.0 |
| MOF 21 | FIG. 65(A) | 10.0 |
| (before calcination | FIG. 65(B) | 20.0 |
| at 750° C.) | FIG. 65(C) | 10.0 |
| MOF 21 | FIG. 65(D) | 200 |
| (after calcination | FIG. 65(E) | 50.0 |
| at 750° C.) | | |
| MOF 22 | FIG. 66(A) | 200 |
| (before calcination | FIG. 66(B) | 200 |
| at 1000° C.) | FIG. 66(C) | 100 |
| MOF 22 | FIG. 66(D) | 200 |
| (after calcination | FIG. 66(E) | 200 |
| at 1000° C.) | | |

FIGS. 65(D) and (E) show SEM images of MOF 21 obtained after calcination at a temperature of about 750° C. It is possible to observe the appearance of substantially small spheres on the carbon surface after calcination.

FIGS. 66(D) and (E) show SEM images of MOF 22 obtained after calcination at a temperature of about 1000° C. It is possible to observe the appearance of substantially small spheres in the carbon matrix after calcination.

### d) Characterization of the Lithiophilic MOFs Based on Mg by EDS

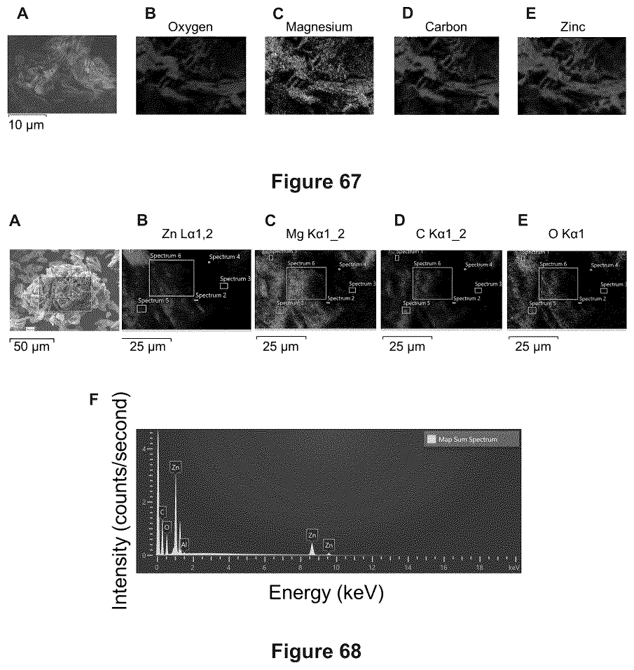

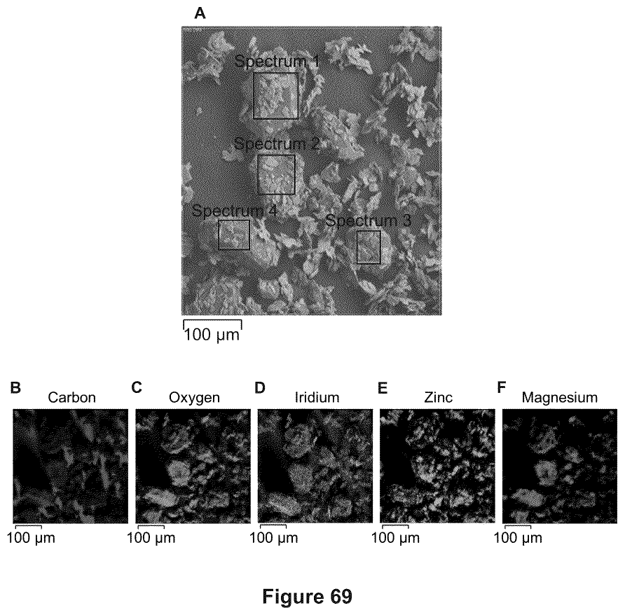

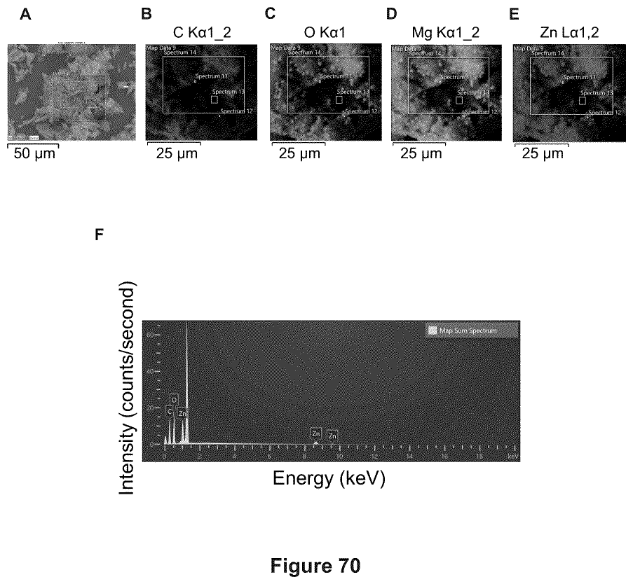

The elemental analysis or chemical characterization of MOFs 21 and 22 prepared in Example 5(a) was carried out using a SEM equipped with an X-ray detector for EDS analysis. FIG. 67 shows in (A) a SEM image obtained for MOF 21 before calcination, and in (B) to (E) the corresponding EDS mapping images. FIG. 68 shows in (A) a SEM image obtained for MOF 21 after calcination at a temperature of about 750° C., in (B) to (E) the corresponding EDS mapping images, and in (F) the results of the corresponding EDS analysis. FIG. 69 shows in (A) a SEM image obtained for MOF 22 before calcination, and in (B) to (F) the corresponding EDS mapping images. FIG. 70 shows in (A) a SEM image obtained for MOF 22 after calcination at a temperature of about 1000° C., in (B) to (E) the corresponding EDS mapping images, and in (F) the results of the corresponding EDS analysis. The experimental conditions used for the EDS analyses carried out for MOFs 21 and 22 are presented in Table 20.

TABLE 20
Experimental conditions used for the EDS
analyses carried out for MOFs 21 and

| | | | Scale |
|---|---|---|---|
| MOF | FIG. | Element | bar (μm) |
| 21 | FIG. 67(B) | O | 10 |
| (before calcination | FIG. 67(C) | Mg | |
| at 750° C.) | FIG. 67(D) | C | |
| | FIG. 67(E) | Zn | |
| 21 | FIG. 68(B) | Zn | 25 |
| (after calcination | FIG. 68(C) | Mg | |
| at 750° C.) | FIG. 68(D) | C | |
| | FIG. 68(E) | O | |
| 22 | FIG. 69(B) | C | 100 |
| (before calcination | FIG. 69(C) | O | |
| at 1000° C.) | FIG. 69(D) | Ir | |
| | FIG. 69(E) | Zn | |
| | FIG. 69(F) | Mg | |
| 22 | FIG. 70(B) | C | 25 |
| (after calcination | FIG. 70C) | O | |
| at 1000° C.) | FIG. 70(D) | Mg | |
| | FIG. 70(E) | Zn | |

The results of EDS analysis obtained for MOF 21 after calcination at a temperature of about 750° C. are presented in Table 21. It is possible to observe a significant quantity of oxygen (about 17.85 at. %), which is substantially close to the sum of zinc and magnesium (about 16 at. %). This indicates that metal oxides such as magnesium oxide (MgO) and ZnO are possibly formed. It is also possible to observe on the EDS spectra that the zones rich in zinc are also rich in oxygen.

TABLE 21
EDS analysis results obtained for MOF 21 after calcination

| | | | Weight % | |
|---|---|---|---|---|
| Element | Line type | % by weight | difference | Atomic % |
| O | K series | 15.59 | 0.15 | 17.85 |
| Zn | L series | 31.12 | 0.18 | 8.72 |
| Mg | K series | 9.88 | 0.08 | 7.44 |
| C | K series | 43.17 | 0.24 | 65.83 |
| Al | K series | 0.23 | 0.03 | 0.16 |
| Total | — | 100.00 | — | 100.00 |

The results of the EDS analysis obtained for MOF 22 before calcination at a temperature of about 1000° C. are presented in Table 22. The results presented in Table 22 were obtained in the outlined zones of the SEM image in FIG. 69(A). It is possible to observe that the composition varies depending on the shape of the particles.

TABLE 22
EDS analysis results obtained for MOF 22 before calcination

| Spectrum | Element | Atomic % |
|---|---|---|
| Spectrum 1 | C | 53.82 |
| | O | 41.09 |
| | Mg | 2.83 |
| | Zn | 2.20 |
| | Al | 0.05 |
| | Si | 0.02 |
| | Total | 100.00 |
| Spectrum 2 | C | 54.67 |
| | O | 41.49 |
| | Mg | 2.49 |
| | Zn | 1.34 |
| | Al | 0.01 |
| | Si | 0.00 |
| | Total | 100.00 |
| Spectrum 3 | C | 52.93 |
| | O | 41.34 |
| | Mg | 3.28 |
| | Zn | 2.40 |
| | Al | 0.04 |
| | Si | 0.01 |
| | Total | 100.00 |
| Spectrum 4 | C | 54.40 |
| | O | 41.59 |
| | Mg | 2.70 |
| | Zn | 1.28 |
| | Al | 0.02 |
| | Si | 0.01 |
| | Total | 100.00 |

The results of the EDS analysis obtained for MOF 22 after calcination at a temperature of about 1000° C. are presented in Table 23. It is possible to observe that the spheres present in the carbon matrix are rich in oxygen and in metals such as zinc and magnesium. Again, this suggests that metal oxides such as MgO and ZnO can be formed.

TABLE 23
EDS analysis results obtained for MOF 22 after calcination

| | | % by | Weight % | |
|---|---|---|---|---|
| Element | Line type | weight | difference | Atomic % |
| C | K series | 37.23 | 0.12 | 52.42 |
| O | K series | 23.02 | 0.08 | 24.33 |
| Mg | K series | 29.70 | 0.07 | 20.66 |
| Zn | L series | 10.04 | 0.05 | 2.60 |
| Total | — | 100.00 | — | 100.00 |

### Example 6—Preparation and Characterization of the Lithiophilic MOFs Based on Mg

### a) Preparation of the Lithiophilic MOFs Based on Mg

Lithiophilic MOFs based on Mg were prepared from magnesium carbonate (MgCO₃) or magnesium acetate (Mg(OAc)₂) and H₄btec according to Equation 4:

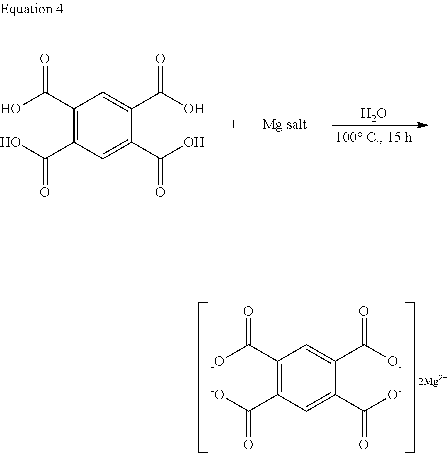

The MOFs thus prepared were then purified by filtration and dried under vacuum for about 18 hours at room temperature. The MOFs prepared in the present example are presented in Table 24.

TABLE 24
Structure of MOFs 23 and 24

| | | Lithiophilic | |
|---|---|---|---|
| | | organo- | |
| | Magnesium | metallic | |
| MOF | salt | structure | Lithiophilic organometallic structure |
| MOF 23 | MgCO₃ | [2Mg²⁺ (btec)] | 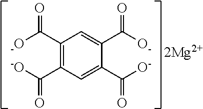 |
| MOF 24 | Mg(OAc)₂ | [2Mg²⁺ (btec)] | 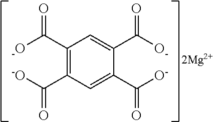 |

It was observed that Mg(OAc)₂ appears to be a suitable precursor for the synthesis of MOFs based on Mg.

### b) SEM Characterization of the Lithiophilic MOFs Based on Mg

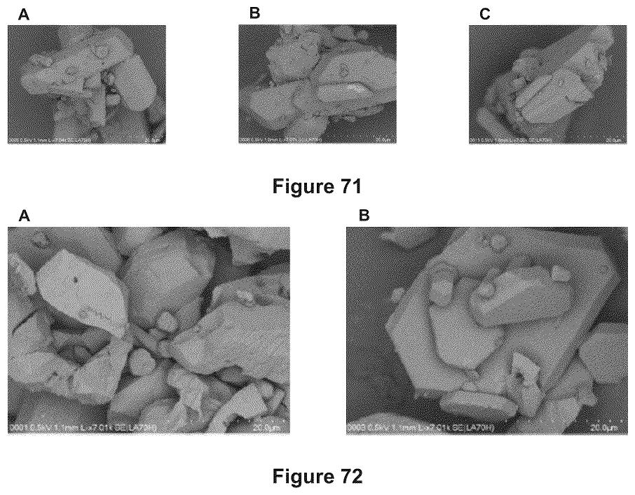

The MOFs prepared in Example 6(a) were imaged using a SEM equipped with an SE detector. The images obtained for MOFs 23 and 24 are presented in FIGS. 71 and 72 and summarized in Table 25.

TABLE 25
Summary of the SEM images obtained for MOFs 23 and 24

| | | Scale |
|---|---|---|
| MOF | Figure | bar (μm) |
| MOF 23 | FIG. 71(A) | 20.0 |
| | FIG. 71(B) | 20.0 |
| | FIG. 71(C) | 20.0 |
| MOF 24 | FIG. 72(A) | 20.0 |
| | FIG. 72(B) | 20.0 |

### c) Characterization of the Lithiophilic MOFs Based on Mg by EDS

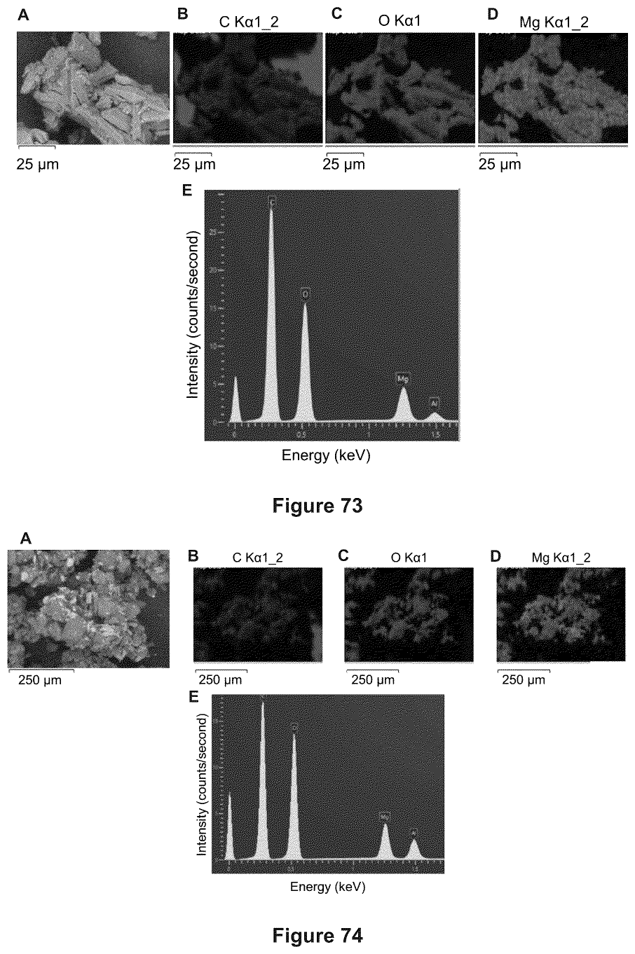

The elemental analysis or chemical characterization of the MOFs prepared in Example 6(a) was carried out using a SEM equipped with an X-ray detector for EDS analysis. FIGS. 73 and 74 show in (A) SEM images obtained respectively for MOFs 23 and 24, in (B) to (D) EDS mapping images, and in (E) the results of the corresponding EDS analysis. The experimental conditions used for the EDS analyses carried out for MOFs 23 and 24 are presented in Table 26.

TABLE 26
Experimental conditions used for the EDS
analyses carried out for MOFs 23 and 24

| | | | Scale |
|---|---|---|---|
| MOF | Figure | Element | bar (μm) |
| MOF 23 | FIG. 73(B) | C | 25 |
| | FIG. 73(C) | O | |
| | FIG. 73(D) | Mg | |
| MOF 24 | FIG. 74(B) | C | 250 |
| | FIG. 74(C) | O | |
| | FIG. 74(D) | Mg | |

### Example 7—Preparation and Characterization of Bimetallic Lithiophilic MOFs Based on Sb and Zn

### a) Preparation of the Bimetallic Lithiophilic MOFs Based on Sb and Zn

Bimetallic lithiophilic MOFs based on Sb and Zn were prepared from antimony (III) acetate (Sb(OAc)₃), ZnO, and H₄btec according to Equation 5:

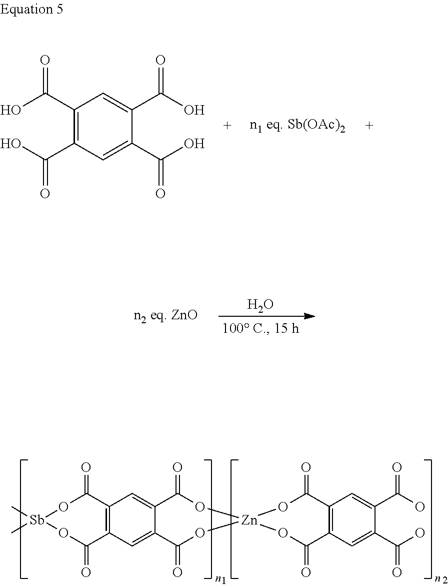

The MOFs thus prepared were then purified by filtration and dried under vacuum for about 18 hours at room temperature.

The structure and Sb:Zn ratio of the bimetallic MOFs prepared in the present example are presented in Table 27.

TABLE 27
Structure and Sb:Zn ratio of MOFs 25 to 30

| | | Sb:Zn |
|---|---|---|
| MOF | Lithiophilic organometallic structure | ratio |
| MOF 25 | 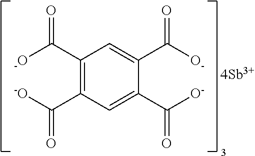 | — |
| MOF 26 | 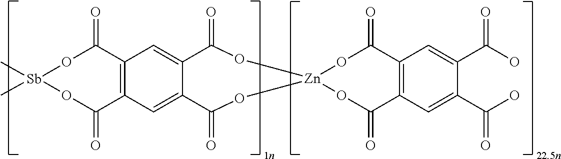 | 1:22.5 |
| MOF 27 | 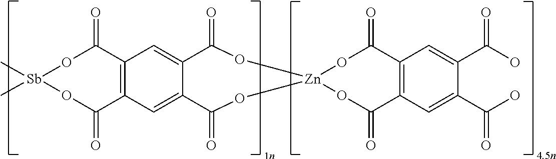 | 1:4.5 |
| MOF 28 | 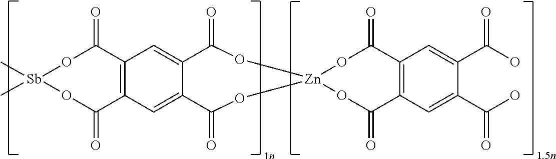 | 1:1.5 |
| MOF 29 | 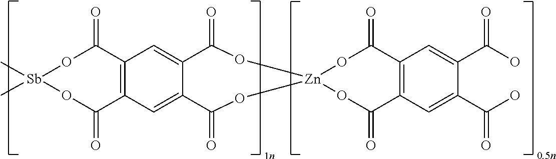 | 1:0.5 |
| MOF 30 | 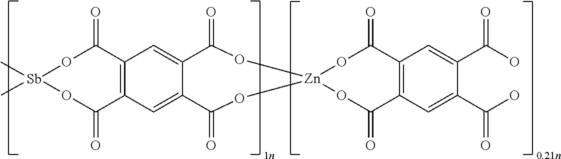 | 1:0.21 |

### b) SEM Characterization of the Bimetallic Lithiophilic MOFs

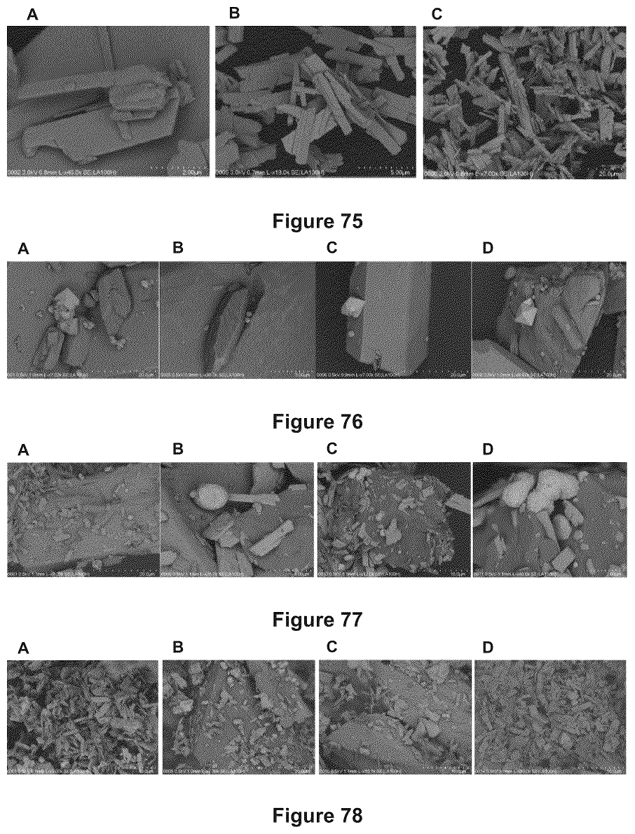

The MOFs prepared in Example 7(a) were imaged using a SEM equipped with an SE detector. The images obtained for MOFs 25 to 30 are presented in FIGS. 75 to 80 and summarized in Table 28.

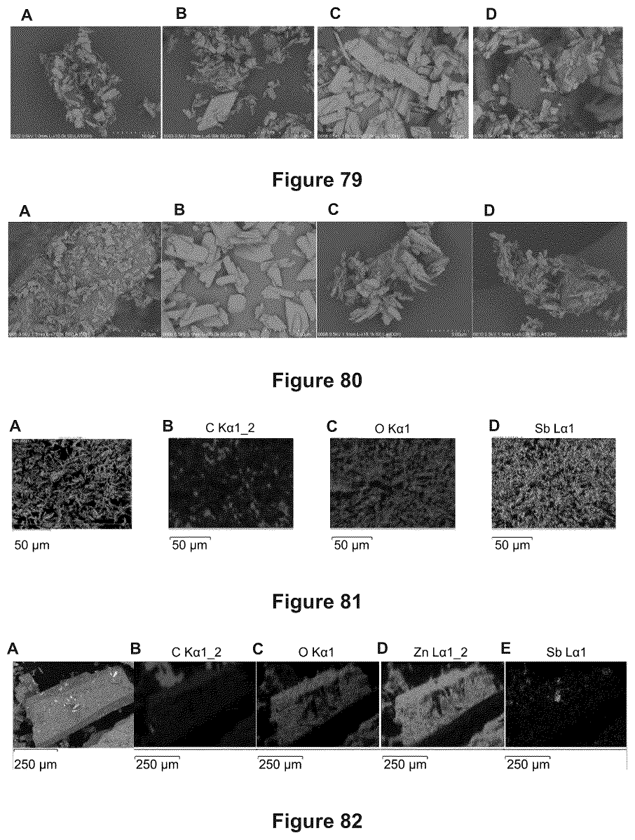

TABLE 28
Summary of the SEM images obtained for MOFs 25 to 30

| | | Scale |
|---|---|---|
| MOF | Figure | bar (μm) |
| MOF 25 | FIG. 75(A) | 2.00 |
| | FIG. 75(B) | 5.00 |
| | FIG. 75(C) | 20.0 |
| MOF 26 | FIG. 76(A) | 20.0 |
| | FIG. 76(B) | 3.00 |
| | FIG. 76(C) | 20.0 |
| | FIG. 76(D) | 20.0 |
| MOF 27 | FIG. 77(A) | 20.0 |
| | FIG. 77(B) | 4.00 |
| | FIG. 77(C) | 10.0 |
| | FIG. 77(D) | 2.00 |
| MOF 28 | FIG. 78(A) | 10.0 |
| | FIG. 78(B) | 20.0 |
| | FIG. 78(C) | 10.0 |
| | FIG. 78(D) | 10.0 |
| MOF 29 | FIG. 79(A) | 10.0 |
| | FIG. 79(B) | 20.0 |
| | FIG. 79(C) | 4.00 |
| | FIG. 79(D) | 5.00 |
| MOF 30 | FIG. 80(A) | 20.0 |
| | FIG. 80(B) | 3.00 |
| | FIG. 80(C) | 5.00 |
| | FIG. 80(D) | 10.0 |

### c) Characterization of the Bimetallic Lithiophilic MOFs by EDS

The elemental analysis or chemical characterization of the MOFs prepared in Example 7(a) was carried out using a SEM equipped with an X-ray detector for EDS analysis. FIGS. 81 to 86 show in (A) SEM images obtained respectively for MOFs 25 to 30, and (B) to (D) or (E) EDS mapping images. The experimental conditions used for the EDS analyses carried out for MOFs 25 to 30 are presented in Table 29.

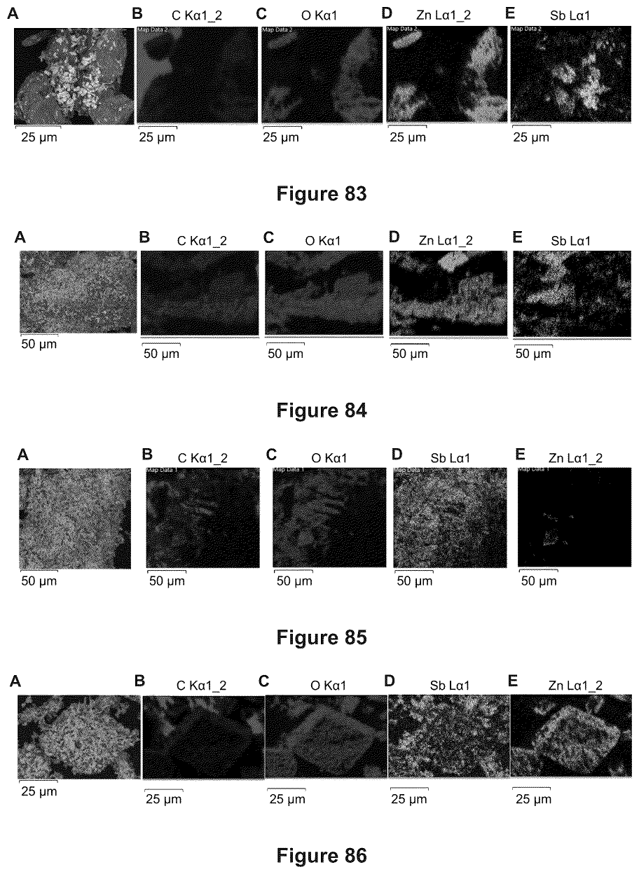

TABLE 29
Experimental conditions used for the EDS
analyses carried out for MOFs 25 to 30

| | | | Scale |
|---|---|---|---|
| MOF | Figure | Element | bar (μm) |
| MOF 25 | FIG. 81(B) | C | 50 |
| | FIG. 81(C) | O | |
| | FIG. 81(D) | Sb | |
| MOF 26 | FIG. 82(B) | C | 250 |
| | FIG. 82(C) | O | |
| | FIG. 82(D) | Zr | |
| | FIG. 82(E) | Sb | |
| MOF 27 | FIG. 83(B) | C | 25 |
| | FIG. 83(C) | O | |
| | FIG. 83(D) | Zn | |
| | FIG. 83(E) | Sb | |
| MOF 28 | FIG. 84(B) | C | 50 |
| | FIG. 84(C) | O | |
| | FIG. 84(D) | Zn | |
| | FIG. 84(E) | Sb | |
| MOF 29 | FIG. 85(B) | C | 50 |
| | FIG. 85(C) | O | |
| | FIG. 85(D) | Sb | |
| | FIG. 85(E) | Zn | |
| MOF 30 | FIG. 86(B) | C | 25 |
| | FIG. 86(C) | O | |
| | FIG. 86(D) | Sb | |
| | FIG. 86(E) | Zn | |

### Example 8—Preparation and Characterization of Bimetallic Lithiophilic MOFs Based on Zn and Ag with Bifunctional Ligands

a) Preparation of the Bimetallic Lithiophilic MOFs Based on Zn and Ag with Bifunctional Ligands

Bimetallic lithiophilic MOFs based on Zn and Ag with bifunctional ligands were prepared from a commercial bifunctional ligand according to Equation 7:

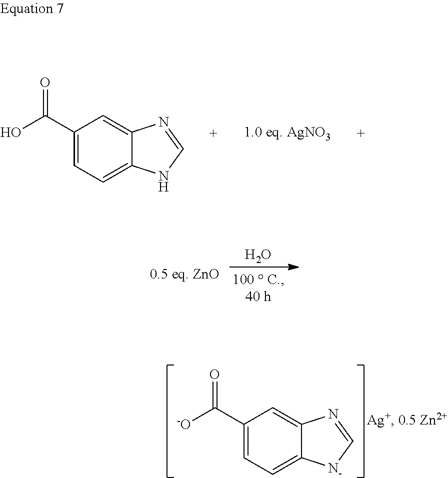

Bimetallic lithiophilic MOFs based on Zn and Ag with bifunctional ligands were also prepared from a synthetic bifunctional ligand according to Equations 8 and 9:

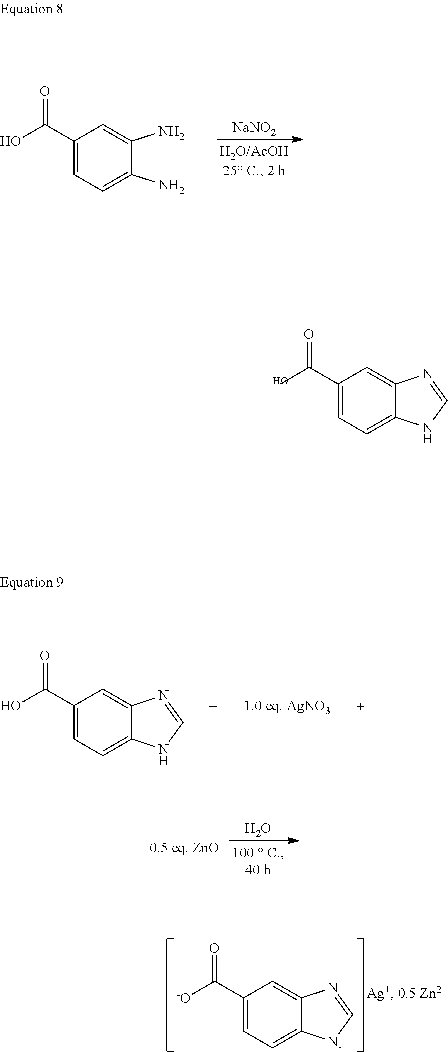

The structure and Zn:Ag ratio of the bimetallic MOFs prepared in the present example are presented in Table 30.

TABLE 30
Structure and Zn:Ag ratio of MOFs 31 and 32

| | Bi- | | Zn: |
|---|---|---|---|
| | functional | | Ag |
| MOF | ligand | Lithiophilic organometallic structure | ratio |
| MOF 31 | Commercial | 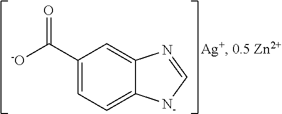 | 1:2 |
| MOF 32 | Prepared according to Equation 8 | 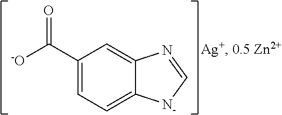 | 1:2 |

### b) SEM Characterization of the Bimetallic Lithiophilic MOFs

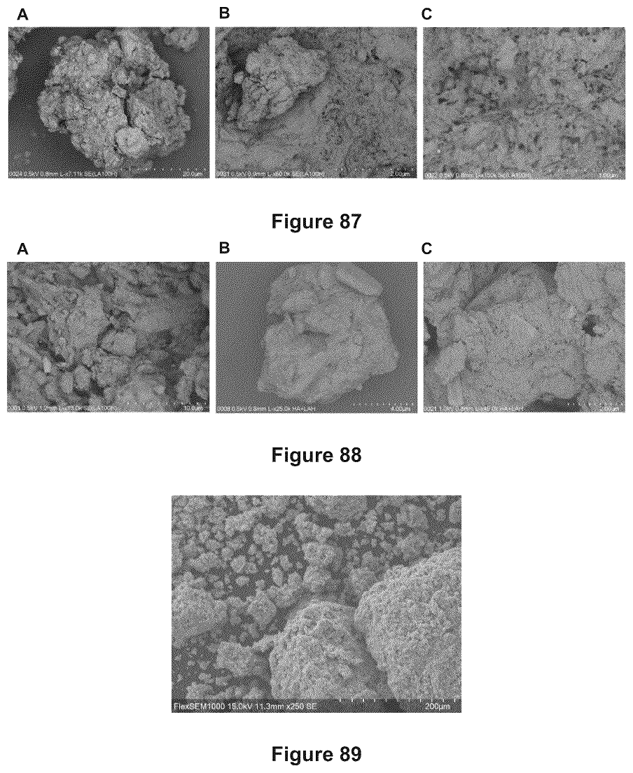

The MOFs prepared in Example 8(a) were imaged using a SEM equipped with an SE detector. The images obtained for MOFs 31 and 32 are presented in FIGS. 87 to 89 and summarized in Table 31.

TABLE 31
Summary of the SEM images obtained for MOFs 31 and 32

| | | Scale |
|---|---|---|
| MOF | Figure | bar (μm) |
| MOF 31 | FIG. 87(A) | 20.0 |
| | FIG. 87(B) | 2.00 |
| | FIG. 87(C) | 1.00 |
| MOF 32 | FIG. 88(A) | 10.0 |
| (before calcination | FIG. 88(B) | 4.00 |
| at 1000° C.) | FIG. 88(C) | 2.00 |
| MOF 32 | FIG. 89 | 200 |
| (after calcination | | |
| at 1000° C.) | | |

### c) Characterization of the Bimetallic Lithiophilic MOFs by EDS

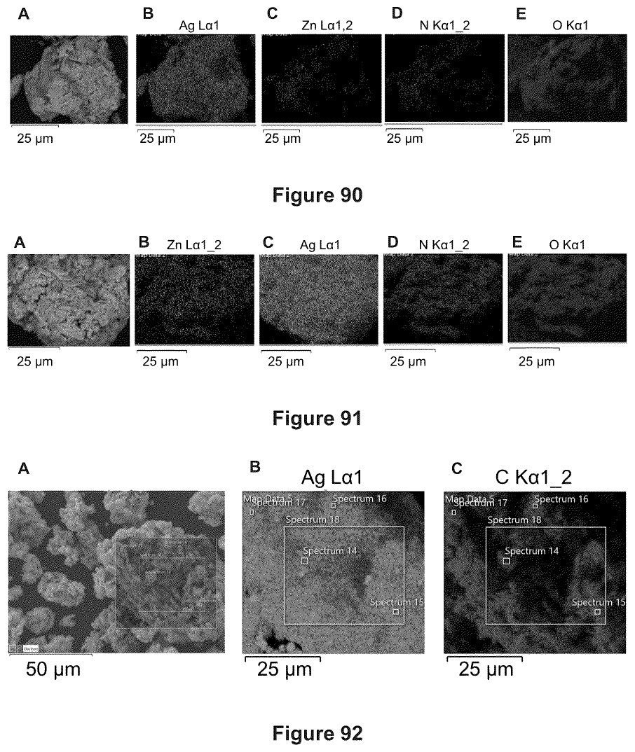

The elemental analysis or chemical characterization of the MOFs prepared in Example 8(a) was carried out using a SEM equipped with an X-ray detector for EDS analysis. FIGS. 90 to 92 show in (A) SEM images obtained respectively for MOFs 31 and 32, in (B) to (E) the EDS mapping images. The experimental conditions used for the EDS analyses carried out for MOFs 31 and 32 are presented in Table 32.

TABLE 32
Experimental conditions used for the EDS
analyses carried out for MOFs 31 and 32

| | | | Scale |
|---|---|---|---|
| MOF | Figure | Element | bar (μm) |
| MOF 31 | FIG. 90(B) | Ag | 25 |
| | FIG. 90(C) | Zn | |
| | FIG. 90(D) | N | |
| | FIG. 90(E) | O | |
| MOF 32 | FIG. 91(B) | Zn | 25 |
| (before calcination | FIG. 91(C) | Ag | |
| at 1000° C.) | FIG. 91(D) | N | |
| | FIG. 91(E) | O | |
| MOF 32 | FIG. 92(B) | Ag | 25 |
| (after calcination | FIG. 92(C) | C | |
| at 1000° C.) | | | |

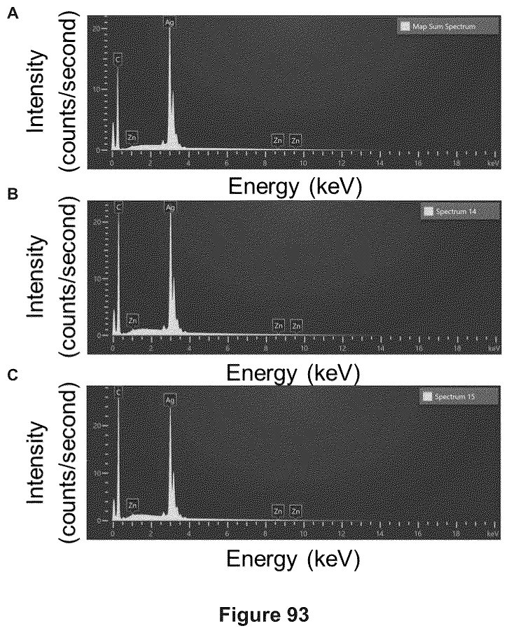

The results of the EDS analysis obtained for MOF 32 after calcination at a temperature of about 1000° C. are presented in FIG. 93. The results presented in FIG. 93 were obtained in the outlined zones on the images presented in FIG. 93. FIG. 93 shows in (A) the sum of the results of the EDS analysis, in (B) the results of the EDS analysis obtained for Spectrum 14, and in (C) the results of the EDS analysis obtained for Spectrum 15. The results of the EDS analysis obtained are summarized in Table 33.

TABLE 33
EDS analysis results obtained for MOF 32 after
calcination at a temperature of about 1000° C.

| | | | | Weight % | Atomic |
|---|---|---|---|---|---|
| Spectrum | Element | Line type | % by weight | difference | % |
| Spectrum | C | K series | 24.86 | 0.09 | 74.75 |
| (Sum) | Ag | L series | 74.69 | 0.10 | 25.01 |
| | Zr | L series | 0.45 | 0.06 | 0.25 |
| | Total | | 100.00 | — | 100.00 |
| Spectrum | C | K series | 31.81 | 0.12 | 80.63 |
| 14 | Ag | L series | 67.55 | 0.13 | 19.07 |
| | Zr | L series | 0.64 | 0.07 | 0.30 |
| | Total | | 100.00 | — | 100.00 |
| Spectrum | C | K series | 36.33 | 0.12 | 83.58 |
| 15 | Ag | L series | 63.00 | 0.13 | 16.14 |
| | Zr | L series | 0.67 | 0.07 | 0.28 |
| | Total | | 100.00 | — | 100.00 |

The results show that a carbon-rich powder is obtained (about 73 at. % to about 83 at. % depending on the observed zone) with silver substantially uniformly distributed in the calcined MOF. It is possible to observe the presence of traces of zinc. However, there is substantially no or very little oxygen. It is possible to conclude that the metal is formed mainly in elemental form.

### Example 9—Preparation and Characterization of Electrochemical Cells

### a) Preparation of Coating Materials Based on Calcined Lithophilic MOFs

Coating materials based on calcined lithiophilic MOFs as described in the previous examples were prepared. The coating materials were obtained by mixing the MOFs with a 60 wt. % solution of solid polymer electrolyte including LiTFSI in a solvating polymer as described in U.S. Pat. No. 6,903,174 B2 (Harvey et al.) (US′174) in a polymer:LiTFSI ratio of (20:1) and 40 wt. % of tetraethylene glycol dimethyl ether. The composition of the coating materials is presented in Table 34.

TABLE 34
Composition of coating materials based
on calcined lithiophilic MOFs

| | Solid polymer | MOF | % solid in the |
|---|---|---|---|
| | electrolyte | (% by | coating material |
| Coating material | (% by weight) | weight) | solution |
| M1 | 25% | MOF 10 | <25% |
| | | 75% | |
| M2 | 25% | MOF 10 | 29.9% |
| | | 75% | |
| M3 | 0% | MOF 14 | — |
| | | 100% | |

### b) Electrochemical Cell Configurations

The electrochemical properties of the coating materials prepared in Example 9 (a) were studied.

The electrochemical cells were assembled with one or two coating layers. The first coating layer being crosslinked and the second layer being non-crosslinked and placed between the first coating layer and the electrolyte. This second coating layer allows a substantial improvement in adhesion between the various components of the electrochemical cell, and therefore, an improvement in electrochemical performance.

The electrochemical cells were assembled with a lithium iron phosphate positive electrode (LiFePO₄, LFP) on carbon-coated aluminum current collectors (Armor™). The composition of the electrochemically active material of the positive electrode is presented in Table 35.

TABLE 35
Composition of positive electrode electrochemically active material

| | Positive electrode material composition | | | |
|---|---|---|---|---|
| Positive | Electrochemically | Electronically | | |
| electrode | active material | conductive material | Binder | Salt |
| C1 | LFP | Carbon black | Polymer as | LiTFSI |
| | (73.5 | (1 wt. %) | described | (6.3 wt. %) |
| | wt. %) | | in patent | |
| | | | US′174 | |
| | | | (19.2 wt. %) | |

All electrochemical cells were assembled with a self-supporting solid polymer electrolyte as described in US'174 patent comprising 81.8 wt. % of polymer, 17.8 wt. % of LiTFSI, and 0.4 wt. % of 2,2-dimethoxy-2-phenylacetophenone (Irgacure™ 651).

The electrochemical cells were assembled with lubricated lithium metal negative electrodes having a thickness of about 50 μm on copper current collectors.

The electrochemical cells were assembled according to the configurations presented in Table 36.

TABLE 36
Electrochemical cell configurations

| | Thickness of | Coating layers | | Thickness of | | |
|---|---|---|---|---|---|---|
| | the negative | 1^{st} layer | Thickness of | the solid | Positive | |
| Cell | electrode | and thickness | the 2^{nd} layer | electrolyte | electrode | Case |
| Cell 1 | 50 μm | M1 | | 25 μm | C1 | Button |
| Cell 2 | | 2 to 4 μm | | | | |
| Cell 3 | | M1 | 8 μm | 25 μm | C1 | Pouch |
| Cell 4 | | 2 to 4 μm | | | | (75 psi) |
| Cell 5 | | M2 | 8 μm | 25 μm | C1 | Button |
| Cell 6 | | 7 to 9 μm | | | | |
| Cell 7 | | M2 | 8 μm | 25 μm | C1 | Pouch |
| | | 7 to 9 μm | | | | (75 psi) |
| Cell 8 | | M3 | 14 μm | 25 μm | C1 | Pouch |
| Cell 9 | | 12 μm | | | | (75 psi) |

Cells 2 to 9 were assembled with a second coating layer including 60 wt. % of the polymer as described in US′174 and LiTFSI in a polymer:LiTFSI ratio of (20:1) and 40 wt. % of tetraethylene glycol dimethyl ether. The polymer of the second layer is not crosslinked.

The reference electrochemical cells were assembled according to the configurations presented in Table 37.

TABLE 37
Reference electrochemical cell configurations

| | | Thickness of | Thickness of | |
|---|---|---|---|---|
| | Positive | the solid | the negative | |
| Reference | electrode | electrolyte | electrode | Case |
| Reference 1 | C1 | 25 μm | 50 μm | Pouch |
| | | | | (75 psi) |
| Reference 2 | | | | Button |
| Reference 3 | | | | Pouch |
| | | | | (75 psi) |
| Reference 4 | | | | Pouch |
| | | | | (75 psi) |

### c) Electrochemical Behaviour

The electrochemical analyses demonstrated that the second coating layer significantly 10 improved the adhesion between the first coating layer and the electrolyte. The presence of this second coating layer also appears to improve coulombic efficiency and initial discharge capacity, while improving the reproducibility of electrochemical results. An improvement in electrochemical performance for electrochemical cells including thinner first coating layer films was also observed.

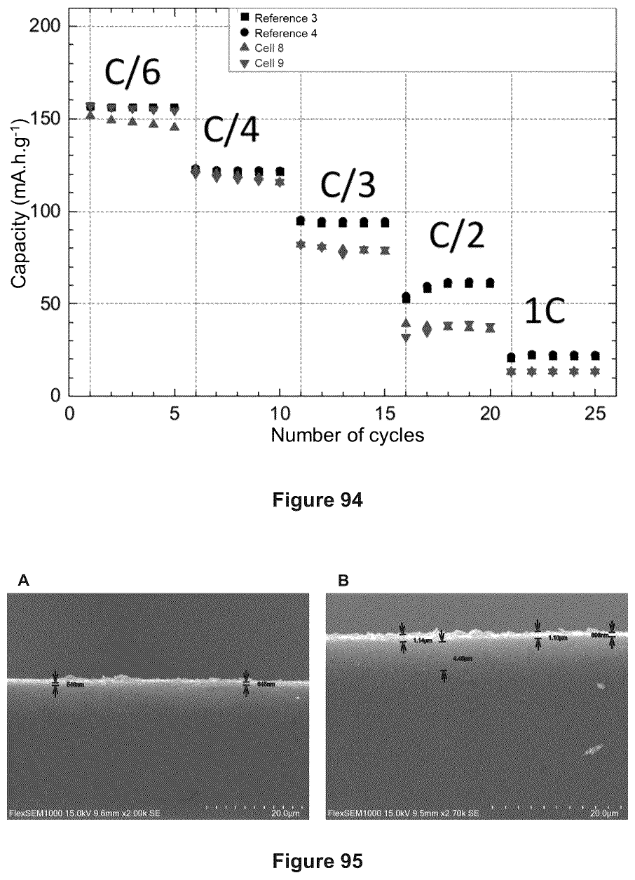

FIG. 94 shows a graph of the capacity as a function of the number of cycles obtained at charge and discharge currents of C/6, C/4, C/3, C/2 and 1 C for Cells 8 (▴) and 9 (▾) and References 3 (▪) and 4 (●). Better reproducibility of electrochemical performance was observed for electrochemical cells including thicker second coating layer films. FIG. 94 shows electrochemical performance substantially close to that of the two references, despite a total coating layer thickness of about 26 μm.

### Example 10—Deposition of a Layer of Calcined Lithiophilic MOFs by Sputtering

### a) Deposition of a Layer of Calcined Lithiophilic MOFs by Sputtering

A layer of calcined lithiophilic MOFs was deposited by sputtering onto a lithium foil.

The calcined lithiophilic MOF was dispersed in tetrahydrofuran (THF) at a concentration of about 1.5 mg/mL. 100 mL of the solution thus obtained was mixed in an ultrasonic bath for about 15 minutes. The solution was then inserted into a manual spray coater in an anhydrous chamber. A lithium foil measuring about 8 cm×15 cm was placed flat and upright on a hard substrate and firmly immobilized. Spraying was carried out by applying a dry air pressure of about 60 psi at a distance of about 30 cm. Two spray passes were made across the surface of the lithium foil from top to bottom. The lithium foil was dried under vacuum at a temperature of about 50° C. overnight.

The depositions were carried out with MOFs 11 and 12 (bimetallic calcined lithiophilic MOFs based on Zn and Cu).

### b) SEM Characterization of the Calcined Lithiophilic MOF Layers Obtained by Sputtering

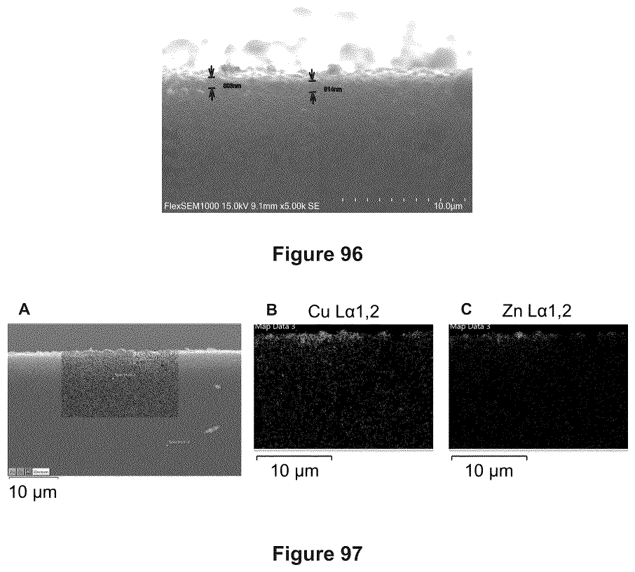

The calcined lithiophilic MOF layers deposited in Example 10 (a) were imaged using a SEM equipped with an SE detector. The images obtained for the two layers of MOFs 11 and 12 are presented in FIGS. 95 and 96 and summarized in Table 38.

TABLE 38
Summary of the SEM images obtained for the layers of
calcined lithiophilic MOFs obtained by sputtering

| | | | Scale |
|---|---|---|---|
| Sprayed layer | MOF | Figure | bar (μm) |
| Layer 1 | MOF 11 calcined at 750° C. | FIG. 95(A) | 20.0 |
| | | FIG. 95(B) | 20.0 |
| Layer 2 | MOF 12 calcined at 1000° C. | FIG. 96 | 10.0 |

FIG. 95 shows images obtained by SEM of a section of a lithium foil coated with a layer of calcined lithiophilic MOFs obtained by sputtering (MOF 11 calcined at 750° C.). It is possible to observe a layer of calcined lithiophilic MOFs having a thickness in the range from a few hundred nm to about 1 μm.

FIG. 96 shows an image obtained by SEM of a section of a lithium foil coated with a layer of calcined lithiophilic MOFs obtained by sputtering (MOF 12 calcined at 1000° C.). It is possible to observe a layer of calcined lithiophilic MOFs having a thickness in the range from about 900 nm to about 1 μm.

### c) EDS Characterization of the Calcined Lithiophilic MOF Layers Obtained by Sputtering

The elemental analysis or chemical characterization of the calcined lithiophilic MOF layers deposited in Example 10 (a) was carried out using a SEM equipped with an X-ray detector for EDS analysis.

FIG. 97 shows EDS mapping images obtained for Layer 1.

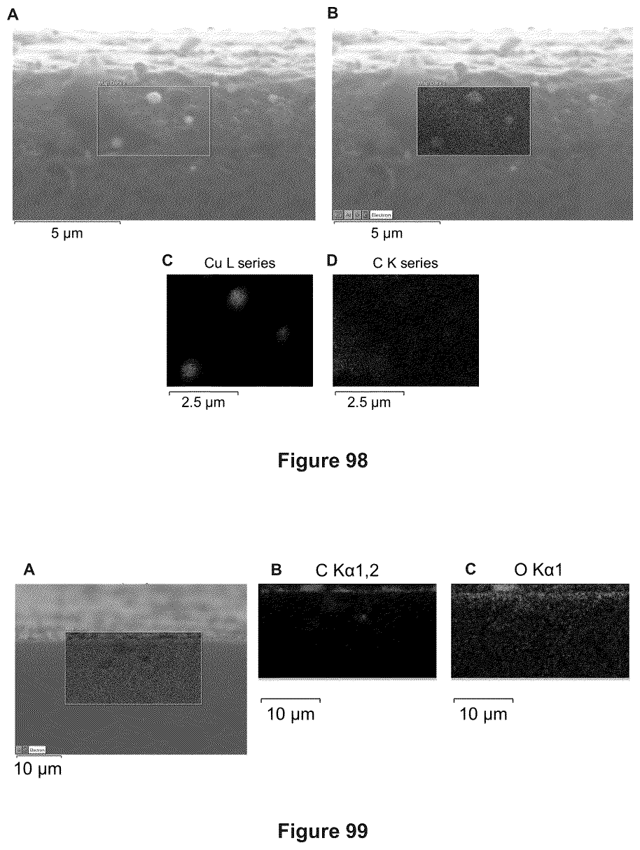

FIG. 98 shows in (A) a SEM image obtained for Layer 2, and in (B) to (D) EDS mapping images.

FIG. 99 shows EDS mapping images obtained for Layer 2.

The experimental conditions used for the EDS analyses carried out on the calcined lithiophilic MOF layers obtained by sputtering are presented in Table 39.

TABLE 39
Experimental conditions for the EDS analyses
carried out for Layers 1 and 2

| Sprayed | | | | Scale |
|---|---|---|---|---|
| layer | MOF | Figure | Element | bar (μm) |
| Layer 1 | MOF 11 | FIG. 97(A) | Zn, Cu, and Al | 10 |
| | calcined at | FIG. 97(B) | Cu | 10 |
| | 750° C. | FIG. 97(C) | Zn | 10 |
| Layer 2 | MOF 12 | FIG. 98(B) | Cu, Al, O, and C | 5 |
| | calcined at | FIG. 98(C) | Cu | 2.5 |
| | 1000° C. | FIG. 98 (D) | C | 2.5 |
| Layer 2 | MOF 12 | FIG. 99(A) | O and C | 10 |
| | calcined at | FIG. 99(B) | C | 10 |
| | 1000° C. | FIG. 99(B) | O | 10 |

FIG. 97 shows in (A) a SEM image obtained for a layer of calcined lithiophilic MOFs obtained by sputtering (MOF 11 calcined at 750° C.) as well as the EDS mapping of Zn (blue), Cu (green), and Al (red). FIGS. 97(B) and (C) respectively show the Cu and Zn EDS mapping images obtained for the zone delimited in (A). It is possible to observe the presence of both metals (Cu and Zn) and mainly Cu.

FIG. 98 shows in (A) a SEM image obtained for a layer of calcined lithiophilic MOFs obtained by sputtering (MOF 12 calcined at 1000° C.), in (B) a SEM image as well as the EDS mapping of Cu (pink), Al (blue), O (green), and C (red), and in (C) and (D) respectively EDS mapping images of Cu and C obtained for the zone delimited in (A) and (B). It is possible to observe the absence of Zn due to its evaporation at elevated temperature. Nanometric spheres of Cu can be observed in the layer of calcined lithiophilic MOFs obtained by sputtering and on the lithium side. The presence of these spheres can be attributed to cryogenic cutting, which can result in hard metal particles.

FIG. 99 shows in (A) a SEM image obtained for a layer of calcined lithiophilic MOFs obtained by sputtering (MOF 12 calcined at 1000° C.) as well as the EDS mapping of O (green) and C (red). FIGS. 99 (B) and (C) respectively show the EDS mapping images of C and O obtained for the zone delimited in (A). It is possible to observe the absence of Cu and Zn. The latter has been evaporated to create porosity and prevent the formation of copper particles.

### d) Electrochemical Behaviour of the Calcined Lithiophilic MOF Layers Obtained by Sputtering

The electrochemical properties of the calcined lithiophilic MOF layers obtained by sputtering prepared in Example 10 (a) were studied.

The electrochemical cells were assembled with lithium metal negative electrodes comprising a layer of calcined lithiophilic MOFs deposited by sputtering onto the surface of a lithium foil prepared in Example 10 (a) on copper current collectors. The electrochemical cells were assembled without a coating layer.

The electrochemical cells were assembled with a positive LFP electrode on carbon-coated aluminum current collectors (Armor™). The composition of the electrochemically active material of the positive electrode is presented in Table 35 in Example 9 (b).

All electrochemical cells were assembled with a self-supporting solid polymer electrolyte as described in the US'174 patent comprising 81.8 wt. % of polymer, 17.8 wt. % of LiTFSI, and 0.4 wt. % of 2,2-dimethoxy-2-phenylacetophenone (Irgacure™ 651).

The electrochemical cells were assembled according to the configurations presented in Table 40.

TABLE 40
Electrochemical cell configurations

| | Thickness of | | Thickness of | | |
|---|---|---|---|---|---|
| | the negative | Sprayed | the solid | Positive | |
| Cell | electrode | layer | electrolyte | electrode | Case |
| Cell 10 | 50 μm | Layer 1 | 25 μm | C1 | Pouch |
| Cell 11 | | | | | (75 psi) |
| Cell 12 | | Layer 2 | | | |
| Cell 13 | | | | | |

The reference electrochemical cells were assembled according to the configurations presented in Table 41.

TABLE 41
Reference electrochemical cell configurations

| | | Thickness of | Thickness of | |
|---|---|---|---|---|
| | Positive | the solid | the negative | |
| Reference | electrode | electrolyte | electrode | Case |
| Reference 5 | C1 | 25 μm | 50 μm | Pouch |
| Reference 6 | | | | (75 psi) |

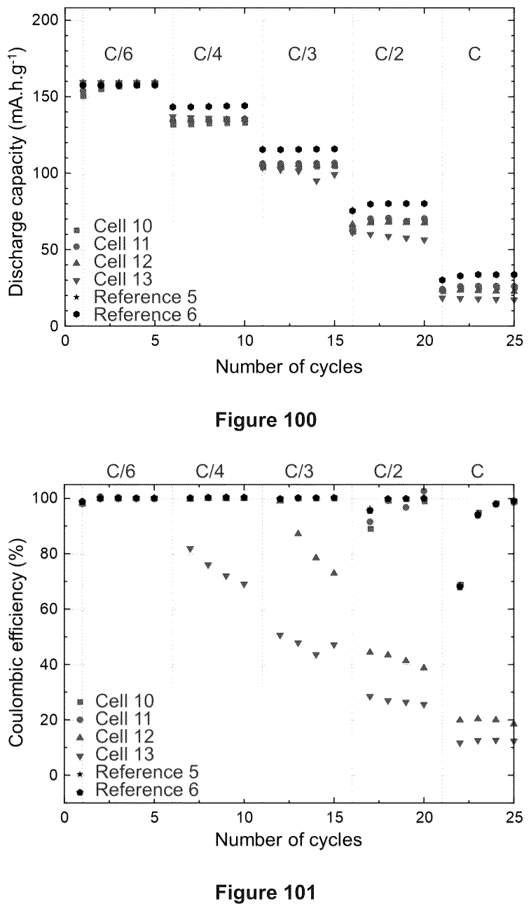

FIG. 100 shows a graph of the capacity as a function of the number of cycles obtained at charge and discharge currents of C/6, C/4, C/3, C/2 and 1 C for Cells 10 (▪), 11 (●), 12 (▴) and 13 (▴) and References 5 (★) and 6 ( [symbol] ).

FIG. 101 shows a graph of the coulombic efficiency as a function of the number of cycles obtained for Cells 10 (▪), 11 (●), 12 (▴) and 13 (▾) and References 5 (★) and 6 ( [symbol] ).

It is possible to observe that the electrochemical performances are very close to the reference cells, especially for Cells 10 and 11.

Several modifications could be made to any of the embodiments described above without departing from the scope of the present invention as contemplated. The references, patents or scientific literature referred to in the present application are incorporated herein by reference in their entirety and for all purposes.

What is claimed is:

1. A process for preparing a negative electrode material comprising an electrochemically active material and a coating layer comprising a coating material based on a calcined lithiophilic organometallic structure disposed on a surface of said electrochemically active material, the process comprising the following steps:
(i) contacting at least one organic ligand with at least one lithiophilic metal precursor to obtain a lithiophilic organometallic structure;
(ii) calcining the lithiophilic organometallic structure obtained in (i) to obtain the calcined lithiophilic organometallic structure of the coating material; and
(iii) depositing the coating material on the surface of the electrochemically active material.

2. The process of claim 1, wherein the lithiophilic metal is selected from Ag, Zn, Sn, Sb, Mg, Al, Ni, Cu, Co, and a combination of at least two thereof.

3. The process of claim 1, wherein the organic ligand is an organic ligand comprising a nitrogen function, an organic ligand comprising a carboxylate, or a mixed organic ligand comprising a nitrogen function and/or a carboxylate, preferably wherein the organic ligand is 1,2,4,5-benzenetetracarboxylic acid or 1H-benzimidazole-6-carboxylic acid.

4. (canceled)

5. The process of claim 1, wherein the lithiophilic organometallic structure obtained in (i) is selected from lithiophilic organometallic structures of Formulae 1 to 9: 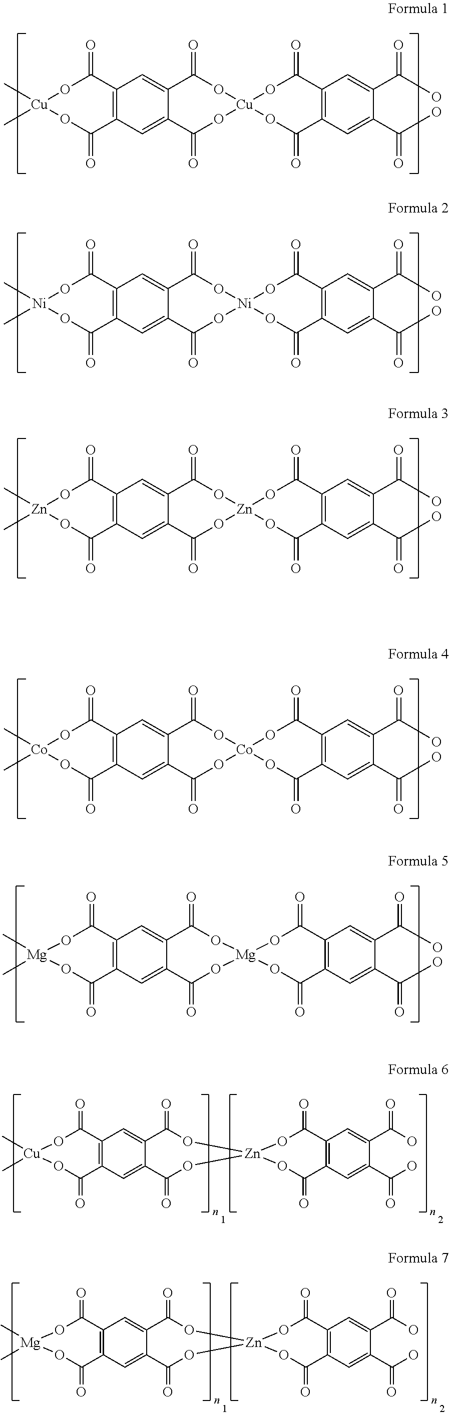 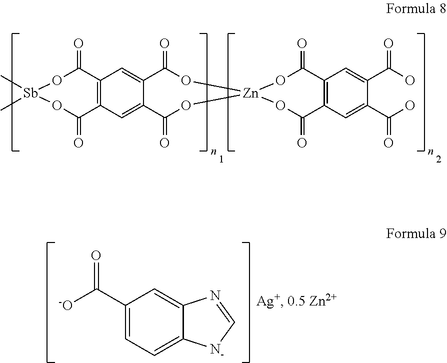
wherein,
n₁ and n₂ indicate the radio of each unit and are independently selected numbers in the range from 0.1 to 0.9.

6-13. (canceled)

14. The process of claim 1, wherein the calcination step is carried out at a temperature of from about 500° C. to about 1050° C. preferably at a temperature of from about 550° C. to about 1000° C.

15. (canceled)

16. The process of claim 1, wherein the calcination step is carried out under an inert atmosphere preferably comprising a gas selected from argon, oxygen, nitrogen, helium, a fluorinated gas, and a mixture comprising least two thereof, and more preferably comprising argon.

17-18. (canceled)

19. The process of claim 1, wherein the deposition step is carried out by at least one of a doctor blade coating method, a comma coating method, a reverse-comma coating method, a printing method such as gravure coating, a slot-die coating method, or a spray deposition method, and preferably by a spray deposition method.

20. (canceled)

21. The process of claim 1, further comprising a step of depositing a second coating layer.

22. The process of claim 21, wherein the step of depositing the second coating layer is carried out by at least one of a doctor blade coating method, a comma coating method, a reverse-comma coating method, a printing method such as gravure coating, a slot-die coating method, or a spray deposition method, and preferably by a spray deposition method.

23. (canceled)

24. A negative electrode material obtained according to the process as defined in claim 1.

25. A negative electrode material comprising an electrochemically active material and a coating layer comprising a coating material based on a calcined lithiophilic organometallic structure comprising at least one lithiophilic metal and at least one at least partially calcined organic ligand, said coating layer disposed on a surface of said electrochemically active material.

26. The electrode material of claim 25, wherein the electrochemically active material comprises an alkali metal, an alkaline earth metal, a non-alkali and non-alkaline earth metal or an alloy comprising at least one thereof.

27. The electrode material of claim 26, wherein the electrochemically active material comprises:
(i) an alkali metal, an alkaline earth metal, or an alloy comprising at least one alkali or alkaline earth metal, and preferably metallic lithium or an alloy including or based on metallic lithium; or
(ii) nickel.

28-29. (canceled)

30. The electrode material of claim 25, wherein the electrochemically active material is in the form of a film having a thickness in the range from about 5 μm to about 75 μm, or from about 15 μm to about 70 μm, or from about 25 μm to about 65 μm, or from about 30 μm to about 60 μm, or from about 45 μm to about 55 μm, upper and lower limits included.

31. The electrode material of claim 25, wherein the lithiophilic metal is selected from Ag, Zn, Sn, Sb, Mg, Al, Ni, Cu, Co, and a combination of at least two thereof.

32. The electrode material of claim 25, wherein the organic ligand is an organic ligand comprising a nitrogen function, an organic ligand comprising a carboxylate, or a mixed organic ligand comprising a nitrogen function and/or a carboxylate, preferably wherein the organic ligand is 1,2,4,5-benzenetetracarboxylic acid or 1H-benzimidazole-6-carboxylic acid.

33. (canceled)

34. The electrode material of claim 25, wherein the lithiophilic organometallic structure before calcination is selected from lithiophilic organometallic structures of Formulae 1 to 9: 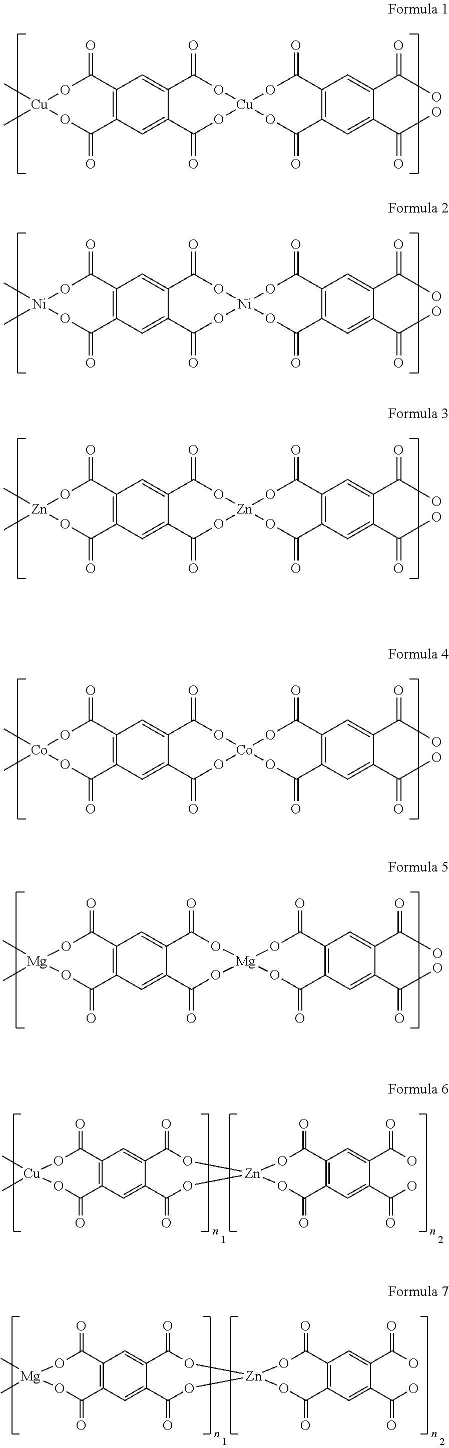 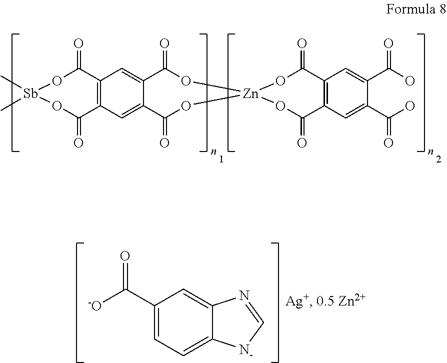
wherein,
n₁ and n₂ indicate the ratio of each unit and are independently selected numbers in the range from 0.1 to 0.9.

35-42. (canceled)

43. The electrode material of claim 25, wherein the calcined lithiophilic organometallic structure further comprises a silver source preferably being a silver salt such as AgCl or AgNO₃, preferably being present in a lithiophilic metal:silver ratio in the range from about 4:3 to about 4:1, upper and lower limits included.

44-46. (canceled)

47. The electrode material of claim 25, wherein the coating material further comprises a solid polymer electrolyte comprising a salt in a solvating polymer.

48. The electrode material of claim 47, wherein the solid polymer electrolyte is a copolymer of ethylene oxide and at least one substituted oxirane comprising a crosslinkable function.

49. The electrode material of claim 48, wherein the copolymer:
(i) comprises ethylene oxide-based units and —O—CH₂—CHR units, wherein R is a substituent comprising a radically crosslinkable functional group and is independently selected from one unit to the other, preferably wherein the copolymer further comprises —O—CH₂—CHR′ units, wherein R′ substituent being free of radically crosslinkable functional groups and is independently selected from one unit to the other; or
(ii) has a polymolecularity index (1=M_{w}/Mₙ) less than or equal to 2.2, wherein Mₙ is the number average molecular weight of the copolymer and is greater than or equal to 20,000 and M_{w} is the weight average molecular weight; or
(iii) is crosslinked.

50-53. (canceled)

54. The electrode material of claim 47, wherein the salt is a lithium salt preferably selected from the group consisting of lithium hexafluorophosphate (LiPF₆), lithium bis(trifluoromethanesulfonyl)imide (LiTFSI), lithium bis(fluorosulfonyl)imide (LiFSI), lithium 2-trifluoromethyl-4,5-dicyanoimidazolate (LiTDI), lithium 4,5-dicyano-1,2,3-triazolate (LiDCTA), lithium bis(pentafluoroethylsulfonyl)imide (LiBETI), lithium tetrafluoroborate (LiBF₄), lithium bis(oxalato)borate (LiBOB), lithium nitrate (LiNO₃), lithium chloride (LiCl), lithium bromide (LiBr), lithium fluoride (LiF), lithium perchlorate (LiClO₄), lithium hexafluoroarsenate (LiAsF₆), lithium trifluoromethanesulfonate (LiSO₃CF₃) (LiOTf), lithium fluoroalkylphosphate Li[PF₃(CF₂CF₃)₃] (LiFAP), lithium tetrakis(trifluoroacetoxy)borate Li[B(OCOCF₃)₄] (LiTFAB), lithium bis(1,2-benzenediolato(2-)-O,O′)borate Li[B(C₆O₂)₂] (LiBBB), and a combination of at least two thereof, preferably the lithium salt is LiTFSI.

55. (canceled)

56. The electrode material of claim 25, wherein the coating layer has a thickness in the range from about 1 μm to about 20 μm, or from about 1 μm to about 19 μm, or from about 1 μm to about 18 μm, or from about 1 μm to about 17 μm, or from about 1 μm to about 16 μm, or from about 1 μm to about 15 μm, or from about 1 μm to about 14 μm, or from about 1 μm to about 13 μm, or from about 2 μm to about 12 μm, upper and lower limits included, and preferably in the range from about 2 μm to about 12 μm upper and lower limits included.

57. (canceled)

58. The electrode material of claim 25, wherein the electrochemically active material is lubricated.

59. The electrode material of claim 25, wherein the coating layer is a first coating layer, and the electrode material comprises a second coating material layer, preferably wherein the second coating material layer:
(i) has a thickness in the range from about 1 μm to about 20 μm, or from about 1 μm to about 19 μm, or from about 1 μm to about 18 μm, or from about 1 μm to about 17 μm, or from about 1 μm to about 16 μm, or from 1 μm to about 15 μm, or front about 1 μm to about 14 μm, or from about 2 μm to about 14 μm, upper and lower limits included, and preferably in the range from about 2 μm to about 14 μm, upper and lower limits included; or
(ii) comprises a non-crosslinked polymer.

60-62. (canceled)

63. A process for preparing an electrode material as defined in claim 25, the process comprising a step of depositing the coating layer based on a calcined lithiophilic organometallic structure on the surface of the electrochemically active material, wherein the deposition step is preferably carried out by at least one of a doctor blade coating method, a comma coating method, a reverse-comma coating method, a printing method such as gravure coating, a slot-die coating method, or a spray deposition method, and more preferably by a spray deposition method.

64. The process of claim 63, further comprising a step of depositing the second coating layer preferably carried out by at least one of a doctor blade coating method, a comma coating method, a n reverse-comma coating method, a printing method such as gravure coating, a slot-die coating method, or a spray deposition method, and more preferably by a spray deposition method.

65-66. (canceled)

67. The process of claim 63, further comprising the preparation of the coating layer based on the calcined lithiophilic organometallic structure and optionally further comprises a step of preparing the calcined lithiophilic organometallic structure optionally comprising (i) a step of contacting at least one organic ligand with at least one lithiophilic metal precursor to obtain a lithiophilic organometallic structure, and (ii) a step of calcining the lithiophilic organometallic structure obtained in (i) to obtain the calcined lithiophilic organometallic structure.

68-69. (canceled)

70. A negative electrode comprising the electrode material as defined in claim 24, said electrode being a self-supported electrode or being on a current collector.

71. (canceled)

72. An electrochemical cell comprising a negative electrode, a positive electrode, and an electrolyte, wherein the negative electrode is as defined in claim 70.

73. The electrochemical cell of claim 72, wherein the positive electrode comprises an electrochemically active material:
(i) selected from metal oxide, a metal sulfide, a metal oxysulfide, a metal phosphate, a metal fluorophosphate, a metal oxyfluorophosphate, a metal sulfate, a metal halide, a metal fluoride, sulfur, selenium, and a combination of at least two thereof, the metal of the electrochemically active material is selected from titanium (Ti), iron (Fe), manganese (Mn), vanadium (V), nickel (Ni), cobalt (Co), aluminum (Al), chromium (Cr), copper (Cu), zirconium (Zr), niobium (Nb), and a combination of at least two thereof, and preferably the metal of the electrochemically active material further comprises an alkali or alkaline earth metal selected from lithium (Li) sodium (Na), potassium (K), and magnesium (Mg); or
(ii) is a lithium metal phosphate, preferably LiFePO₄.

74-77. (canceled)

78. The electrochemical cell of claim 72, wherein the electrolyte is selected from a solid polymer electrolyte comprising a salt in a solvating polymer, a liquid electrolyte comprising a salt in a solvent, and a gel electrolyte comprising a salt in a solvent and optionally a solvating polymer.

79-81. (canceled)

82. The electrochemical cell of claim 78, wherein the salt is a lithium salt preferably selected from the group consisting of lithium hexafluorophosphate (LiPF₆), lithium bis(trifluoromethanesulfonyl)imide (LiTFSI), lithium bis(fluorosulfonyl)imide (LiFSI), lithium 2-trifluoromethyl-4,5-dicyanoimidazolate (LiTDI), lithium 4,5-dicyano-1,2,3-triazolate (LiDCTA), lithium bis(pentafluoroethylsulfonyl)imide (LiBETI), lithium tetrafluoroborate (LiBF₄), lithium bis(oxalato)borate (LiBOB), lithium nitrate (LiNO₃), lithium chloride (LiCl), lithium bromide (LiBr), lithium fluoride (LiF), lithium perchlorate (LiClO₄), lithium hexafluoroarsenate (LiAsF₆), lithium trifluoromethanesulfonate (LiSO₃CF₃) (LiOTf), lithium fluoroalkylphosphate Li[PF₃(CF₂CF₃)₃] (LiFAP), lithium tetrakis(trifluoroacetoxy)borate Li[B(OCOCF₃)₄] (LiTFAB), lithium bis(1,2-benzenediolato(2-)-O,O′)borate Li[B(C₆O₂)₂] (LiBBB), and a combination of at least two thereof, preferably the lithium salt is LiTFSI.

83. (canceled)

84. A battery comprising at least one electrochemical cell as defined in claim 72, wherein said battery is selected from the group consisting of a lithium battery, a lithium-ion battery, a sodium battery, a sodium-ion battery, a potassium battery, a potassium-ion battery, a magnesium battery, and a magnesium-ion battery, and more preferably said battery is a lithium battery or a lithium-ion battery.

85-87. (canceled)

88. A negative electrode comprising the electrode material as defined in claim 25, said electrode being a self-supported electrode or being on a current collector.

89. An electrochemical cell comprising a negative electrode, a positive electrode, and an electrolyte, wherein the negative electrode is as defined in claim 88.

90. The electrochemical cell of claim 89, wherein the positive electrode comprises an electrochemically active material:
(i) selected from metal oxide, a metal sulfide, a metal oxysulfide, a metal phosphate, a metal fluorophosphate, a metal oxyfluorophosphate, a metal sulfate, a metal halide, a metal fluoride, sulfur, selenium, and a combination of at least two thereof, the metal of the electrochemically active material preferably being selected from titanium (Ti), iron (Fe), manganese (Mn), vanadium (V), nickel (Ni), cobalt (Co), aluminum (Al), chromium (Cr), copper (Cu), zirconium (Zr), niobium (Nb), and a combination of at least two thereof, and preferably the metal of the electrochemically active material further comprises an alkali or alkaline earth metal selected from lithium (Li), sodium (Na), potassium (K), and magnesium (Mg); or
(ii) is a lithium metal phosphate, preferably LiFePO₄.

91. The electrochemical cell of claim 89, wherein the electrolyte is selected from a solid polymer electrolyte comprising a salt in a solvating polymer, a liquid electrolyte comprising a salt in a solvent, and a gel electrolyte comprising a salt in a solvent and optionally a solvating polymer.

92. The electrochemical cell of claim 91, wherein the salt is a lithium salt preferably selected from the group consisting of lithium hexafluorophosphate (LiPF₆), lithium bis(trifluoromethanesulfonyl)imide (LiTFSI), lithium bis(fluorosulfonyl)imide (LiFSI), lithium 2-trifluoromethyl-4,5-dicyanoimidazolate (LiTDI), lithium 4,5-dicyano-1,2,3-triazolate (LiDCTA), lithium bis(pentafluoroethylsulfonyl)imide (LiBETI), lithium tetrafluoroborate (LiBF₄), lithium bis(oxalato)borate (LiBOB), lithium nitrate (LiNO₃), lithium chloride (LiCl), lithium bromide (LiBr), lithium fluoride (LiF), lithium perchlorate (LiClO₄), lithium hexafluoroarsenate (LiAsF₆), lithium trifluoromethanesulfonate (LiSO₃CF₃) (LiOTf), lithium fluoroalkylphosphate Li[PF₃(CF₂CF₃)₃] (LiFAP), lithium tetrakis(trifluoroacetoxy)borate Li[B(OCOCF₃)₄] (LiTFAB), lithium bis(1,2-benzenediolato(2-)-O,O′)borate Li[B(C₆O₂)₂] (LiBBB), and a combination of at least two thereof, preferably the lithium salt is LiTFSI.

93. A battery comprising at least one electrochemical cell as defined in claim 89, wherein said battery is selected from the group consisting of a lithium battery, a lithium-ion battery, a sodium battery, a sodium-ion battery, a potassium battery, a potassium-ion battery, a magnesium battery, and a magnesium-ion battery, and more preferably said battery is a lithium battery or a lithium-ion battery.
